(19) United States
(12) Patent Application Publication
(10) Pub. No.: US 2012/0173297 A1
(43) Pub. Date: Jul. 5, 2012

(54) Method and system for task tracking and allocation

(75) Inventors: Henry Van Styn, Cincinnati, OH (US); Howard Jackson, Cincinnati, OH (US)

(73) Assignee: Intranet Productivity Soluthions, Ltd., Cincinnati, OH (US)

(21) Appl. No.: 13/374,116

(22) Filed: Dec. 12, 2011

Related U.S. Application Data
(63) Continuation of application No. 12/320,398, filed on Jan. 23, 2009, now abandoned.
(60) Provisional application No. 61/011,966, filed on Jan. 23, 2008.

(51) Int. Cl. G06Q 10/06

(52) U.S. Cl. 705/7.15

(57) ABSTRACT

Task tracking and allocation can be performed using software implemented technology which allows authorized individuals to use a web interface to a tracking application. The application can include features allowing tasks to be delegated, new issues to be added, and various activities to be tracked. Business features such as display of profit margin in terms of worker, job, month, task or other information can also be included in such applications.

### CROSS REFERENCE TO RELATED APPLICATIONS

This application is a continuation of, and incorporates by reference in its entirety, non-provisional patent application Ser. No. 12/320,398, filed on Jan. 23, 2009 having the same title and inventors as listed above, which application itself claims the benefit of provisional patent application 61/011,966, filed on Jan. 23, 2008, also with the same title and inventors as listed above.

### INCORPORATION BY REFERENCE

This application incorporates by reference in its entirety the information from the computer program listing appendix submitted herewith, comprising the files listed in the table below:

| Name | Size | Date |
|---|---|---|
| D:\webirs | | |
| webirs_db_schema.sql | 42,426 | 1/22/2009 |
| D:\webirs\webirs_source | | |
| advsearch.html | 5,208 | 7/25/2007 |
| alloc.eps | 225,502 | 4/6/2008 |
| alloc.gif | 18,856 | 1/14/2009 |
| alloc.uxf | 9,968 | 4/6/2008 |
| article.php | 9,683 | 1/31/2008 |
| attach.php | 14,225 | 9/10/2008 |
| category.php | 6,454 | 4/10/2008 |
| charsettest.html | 94,000 | 11/14/2007 |
| charsettest2.html | 72,931 | 11/14/2007 |
| clientgroup.php | 1,546 | 9/10/2008 |
| clock.php | 121 | 8/3/2007 |
| combine.php | 5,298 | 4/18/2008 |
| config.php | 527 | 5/27/2008 |
| constants.php | 9,812 | 10/17/2008 |
| createflag.php | 84 | 7/25/2007 |
| cronjob.php | 347 | 5/5/2008 |
| cronjob.sh | 74 | 7/25/2007 |
| dokuwiki.php | 13,206 | 10/16/2008 |
| error.php | 2,535 | 4/21/2008 |
| flag.php | 13,700 | 10/21/2008 |
| get_css.php | 2,068 | 4/18/2008 |
| get_js.php | 1,119 | 4/18/2008 |
| group.php | 1,587 | 1/9/2008 |
| include.php | 2,886 | 9/10/2008 |
| index.php | 381 | 4/21/2008 |
| init.php | 25,054 | 11/6/2008 |
| issue.php | 63,595 | 1/31/2008 |
| itemlist.php | 4,529 | 10/2/2008 |
| js_css_map.php | 2,623 | 10/17/2008 |
| myform.php | 119 | 7/25/2007 |
| note.php | 11,577 | 9/10/2008 |
| notelist.php | 6,078 | 5/19/2008 |
| notelistpresentation.php | 8,906 | 3/5/2008 |
| object.php | 12,767 | 10/17/2008 |
| objectnotelist.php | 3,290 | 10/2/2008 |
| period.php | 68,232 | 10/29/2008 |
| periodlist.php | 3,414 | 10/13/2008 |
| permconfig.js.php | 413 | 11/15/2007 |
| permconfig.php | 16,090 | 9/10/2008 |
| permission.php | 17,706 | 11/6/2008 |
| phpinfo.php | 19 | 10/26/2007 |
| portal.php | 4,318 | 4/6/2008 |
| portalattr.php | 21,391 | 8/18/2008 |
| postrecorder.php | 1,275 | 9/20/2007 |
| search.php | 13,535 | 5/27/2008 |
| settings.php | 472 | 7/25/2007 |
| smsclock.php | 503 | 1/18/2008 |
| t.php | 29 | 4/7/2008 |
| t1.txt | 82 | 1/22/2009 |
| t2.txt | 153 | 1/22/2009 |
| testauth.php | 88 | 7/25/2007 |
| update_expanse.php | 2,296 | 4/11/2008 |
| update_items.php | 4,167 | 4/18/2008 |
| update_logs.php | 1,564 | 5/16/2008 |
| update_notes.php | 939 | 4/18/2008 |
| update_notes2.php | 1,114 | 4/6/2008 |
| update_periods.php | 778 | 8/5/2008 |
| update_searches.php | 4,954 | 10/3/2008 |
| user.php | 24,491 | 10/2/2008 |
| utf8.html | 29,035 | 11/14/2007 |
| vacation.php | 8,992 | 9/24/2008 |
| varfields.php | 22,087 | 5/16/2008 |
| version.php | 7,271 | 10/17/2008 |
| wiki.html | 27,693 | 7/25/2007 |
| xajax.php | 827 | 7/25/2007 |
| xajax_server.php | 18,389 | 10/13/2008 |
| D:\webirs\webirs_source\artissue | | |
| article.php | 4,992 | 9/11/2008 |
| articlesearch.php | 3,986 | 9/10/2008 |
| articlesearchquery.php | 620 | 9/10/2008 |
| articlesearch_typ.php | 9,407 | 10/2/2008 |
| article_typ.php | 11,205 | 9/10/2008 |
| artissue.php | 14,437 | 9/10/2008 |
| artissuesearch.php | 7,862 | 9/10/2008 |
| artprissue.php | 32,563 | 10/21/2008 |
| issue.php | 70,280 | 11/4/2008 |
| issuelistpresentation.php | 13,519 | 9/10/2008 |
| issuesearch.php | 24,389 | 10/2/2008 |
| issuesearchquery.php | 18,172 | 10/2/2008 |
| issuesearch_typ.php | 21,148 | 10/2/2008 |
| issue_typ.php | 36,016 | 10/21/2008 |
| priorityindex.php | 3,785 | 4/6/2008 |
| prissuesearch.php | 23,139 | 10/2/2008 |
| project.php | 10,896 | 10/2/2008 |
| projectsearch.php | 5,061 | 10/2/2008 |
| projectsearchquery.php | 2,069 | 9/10/2008 |
| projectsearch_typ.php | 11,835 | 10/2/2008 |
| project_typ.php | 13,282 | 10/2/2008 |
| searchquery.php | 9,648 | 9/10/2008 |
| D:\webirs\webirs_source\billableitem | | |
| expenseitem.php | 9,717 | 10/2/2008 |
| item.php | 27,338 | 10/17/2008 |
| itemsearch.php | 9,547 | 5/27/2008 |
| labor.php | 2,902 | 4/6/2008 |
| milagereport.php | 5,825 | 10/2/2008 |
| reimbursableitem.php | 920 | 5/5/2008 |
| resaleitem.php | 6,865 | 10/2/2008 |
| workreport.php | 6,838 | 10/13/2008 |
| D:\webirs\webirs_source\cache | | |
| cache-1208505043-a0e7b2a565119c0a7ec3126a16016113.css | 3,883 | 11/6/2008 |
| cache-1208513109-03f0a5211ea970eed47856b3e6ce46c8.javascript | 84,989 | 11/18/2008 |
| cache-1208513109-0bf3f22f1ce4cd9ffe018f4efa2ba58c.javascript | 82,768 | 11/19/2008 |
| cache-1208513109-13011fac086e13b5cf832bae43302aed.javascript | 106,538 | 12/16/2008 |
| cache-1208513109-1726598d5d0c71b1730da8abd31c8cb2.javascript | 99,138 | 11/20/2008 |
| cache-1208513109-1bd4cab58aca53e39d308847b060f645.javascript | 72,128 | 11/6/2008 |
| cache-1208513109-1d9ddbeea18622fa636f409caae7f948.javascript | 118,942 | 11/6/2008 |
| cache-1208513109-2ab1a477c84006dc7fa1cdfc56d42bf0.javascript | 69,982 | 11/10/2008 |
| cache-1208513109-2c0b4f2650e2fcd918fe09d6cf05aa5a.javascript | 102,584 | 11/18/2008 |
| cache-1208513109-3b828b412dc78bf28f13f82fc380aef5.javascript | 124,121 | 11/14/2008 |
| cache-1208513109-42d7cb8475abfbb978d93568c876d5e6.javascript | 85,812 | 11/6/2008 |
| cache-1208513109-474c3399cd1fe85b184d621d05314fa9.javascript | 72,857 | 1/1/2009 |
| cache-1208513109-4f15c2598cab330b61e9dce002858553.javascript | 88,033 | 11/6/2008 |
| cache-1208513109-56a8d26b61f296fa67b8b925fb754374.javascript | 104,805 | 11/14/2008 |
| cache-1208513109-58b16a630c3a4ab6e3cca901ba1c1e62.javascript | 57,995 | 11/6/2008 |
| cache-1208513109-5ac080177ee6685f056b094154fdc8e6.javascript | 94,965 | 11/7/2008 |
| cache-1208513109-5df17b05b4c7899ca0318348949ee311.javascript | 85,529 | 12/12/2008 |
| cache-1208513109-5f9e50749331bb7f68a8f51185c153a7.javascript | 86,754 | 12/30/2008 |
| cache-1208513109-5fc25725be1f623c7510cefcfff49039.javascript | 90,708 | 11/13/2008 |
| cache-1208513109-7ef5809312f41d57b48a53a27faf9ecc.javascript | 116,721 | 11/13/2008 |
| cache-1208513109-7f5e99b09fc021d9c22b53c1f64f28a5.javascript | 61,151 | 11/13/2008 |
| cache-1208513109-7f749f1c4cad5dc96a2c2ce2a789b8bb.javascript | 60,216 | 11/6/2008 |
| cache-1208513109-8b8ce60dd7fa50f69caf0154ed407ff0.javascript | 104,317 | 11/10/2008 |
| cache-1208513109-9332385809e486d773de0d6c85b76655.javascript | 56,298 | 11/24/2008 |
| cache-1208513109-c2be4b06e6f8830aca3d93eaefe1cee1.javascript | 69,907 | 11/19/2008 |
| cache-1208513109-cdb3b631c22ad72ac5d12ba7d17022c3.javascript | 88,487 | 11/30/2008 |
| cache-1208513109-d1402dee14588e7c09b1f79aa97235c6.javascript | 92,744 | 11/11/2008 |
| cache-1208513109-d223e1439188e478349d52476506c22e.javascript | 54,077 | 11/26/2008 |
| cache-1208513109-df2191458d698d04cfb15266ce30cf14.javascript | 101,359 | 12/29/2008 |
| cache-1208513109-fd69f9ede15a995366dba4c9cf2cdc3a.javascript | 83,308 | 12/1/2008 |
| cache-1208513109-fe1b0106c455797745ca5185e1a6d982.javascript | 72,203 | 11/6/2008 |
| cache-1211909112-00c63e22b38ef6814285867564006ad6.javascript | 117,004 | 11/24/2008 |
| cache-1211909112-12408424fbfebec3e171295ade0ca381.javascript | 150,319 | 1/12/2009 |
| cache-1211909112-34337e90b1b46113c203ec6235801844.javascript | 149,564 | 1/7/2009 |
| cache-1211909112-435389f5e3b3502a37f8c4259a159270.javascript | 144,385 | 11/26/2008 |
| cache-1211909112-45de4d0416252aad58e574feb44ffd7f.javascript | 152,719 | 11/30/2008 |
| cache-1211909112-4cb9c0a4ecb7d5fbf82e52581b5d8815.javascript | 137,158 | 11/6/2008 |
| cache-1211909112-522173383508a972e6cc66dd4c6e7d5d.javascript | 142,164 | 11/30/2008 |
| cache-1211909112-5dd2b8dfd53ea0530ab4696e568d4953.javascript | 131,059 | 11/6/2008 |
| cache-1211909112-5f978aab06745a2339e31a8a96143ed7.javascript | 164,766 | 11/18/2008 |
| cache-1211909112-68610f4d9603221710093adbec71d533.javascript | 134,668 | 11/30/2008 |
| cache-1211909112-8490cf25be8106dbdf9713e7b4f8f1be.javascript | 168,764 | 11/10/2008 |
| cache-1211909112-8b94972eb27fdfeb74104bcadf1796a3.javascript | 147,994 | 11/15/2008 |
| cache-1211909112-adc13e0956d5132faae123cf1f5f2fe1.javascript | 150,215 | 11/10/2008 |
| cache-1211909112-adff556bf3927d80e70ca01776d38c87.javascript | 132,756 | 1/15/2009 |
| cache-1211909112-c47b180b8e80032cecab36a728751b7c.javascript | 166,987 | 11/7/2008 |
| cache-1211909112-cb060861f87300cbd71f710099e118bb.javascript | 150,498 | 11/26/2008 |
| cache-1211909112-d6066b4a8e7ece68e30755843f508dd5.javascript | 166,543 | 11/25/2008 |
| cache-1211909112-dde7de4a147e4295589e2905d0e5fcf9.javascript | 136,889 | 12/1/2008 |
| cache-1211909112-e200c3a9f8d1af919858a42671ad78ea.javascript | 134,977 | 12/1/2008 |
| cache-1211909112-e8bdc8427f7481409c2767b0737e902e.javascript | 150,713 | 12/30/2008 |
| cache-1211909112-fe394543006f762ebdcd2ba4466b34b3.javascript | 128,838 | 11/14/2008 |
| cache-1222936521-48e9385d6edb33bf23327de1a24e474e.css | 31,613 | 11/6/2008 |
| cache-1222936521-5a6ac00e8f3607b414ab3c87db5dacf6.javascript | 128,738 | 11/14/2008 |
| cache-1222936521-6350035f31d4bd5279fbfa5e535726ad.javascript | 123,559 | 11/8/2008 |
| cache-1222936521-64d11c5626c4a6ec6ceeb6065a86eaf3.javascript | 126,517 | 1/5/2009 |
| cache-1222936521-767038c24d3e3d783af21d84d2ca2b84.javascript | 113,018 | 11/14/2008 |
| cache-1222936521-b22c673c232455806494567bc60b46a4.javascript | 123,559 | 11/7/2008 |
| cache-1222936521-c09bbac46cffd09e88c686ffe6efcedf.javascript | 121,338 | 11/10/2008 |
| cache-1222936521-d2050a898717b4372fb631b0e0d82926.javascript | 110,797 | 11/20/2008 |
| cache-1222936521-f761c00c5fd70a3e0d9aacd5d2fe12b1.javascript | 121,338 | 11/10/2008 |
| cache-1224586281-38548e772e5209e930142186e437956d.javascript | 107,419 | 11/25/2008 |
| cache-1224586281-911d72b1fb913aaa2b7ed187dc7513ce.javascript | 109,640 | 11/14/2008 |
| cache-1224586281-a8078d0bd74dbded99761bd75090e1a2.javascript | 126,412 | 11/14/2008 |
| cache-1224586281-e6c620a911953b45eb6bc24a01178960.javascript | 124,191 | 11/25/2008 |
| cache-1225297029-1acb3516f5b1976222644d8efce553c8.javascript | 165,519 | 11/26/2008 |
| cache-1225297029-4c64124a0c362bc6a838feb14fdfc97d.javascript | 167,740 | 11/10/2008 |
| cache-1225900847-0224b49db7a390d30fad977e9597ff06.javascript | 133,625 | 11/6/2008 |
| cache-1225900847-064a2b37c72d23a9b9b5b88ac70ca599.javascript | 137,543 | 12/11/2008 |
| cache-1225900847-06ac6d55b89d01be6e6dee5dd2a3ad95.javascript | 110,700 | 12/23/2008 |
| cache-1225900847-07d528c76807136df3eb1d059b4a6b8d.javascript | 157,353 | 11/10/2008 |
| cache-1225900847-0b9893c21b2ca2ca26a9175e205b269e.javascript | 196,399 | 11/6/2008 |
| cache-1225900847-0f070e18d21839bda3aaa2d34a1c4697.javascript | 109,758 | 11/7/2008 |
| cache-1225900847-1076f4b3604e381d02743424c6516c28.javascript | 146,876 | 11/13/2008 |
| cache-1225900847-110ba3e16c4435f579108468dc49dd2e.javascript | 91,707 | 11/11/2008 |
| cache-1225900847-12b7a5e376349649e9d8e1244a7ee5f2.javascript | 127,883 | 11/13/2008 |
| cache-1225900847-1e7e431dbb929b32ec527c6b402f0b4a.javascript | 133,625 | 11/7/2008 |
| cache-1225900847-25c6b9abaa5249f29edf0544c2c4a98a.javascript | 108,497 | 12/13/2008 |
| cache-1225900847-3200eec42c385f23ad63e5f0032de128.javascript | 93,853 | 11/7/2008 |
| cache-1225900847-327f4979796b83ab44289c70c971d129.javascript | 135,322 | 11/11/2008 |
| cache-1225900847-35c8672ddd2750462e3c014a3d52f039.javascript | 106,166 | 11/6/2008 |
| cache-1225900847-371097470a96d134b4eedf8fb6713ae4.javascript | 196,399 | 11/6/2008 |
| cache-1225900847-3d7af85d2dae4d814b35a62db230be44.javascript | 187,451 | 11/6/2008 |
| cache-1225900847-3d94d75d21d4930983ba10f7772c0146.javascript | 157,353 | 12/23/2008 |
| cache-1225900847-41f576a93080c617908bcbc8af077a10.javascript | 79,559 | 11/12/2008 |
| cache-1225900847-51a9cfeec4619dd0c1936e2a24348992.javascript | 156,475 | 11/6/2008 |
| cache-1225900847-54a13ddfdc9b73714edd65788d85faa6.javascript | 169,143 | 12/11/2008 |
| cache-1225900847-5556425ac44ee9b8ad5096119c811c69.javascript | 169,143 | 12/10/2008 |
| cache-1225900847-59f4bb54c3842e4d1213e6618cfd8dac.javascript | 132,575 | 1/6/2009 |
| cache-1225900847-5b83abb98b248be1696907793b3a0de9.javascript | 123,084 | 11/12/2008 |
| cache-1225900847-5e3c9d522f5a2cf9ddbca6f7375085e4.javascript | 111,172 | 11/6/2008 |
| cache-1225900847-6175d916f1418a0795103f3e28b38b9d.javascript | 183,637 | 11/10/2008 |
| cache-1225900847-642696d0a716681e789f209023fca021.javascript | 195,514 | 11/11/2008 |
| cache-1225900847-65c844907266ee063a2b798375d403e8.javascript | 108,951 | 11/11/2008 |
| cache-1225900847-666d06db2446a2bda7929f8ee5408f30.javascript | 109,758 | 11/14/2008 |
| cache-1225900847-6c29581852580c244992556bbad88596.javascript | 124,781 | 11/26/2008 |
| cache-1225900847-6cf4801404abab88125ed8416f82d7de.javascript | 183,724 | 12/1/2008 |
| cache-1225900847-710f5eeae3b6c999c85b09230cd56314.javascript | 168,458 | 11/17/2008 |
| cache-1225900847-760fd40f0ba280bc20a29d565895f2fd.javascript | 196,399 | 11/7/2008 |
| cache-1225900847-7826bc98b318ed5ee1959c1cab1603a9.javascript | 106,714 | 11/17/2008 |
| cache-1225900847-79f61be97c677415ac0143c642cbc91b.javascript | 78,023 | 11/7/2008 |
| cache-1225900847-7cc8bc26fdd14de66fca55c7bfff47f6.javascript | 93,928 | 11/6/2008 |
| cache-1225900847-7eccbc1def6e137cfb477de9f1d5fa26.javascript | 127,002 | 12/5/2008 |
| cache-1225900847-80ce57836472dddedffbe6ea755196fa.javascript | 194,178 | 11/11/2008 |
| cache-1225900847-88acae417641b79a2fbff5832e6782b7.javascript | 127,002 | 11/7/2008 |
| cache-1225900847-8a1f13101d0c8f082d03a6919372fc2a.javascript | 107,537 | 11/11/2008 |
| cache-1225900847-8a2d9cb6db141a2b5c3fb514cda11849.javascript | 194,178 | 11/12/2008 |
| cache-1225900847-8b06ebede5d409dc86c6dc526de21ab3.javascript | 137,543 | 11/10/2008 |
| cache-1225900847-982aa0b536e74472b4c9944879085ab3.javascript | 120,863 | 11/11/2008 |
| cache-1225900847-9acf14af68f8e52d7206bcdf27651684.javascript | 135,322 | 11/13/2008 |
| cache-1225900847-9b9de49e6f87f09e77290ff4b3924af2.javascript | 185,858 | 11/6/2008 |
| cache-1225900847-9daf24cdf62420ee985e99584d43f7d8.javascript | 137,543 | 11/21/2008 |
| cache-1225900847-9db5804a042d0d9ec0c2cfd7265f01b8.javascript | 185,858 | 11/20/2008 |
| cache-1225900847-9ea429641e5c10f855cef007bb7a398c.javascript | 142,647 | 11/11/2008 |
| cache-1225900847-9ef6c9ebc9e9a09a044177d1b3ef3852.javascript | 152,784 | 11/6/2008 |
| cache-1225900847-a2db99f346114a96335d97965ff3ffa3.javascript | 182,752 | 12/2/2008 |
| cache-1225900847-a7519d9712e5305f779b9b4cd626cf0b.javascript | 190,489 | 11/6/2008 |
| cache-1225900847-ab6d2a440f8216565a97226ff05f0f20.javascript | 170,679 | 11/6/2008 |
| cache-1225900847-ac29a6d1d590613a8773766bb7bc0a2d.javascript | 170,028 | 11/24/2008 |
| cache-1225900847-b22bcfa67f927e087018e8481ca00535.javascript | 130,104 | 11/10/2008 |
| cache-1225900847-b3ec44e43e862860421ff01743a9ad9a.javascript | 150,563 | 11/11/2008 |
| cache-1225900847-b4d18c0123b816de2d87113138c08d38.javascript | 172,044 | 11/14/2008 |
| cache-1225900847-b6af4c6ebca3477e9a377e33ad254d9b.javascript | 109,758 | 11/7/2008 |
| cache-1225900847-b883c86156218798c7fdec5a2433456a.javascript | 193,293 | 1/5/2009 |
| cache-1225900847-bdb16c9868f31b3307638999b98b467d.javascript | 124,309 | 11/17/2008 |
| cache-1225900847-c1d58ca38454b39e25e51ac82bc54c9a.javascript | 158,552 | 11/25/2008 |
| cache-1225900847-c1e33cade9e24c9b54409b08089a2a11.javascript | 99,382 | 12/1/2008 |
| cache-1225900847-c2b4c123a1ad5031bea7442ebcb2e553.javascript | 107,254 | 12/9/2008 |
| cache-1225900847-c5f2d8f5ea8450fab6293c26065e29ac.javascript | 109,758 | 11/6/2008 |
| cache-1225900847-c8d84f446ee39b5557a21a094a4dedde.javascript | 188,268 | 11/14/2008 |
| cache-1225900847-cd187cc9c29947ddc4d4cbe1e73673e2.javascript | 154,634 | 11/25/2008 |
| cache-1225900847-cda5fa785fd8c28fa9348f46150544b8.javascript | 154,254 | 11/20/2008 |
| cache-1225900847-ce7183ff107699813b18862cff4c7b9c.javascript | 183,637 | 11/10/2008 |
| cache-1225900847-d1ccb8bbee99899b3d91adcbe7db6c82.javascript | 133,625 | 11/24/2008 |
| cache-1225900847-d2cb4ddd80eddbf58fef59314c4ef2a0.javascript | 194,178 | 11/30/2008 |
| cache-1225900847-d34bb6d0f6577269f59ac9b034909343.javascript | 174,659 | 11/14/2008 |
| cache-1225900847-d85fc66cfb53d482e9f1eb06c01b9e69.javascript | 194,178 | 11/7/2008 |
| cache-1225900847-d9c92dfa339dd8cfbae862e3fa1a00e9.javascript | 123,084 | 11/13/2008 |
| cache-1225900847-e346d2f1b7bd19c08adb27c8cd872f52.javascript | 138,729 | 11/11/2008 |
| cache-1225900847-e3ec9d0646e5e1534a2706ea6fc3ea6e.javascript | 166,110 | 11/7/2008 |
| cache-1225900847-e6e81604c74ed81dbf5e3570ee4264f2.javascript | 185,858 | 11/6/2008 |
| cache-1225900847-e71e788c1979804393b8858473c2b40f.javascript | 143,713 | 11/10/2008 |
| cache-1225900847-ea895c479f8f1c2a0caff521e37248a5.javascript | 131,404 | 11/11/2008 |
| cache-1225900847-ebc7e1eee08f7f044a4da4ba320ea6d3.javascript | 170,962 | 11/17/2008 |
| cache-1225900847-ec1dec6948eb21ff4afe01b260eb8d7b.javascript | 173,183 | 11/6/2008 |
| cache-1225900847-ec9fcbb55b9c7278895b440f948d3b4c.javascript | 145,934 | 11/6/2008 |
| cache-1225900847-ed8d89b11040a290b574ab1c52468946.javascript | 170,962 | 11/11/2008 |
| cache-1225900847-ef14965ca9b6903a782b0927ee9a7348.javascript | 126,530 | 11/6/2008 |
| cache-1225900847-f03402b9991ae5f924fcfeb871935708.javascript | 184,973 | 11/7/2008 |
| cache-1225900847-f33356187c8e4b8d9cff812b5c5f0368.javascript | 169,471 | 11/6/2008 |
| cache-1225900847-f38de6a0d0d453e4cbf6d8bcb4862ff2.javascript | 185,230 | 11/11/2008 |
| cache-1225900847-f3a1fe747d80585f288d65fc5113b96c.javascript | 196,399 | 11/6/2008 |
| cache-1225900847-f8267b404714c41dfc1c5c28f59a82fd.javascript | 108,387 | 11/7/2008 |
| cache-1225900847-fda8ea92b4035d266d617756b8ebed69.javascript | 173,183 | 11/6/2008 |
| cache-1225900847-fe1efc4dc0b6c37f883da0e69ce8f709.javascript | 195,514 | 12/1/2008 |
| cache-1225989046-1ac235721a5be6032c55b81ecc34bf96.javascript | 117,771 | 11/18/2008 |
| cache-1225989046-30e5d994cc072a2a4694ddd028d21798.javascript | 120,763 | 12/1/2008 |
| cache-1225989046-c1d885c60942f2fab118dd757eada0a5.css | 12,052 | 11/6/2008 |
| cache-1225989046-c6e2881a46d00bd770bbf872a6c9907f.javascript | 101,866 | 11/6/2008 |
| cache-1225989046-fcf81d49790caf1539b2e5034ad21a44.css | 42,650 | 11/6/2008 |
| “cache” stats: Files: 160; Folders: 0; Total size: 20,954,686 | | |
| D:\webirs\webirs_source\dokuwiki | | |
| doku.php | 1,794 | 7/25/2007 |
| feed.php | 6,055 | 7/25/2007 |
| index.php | 185 | 7/25/2007 |
| D:\webirs\webirs_source\dokuwiki\bin | | |
| dwpage.php | 9,885 | 7/25/2007 |
| indexer.php | 3,137 | 7/25/2007 |
| wantedpages.php | 3,875 | 7/25/2007 |
| D:\webirs\webirs_source\dokuwiki\conf | | |
| acl.auth.php.dist | 436 | 7/25/2007 |
| acronyms.conf | 5,145 | 7/25/2007 |
| changelog.txt | 0 | 7/25/2007 |
| dokuwiki.php | 7,677 | 7/25/2007 |
| entities.conf | 255 | 7/25/2007 |
| interwiki.conf | 6,347 | 7/25/2007 |
| local.php.dist | 631 | 7/25/2007 |
| mime.conf | 1,104 | 7/25/2007 |
| mysql.conf.php.example | 10,926 | 7/25/2007 |
| smileys.conf | 782 | 7/25/2007 |
| users.auth.php.dist | 151 | 7/25/2007 |
| wordblock.conf | 289,884 | 7/25/2007 |
| words.aspell.dist | 55 | 7/25/2007 |
| D:\webirs\webirs_source\dokuwiki\inc | | |
| actions.php | 8,820 | 7/25/2007 |
| admin_acl.php | 11,152 | 7/25/2007 |
| aspell.php | 8,650 | 7/25/2007 |
| auth.php | 20,489 | 7/25/2007 |
| blowfish.php | 27,604 | 7/25/2007 |
| cliopts.php | 12,251 | 7/25/2007 |
| common.php | 29,965 | 7/25/2007 |
| common.php.bak | 29,600 | 7/25/2007 |
| confutils.php | 3,992 | 7/25/2007 |
| DifferenceEngine.php | 28,368 | 7/25/2007 |
| feedcreator.class.php | 52,848 | 7/25/2007 |
| fulltext.php | 8,132 | 7/25/2007 |
| geshi.php | 90,834 | 7/25/2007 |
| html.php | 32,778 | 7/25/2007 |
| HTTPClient.php | 13,323 | 7/25/2007 |
| indexer.php | 11,946 | 7/25/2007 |
| init.php | 9,324 | 7/25/2007 |
| io.php | 8,564 | 7/25/2007 |
| JpegMeta.php | 103,002 | 7/25/2007 |
| JSON.php | 27,241 | 7/25/2007 |
| mail.php | 7,057 | 7/25/2007 |
| pageutils.php | 8,402 | 7/25/2007 |
| parserutils.php | 11,801 | 9/28/2007 |
| pluginutils.php | 2,234 | 7/25/2007 |
| search.php | 12,868 | 7/25/2007 |
| template.php | 27,037 | 7/25/2007 |
| toolbar.php | 6,647 | 7/25/2007 |
| utf8.php | 44,140 | 7/25/2007 |
| D:\webirs\webirs_source\dokuwiki\inc\auth | | |
| basic.class.php | 8,875 | 7/25/2007 |
| ldap.class.php | 11,385 | 7/25/2007 |
| mysql.class.php | 31,867 | 7/25/2007 |
| pgsql.class.php | 13,142 | 7/25/2007 |
| plain.class.php | 9,406 | 7/25/2007 |
| punbb.class.php | 6,765 | 7/25/2007 |
| D:\webirs\webirs_source\dokuwiki\inc\geshi | | |
| actionscript-french.php | 19,574 | 7/25/2007 |
| actionscript.php | 10,885 | 7/25/2007 |
| ada.php | 3,809 | 7/25/2007 |
| apache.php | 6,325 | 7/25/2007 |
| applescript.php | 3,808 | 7/25/2007 |
| asm.php | 8,731 | 7/25/2007 |
| asp.php | 5,186 | 7/25/2007 |
| autoit.php | 10,166 | 7/25/2007 |
| bash.php | 3,749 | 7/25/2007 |
| blitzbasic.php | 10,942 | 7/25/2007 |
| c.php | 3,986 | 7/25/2007 |
| caddcl.php | 4,094 | 7/25/2007 |
| cadlisp.php | 8,656 | 7/25/2007 |
| cfm.php | 17,446 | 7/25/2007 |
| cpp.php | 6,693 | 7/25/2007 |
| csharp.php | 7,021 | 7/25/2007 |
| css-gen.cfg | 0 | 7/25/2007 |
| css.php | 7,595 | 7/25/2007 |
| c_mac.php | 6,962 | 7/25/2007 |
| d.php | 8,287 | 7/25/2007 |
| delphi.php | 14,896 | 7/25/2007 |
| diff.php | 3,823 | 7/25/2007 |
| div.php | 3,684 | 7/25/2007 |
| dos.php | 5,302 | 7/25/2007 |
| eiffel.php | 8,144 | 7/25/2007 |
| freebasic.php | 5,536 | 7/25/2007 |
| gml.php | 32,621 | 7/25/2007 |
| html4strict.php | 10,514 | 7/25/2007 |
| ini.php | 3,410 | 7/25/2007 |
| inno.php | 12,113 | 7/25/2007 |
| java.php | 43,243 | 7/25/2007 |
| java5.php | 97,339 | 7/25/2007 |
| javascript.php | 4,475 | 7/25/2007 |
| lisp.php | 4,470 | 7/25/2007 |
| lua.php | 5,396 | 7/25/2007 |
| matlab.php | 2,799 | 7/25/2007 |
| mpasm.php | 5,315 | 7/25/2007 |
| mysql.php | 7,583 | 7/25/2007 |
| nsis.php | 18,201 | 7/25/2007 |
| objc.php | 11,740 | 7/25/2007 |
| ocaml-brief.php | 3,589 | 7/25/2007 |
| ocaml.php | 6,868 | 7/25/2007 |
| oobas.php | 4,441 | 7/25/2007 |
| oracle8.php | 8,282 | 7/25/2007 |
| pascal.php | 4,354 | 7/25/2007 |
| perl.php | 6,371 | 7/25/2007 |
| php-brief.php | 12,855 | 7/25/2007 |
| php.php | 21,474 | 7/25/2007 |
| python.php | 10,111 | 7/25/2007 |
| qbasic.php | 5,286 | 7/25/2007 |
| robots.php | 2,966 | 7/25/2007 |
| ruby.php | 4,290 | 7/25/2007 |
| scheme.php | 5,911 | 7/25/2007 |
| sdlbasic.php | 7,109 | 7/25/2007 |
| smarty.php | 6,087 | 7/25/2007 |
| sql.php | 4,354 | 7/25/2007 |
| tsql.php | 21,611 | 7/25/2007 |
| vb.php | 5,998 | 7/25/2007 |
| vbnet.php | 8,493 | 7/25/2007 |
| vhdl.php | 4,905 | 7/25/2007 |
| visualfoxpro.php | 27,069 | 7/25/2007 |
| xml.php | 3,717 | 7/25/2007 |
| D:\webirs\webirs_source\dokuwiki\inc\lang\en | | |
| admin.txt | 104 | 7/25/2007 |
| backlinks.txt | 94 | 7/25/2007 |
| conflict.txt | 349 | 7/25/2007 |
| denied.txt | 110 | 7/25/2007 |
| diff.txt | 124 | 7/25/2007 |
| edit.txt | 232 | 7/25/2007 |
| editrev.txt | 118 | 7/25/2007 |
| index.txt | 112 | 7/25/2007 |
| lang.php | 8,006 | 7/25/2007 |
| locked.txt | 161 | 7/25/2007 |
| login.txt | 154 | 7/25/2007 |
| mailtext.txt | 342 | 7/25/2007 |
| newpage.txt | 184 | 7/25/2007 |
| norev.txt | 152 | 7/25/2007 |
| password.txt | 177 | 7/25/2007 |
| preview.txt | 108 | 7/25/2007 |
| read.txt | 122 | 7/25/2007 |
| recent.txt | 73 | 7/25/2007 |
| register.txt | 312 | 7/25/2007 |
| resendpwd.txt | 231 | 7/25/2007 |
| revisions.txt | 176 | 7/25/2007 |
| searchpage.txt | 216 | 7/25/2007 |
| showrev.txt | 52 | 7/25/2007 |
| stopwords.txt | 407 | 7/25/2007 |
| subscribermail.txt | 393 | 7/25/2007 |
| updateprofile.txt | 140 | 7/25/2007 |
| wordblock.txt | 219 | 7/25/2007 |
| D:\webirs\webirs_source\dokuwiki\inc\magpie | | |
| rss_cache.inc | 6,058 | 7/25/2007 |
| rss_fetch.inc | 15,925 | 7/25/2007 |
| rss_parse.inc | 19,207 | 7/25/2007 |
| rss_utils.inc | 2,056 | 7/25/2007 |
| D:\webirs\webirs_source\dokuwiki\inc\parser | | |
| handler.php | 48,832 | 10/3/2007 |
| lexer.php | 19,882 | 7/25/2007 |
| parser.php | 26,241 | 9/28/2007 |
| renderer.php | 4,656 | 9/28/2007 |
| wiki.php | 6,394 | 9/28/2007 |
| xhtml.php | 33,724 | 5/5/2008 |
| xhtmlsummary.php | 2,520 | 7/25/2007 |
| D:\webirs\webirs_source\dokuwiki\lib\exe | | |
| ajax.php | 1,626 | 7/25/2007 |
| css.php | 8,221 | 4/18/2008 |
| detail.php | 1,684 | 7/25/2007 |
| errors.txt | 21,174 | 7/25/2007 |
| fetch.php | 11,411 | 7/25/2007 |
| indexer.php | 5,264 | 7/25/2007 |
| js.php | 9,171 | 7/25/2007 |
| media.php | 4,605 | 7/25/2007 |
| spellcheck.php | 9,162 | 7/25/2007 |
| D:\webirs\webirs_source\dokuwiki\lib\images | | |
| arrow_down.gif | 273 | 7/25/2007 |
| arrow_up.gif | 274 | 7/25/2007 |
| blank.gif | 42 | 7/25/2007 |
| del.png | 433 | 7/25/2007 |
| diff.png | 219 | 7/25/2007 |
| edit.gif | 142 | 7/25/2007 |
| error.png | 706 | 7/25/2007 |
| history.png | 202 | 7/25/2007 |
| info.png | 783 | 7/25/2007 |
| interwiki.png | 1,089 | 7/25/2007 |
| larger.gif | 87 | 7/25/2007 |
| loading.gif | 1,876 | 7/25/2007 |
| smaller.gif | 86 | 7/25/2007 |
| success.png | 816 | 7/25/2007 |
| D:\webirs\webirs_source\dokuwiki\lib\images\fileicons | | |
| conf.png | 1,226 | 7/25/2007 |
| deb.png | 530 | 7/25/2007 |
| doc.png | 531 | 7/25/2007 |
| file.png | 277 | 7/25/2007 |
| gz.png | 393 | 7/25/2007 |
| htm.png | 796 | 7/25/2007 |
| html.png | 796 | 7/25/2007 |
| odc.png | 1,193 | 7/25/2007 |
| odf.png | 1,088 | 7/25/2007 |
| odg.png | 1,253 | 7/25/2007 |
| odi.png | 1,253 | 7/25/2007 |
| odp.png | 1,146 | 7/25/2007 |
| ods.png | 1,193 | 7/25/2007 |
| odt.png | 1,033 | 7/25/2007 |
| pdf.png | 1,083 | 7/25/2007 |
| ppt.png | 1,075 | 7/25/2007 |
| ps.png | 424 | 7/25/2007 |
| rpm.png | 574 | 7/25/2007 |
| rtf.png | 1,061 | 7/25/2007 |
| sxc.png | 246 | 7/25/2007 |
| sxd.png | 1,111 | 7/25/2007 |
| sxi.png | 1,166 | 7/25/2007 |
| sxw.png | 356 | 7/25/2007 |
| tgz.png | 406 | 7/25/2007 |
| txt.png | 277 | 7/25/2007 |
| xls.png | 1,319 | 7/25/2007 |
| xml.png | 1,059 | 7/25/2007 |
| zip.png | 235 | 7/25/2007 |
| D:\webirs\webirs_source\dokuwiki\lib\images\interwiki | | |
| amazon.de.gif | 882 | 7/25/2007 |
| amazon.gif | 882 | 7/25/2007 |
| amazon.uk.gif | 882 | 7/25/2007 |
| bug.gif | 166 | 7/25/2007 |
| coral.gif | 85 | 7/25/2007 |
| doku.gif | 257 | 7/25/2007 |
| google.gif | 980 | 7/25/2007 |
| meatball.gif | 1,100 | 7/25/2007 |
| phpfn.gif | 330 | 7/25/2007 |
| sb.gif | 886 | 7/25/2007 |
| wiki.gif | 909 | 7/25/2007 |
| wp.gif | 680 | 7/25/2007 |
| wpde.gif | 680 | 7/25/2007 |
| wpmeta.gif | 680 | 7/25/2007 |
| D:\webirs\webirs_source\dokuwiki\lib\images\smileys | | |
| delete.gif | 1,421 | 7/25/2007 |
| fixme.gif | 1,435 | 7/25/2007 |
| icon_arrow.gif | 170 | 7/25/2007 |
| icon_biggrin.gif | 172 | 7/25/2007 |
| icon_confused.gif | 171 | 7/25/2007 |
| icon_cool.gif | 172 | 7/25/2007 |
| icon_cry.gif | 498 | 7/25/2007 |
| icon_doubt.gif | 990 | 7/25/2007 |
| icon_doubt2.gif | 992 | 7/25/2007 |
| icon_eek.gif | 170 | 7/25/2007 |
| icon_evil.gif | 236 | 7/25/2007 |
| icon_exclaim.gif | 236 | 7/25/2007 |
| icon_frown.gif | 171 | 7/25/2007 |
| icon_fun.gif | 590 | 7/25/2007 |
| icon_idea.gif | 176 | 7/25/2007 |
| icon_kaddi.gif | 991 | 7/25/2007 |
| icon_lol.gif | 336 | 7/25/2007 |
| icon_mrgreen.gif | 349 | 7/25/2007 |
| icon_neutral.gif | 171 | 7/25/2007 |
| icon_question.gif | 248 | 7/25/2007 |
| icon_razz.gif | 176 | 7/25/2007 |
| icon_redface.gif | 650 | 7/25/2007 |
| icon_rolleyes.gif | 485 | 7/25/2007 |
| icon_sad.gif | 171 | 7/25/2007 |
| icon_silenced.gif | 231 | 7/25/2007 |
| icon_smile.gif | 174 | 7/25/2007 |
| icon_smile2.gif | 174 | 7/25/2007 |
| icon_surprised.gif | 174 | 7/25/2007 |
| icon_twisted.gif | 238 | 7/25/2007 |
| icon_wink.gif | 170 | 7/25/2007 |
| D:\webirs\webirs_source\dokuwiki\lib\images\toolbar | | |
| bold.png | 433 | 7/25/2007 |
| chars.png | 594 | 7/25/2007 |
| h1.png | 387 | 7/25/2007 |
| h2.png | 453 | 7/25/2007 |
| h3.png | 464 | 7/25/2007 |
| h4.png | 429 | 7/25/2007 |
| h5.png | 437 | 7/25/2007 |
| hr.png | 329 | 7/25/2007 |
| image.png | 594 | 7/25/2007 |
| italic.png | 322 | 7/25/2007 |
| link.png | 554 | 7/25/2007 |
| linkextern.png | 962 | 7/25/2007 |
| mono.png | 385 | 7/25/2007 |
| ol.png | 403 | 7/25/2007 |
| sig.png | 569 | 7/25/2007 |
| smiley.png | 730 | 7/25/2007 |
| spellcheck.png | 558 | 7/25/2007 |
| spellnoerr.png | 593 | 7/25/2007 |
| spellstop.png | 576 | 7/25/2007 |
| spellwait.gif | 3,035 | 7/25/2007 |
| strike.png | 415 | 7/25/2007 |
| ul.png | 383 | 7/25/2007 |
| underline.png | 375 | 7/25/2007 |
| D:\webirs\webirs_source\dokuwiki\lib\plugins | | |
| acl | | 1/23/2009 |
| config | | 1/23/2009 |
| info | | 1/23/2009 |
| plugin | | 1/23/2009 |
| usermanager | | 1/23/2009 |
| admin.php | 5,961 | 7/25/2007 |
| syntax.php | 7,697 | 7/25/2007 |
| D:\webirs\webirs_source\dokuwiki\lib\plugins\acl | | |
| admin.php | 13,842 | 7/25/2007 |
| style.css | 144 | 7/25/2007 |
| D:\webirs\webirs_source\dokuwiki\lib\plugins\config | | |
| admin.php | 6,629 | 7/25/2007 |
| style.css | 875 | 7/25/2007 |
| D:\webirs\webirs_source\dokuwiki\lib\plugins\info | | |
| syntax.php | 4,548 | 7/25/2007 |
| D:\webirs\webirs_source\dokuwiki\lib\plugins\plugin | | |
| admin.php | 23,156 | 7/25/2007 |
| style.css | 2,015 | 7/25/2007 |
| D:\webirs\webirs_source\dokuwiki\lib\plugins\usermanager | | |
| admin.php | 18,083 | 7/25/2007 |
| style.css | 391 | 7/25/2007 |
| D:\webirs\webirs_source\dokuwiki\lib\scripts | | |
| ajax.js | 1,900 | 7/25/2007 |
| domLib.js | 15,932 | 7/25/2007 |
| domTT.js | 27,993 | 7/25/2007 |
| edit.js | 15,014 | 7/25/2007 |
| events.js | 3,043 | 7/25/2007 |
| pngbehavior.htc | 1,287 | 7/25/2007 |
| script.js | 10,343 | 7/25/2007 |
| spellcheck.js | 13,031 | 7/25/2007 |
| tw-sack.js | 4,321 | 7/25/2007 |
| D:\webirs\webirs_source\dokuwiki\lib\styles | | |
| feed.css | 1,329 | 7/25/2007 |
| spellcheck.css | 709 | 7/25/2007 |
| style.css | 1,923 | 7/25/2007 |
| D:\webirs\webirs_source\dokuwiki\lib\tpl\default | | |
| design.css | 16,964 | 5/5/2008 |
| detail.php | 2,959 | 7/25/2007 |
| footer.html | 2,930 | 7/25/2007 |
| layout.css | 2,273 | 7/25/2007 |
| main.php | 3,416 | 7/25/2007 |
| media.php | 1,429 | 7/25/2007 |
| mediaedit.php | 3,452 | 7/25/2007 |
| mediaref.php | 1,353 | 7/25/2007 |
| print.css | 3,501 | 7/25/2007 |
| rtl.css | 1,808 | 7/25/2007 |
| style.ini | 1,306 | 7/25/2007 |
| D:\webirs\webirs_source\error | | |
| error.html | 5,287 | 7/25/2007 |
| error.php | 4,349 | 4/21/2008 |
| error.tpl | 10,006 | 4/21/2008 |
| showSource.php | 2,504 | 7/25/2007 |
| D:\webirs\webirs_source\gorum2 | | |
| adodb-time.php | 28,561 | 11/8/2007 |
| category.php | 11,424 | 8/29/2008 |
| changename.php | 1,300 | 11/8/2007 |
| charconvert.php | 619 | 11/8/2007 |
| constants.php | 5,850 | 8/29/2008 |
| date.php | 24,448 | 11/4/2008 |
| dbproperty.php | 14,337 | 10/2/2008 |
| dbtreeproperty.php | 3,800 | 11/8/2007 |
| flood.php | 818 | 11/8/2007 |
| form.php | 981 | 4/6/2008 |
| g.php | 3,957 | 4/6/2008 |
| gorum.php | 2,631 | 5/27/2008 |
| gorum2.kpf | 556 | 11/8/2007 |
| gorumlib.php | 12,746 | 4/6/2008 |
| gorum_db.php | 1,779 | 5/27/2008 |
| hasmany.php | 6,425 | 11/8/2007 |
| htmllist.php | 5,552 | 5/27/2008 |
| imap.php | 910 | 11/8/2007 |
| init.php | 12,764 | 4/6/2008 |
| installlib.php | 20,152 | 11/22/2007 |
| javascript.php | 4,937 | 4/18/2008 |
| loginlib.php | 9,387 | 4/6/2008 |
| loginlib_high.php | 3,257 | 11/8/2007 |
| object.php | 33,333 | 4/6/2008 |
| privilegeproperty.php | 6,095 | 4/6/2008 |
| relativedate.php | 8,880 | 9/10/2008 |
| roll.php | 8,722 | 4/6/2008 |
| Savant2.php | 39,161 | 11/8/2007 |
| sqlparser.php | 73,520 | 11/8/2007 |
| stopwatch.php | 1,660 | 11/8/2007 |
| tools.php | 19,670 | 4/6/2008 |
| updatelib.php | 699 | 11/8/2007 |
| user_email.php | 21,086 | 4/6/2008 |
| user_high.php | 7,528 | 4/6/2008 |
| user_simple.php | 24,778 | 4/6/2008 |
| view.php | 5,370 | 4/6/2008 |
| xdebug.php | 475 | 4/6/2008 |
| D:\webirs\webirs_source\gorum2\js | | |
| bind.js | 2,038 | 11/8/2007 |
| cookie.js | 1,377 | 11/8/2007 |
| core.js | 13,324 | 11/8/2007 |
| dump.js | 9,476 | 11/8/2007 |
| fsmenu.js | 17,324 | 11/8/2007 |
| pngfix.js | 1,412 | 11/8/2007 |
| popupmain.js | 7,601 | 11/8/2007 |
| usableforms.js | 3,916 | 4/18/2008 |
| usableforms.unpacked.js | 6,364 | 4/18/2008 |
| widget.js | 4,548 | 11/8/2007 |
| D:\webirs\webirs_source\gorum2\js\jquery | | |
| alphanumeric.zip | 15,276 | 4/6/2008 |
| curvycorners-unpacked.js | 38,506 | 4/18/2008 |
| curvycorners.js | 14,868 | 4/18/2008 |
| form-unpacked.js | 30,591 | 4/18/2008 |
| form.js | 7,072 | 4/18/2008 |
| jqDnR.js | 1,294 | 11/8/2007 |
| jqmodal-doc.html | 9,269 | 11/8/2007 |
| jQmodal-unpacked.js | 3,272 | 4/18/2008 |
| jqModal.css | 1,382 | 11/8/2007 |
| jqModal.js | 3,319 | 10/2/2008 |
| jquery.alphanumeric.js | 1,534 | 1/11/2008 |
| jquery.asmselect.css | 1,077 | 10/17/2008 |
| jquery.asmselect.js | 10,373 | 10/17/2008 |
| jquery.bgiframe.js | 1,701 | 11/8/2007 |
| jquery.color-unpacked.js | 3,660 | 4/18/2008 |
| jquery.color.js | 2,219 | 4/18/2008 |
| jquery.compat-1.1.js | 1,286 | 11/8/2007 |
| jquery.dimensions-unpacked.js | 23,943 | 4/18/2008 |
| jquery.dimensions.js | 7,040 | 4/18/2008 |
| jquery.dump.js | 11,946 | 11/8/2007 |
| jquery.fluidtyping.js | 883 | 1/9/2008 |
| jquery.hoverIntent.js | 4,605 | 11/8/2007 |
| jquery.js | 54,075 | 4/18/2008 |
| jquery.maskedinput.js | 7,805 | 1/4/2008 |
| json.js | 3,053 | 11/8/2007 |
| tablehover-unpacked.js | 13,233 | 4/18/2008 |
| tablehover.js | 3,042 | 4/18/2008 |
| tablesort-unpacked.js | 31,422 | 4/18/2008 |
| tablesort.js | 12,784 | 4/18/2008 |
| D:\webirs\webirs_source\gorum2\js\jquery\cluetip | | |
| arrowleft.gif | 76 | 11/8/2007 |
| arrowright.gif | 77 | 11/8/2007 |
| bl.gif | 5,565 | 11/8/2007 |
| bl.png | 3,065 | 11/8/2007 |
| br.gif | 1,648 | 11/8/2007 |
| br.png | 901 | 11/8/2007 |
| jquery.cluetip-unpacked.js | 22,690 | 4/18/2008 |
| jquery.cluetip.css | 2,647 | 11/8/2007 |
| jquery.cluetip.js | 5,932 | 4/18/2008 |
| loader.gif | 958 | 11/8/2007 |
| shadow.png | 6,245 | 11/8/2007 |
| Thumbs.db | 10,240 | 11/8/2007 |
| tl.gif | 1,135 | 11/8/2007 |
| tl.png | 606 | 11/8/2007 |
| tr.gif | 672 | 11/8/2007 |
| tr.png | 731 | 11/8/2007 |
| wait.gif | 432 | 11/8/2007 |
| D:\webirs\webirs_source\gorum2\js\jquery\markitup | | |
| jquery.markitup.js | 16,997 | 9/10/2008 |
| jquery.markitup.pack.js | 8,256 | 9/10/2008 |
| readme.txt | 2,267 | 9/10/2008 |
| D:\webirs\webirs_source\gorum2\js\jscalendar | | |
| bugtest-hidden-selects.html | 4,101 | 4/6/2008 |
| calendar-blue.css | 4,830 | 4/6/2008 |
| calendar-blue2.css | 5,006 | 4/6/2008 |
| calendar-brown.css | 4,716 | 4/6/2008 |
| calendar-green.css | 4,781 | 4/6/2008 |
| calendar-setup.js | 4,919 | 4/18/2008 |
| calendar-system.css | 5,707 | 4/6/2008 |
| calendar-tas.css | 5,309 | 4/6/2008 |
| calendar-win2k-1.css | 5,986 | 4/6/2008 |
| calendar-win2k-2.css | 5,986 | 4/6/2008 |
| calendar-win2k-cold-1.css | 5,782 | 4/6/2008 |
| calendar-win2k-cold-2.css | 5,986 | 4/6/2008 |
| calendar.js | 49,446 | 5/27/2008 |
| calendar.php | 4,490 | 4/6/2008 |
| ChangeLog | 25,100 | 4/6/2008 |
| dayinfo.html | 3,039 | 4/6/2008 |
| img.gif | 223 | 4/6/2008 |
| index.html | 12,703 | 4/6/2008 |
| menuarrow.gif | 68 | 4/6/2008 |
| menuarrow2.gif | 49 | 4/6/2008 |
| multiple-dates.html | 2,929 | 4/6/2008 |
| README | 910 | 4/6/2008 |
| release-notes.html | 18,436 | 4/6/2008 |
| simple-1.html | 9,448 | 4/6/2008 |
| simple-2.html | 3,738 | 4/6/2008 |
| simple-3.html | 4,486 | 4/6/2008 |
| D:\webirs\webirs_source\gorum2\js\jscalendar\doc | | |
| reference.pdf | 281,155 | 4/6/2008 |
| D:\webirs\webirs_source\gorum2\js\jscalendar\lang | | |
| calendar-af.js | 1,011 | 4/6/2008 |
| calendar-al.js | 2,135 | 4/6/2008 |
| calendar-bg.js | 3,723 | 4/6/2008 |
| calendar-big5-utf8.js | 3,525 | 4/6/2008 |
| calendar-big5.js | 3,290 | 4/6/2008 |
| calendar-br.js | 3,706 | 4/6/2008 |
| calendar-ca.js | 3,597 | 4/6/2008 |
| calendar-cs-utf8.js | 2,824 | 4/6/2008 |
| calendar-cs-win.js | 2,705 | 4/6/2008 |
| calendar-da.js | 3,500 | 4/6/2008 |
| calendar-de.js | 3,863 | 4/6/2008 |
| calendar-du.js | 1,143 | 4/6/2008 |
| calendar-el.js | 3,241 | 4/6/2008 |
| calendar-en.js | 3,600 | 4/6/2008 |
| calendar-es.js | 3,917 | 4/6/2008 |
| calendar-fi.js | 2,782 | 4/6/2008 |
| calendar-fr.js | 3,743 | 4/6/2008 |
| calendar-he-utf8.js | 3,919 | 4/6/2008 |
| calendar-hr-utf8.js | 1,553 | 4/6/2008 |
| calendar-hr.js | 3,088 | 4/6/2008 |
| calendar-hu.js | 3,603 | 4/6/2008 |
| calendar-it.js | 3,633 | 4/6/2008 |
| calendar-jp.js | 913 | 4/6/2008 |
| calendar-ko-utf8.js | 3,568 | 4/6/2008 |
| calendar-ko.js | 3,256 | 4/6/2008 |
| calendar-lt-utf8.js | 3,432 | 4/6/2008 |
| calendar-lt.js | 3,400 | 4/6/2008 |
| calendar-lv.js | 3,603 | 4/6/2008 |
| calendar-nl.js | 2,234 | 4/6/2008 |
| calendar-no.js | 3,178 | 4/6/2008 |
| calendar-pl-utf8.js | 2,635 | 4/6/2008 |
| calendar-pl.js | 2,414 | 4/6/2008 |
| calendar-pt.js | 3,526 | 4/6/2008 |
| calendar-ro.js | 2,058 | 4/6/2008 |
| calendar-ru.js | 4,357 | 4/6/2008 |
| calendar-ru_win_.js | 3,643 | 4/6/2008 |
| calendar-si.js | 2,684 | 4/6/2008 |
| calendar-sk.js | 2,661 | 4/6/2008 |
| calendar-sp.js | 3,015 | 4/6/2008 |
| calendar-sv.js | 3,205 | 4/6/2008 |
| calendar-tr.js | 1,736 | 4/6/2008 |
| calendar-zh.js | 3,082 | 4/6/2008 |
| cn_utf8.js | 4,630 | 4/6/2008 |
| D:\webirs\webirs_source\gorum2\lang | | |
| lang_en.php | 23,378 | 5/27/2008 |
| D:\webirs\webirs_source\gorum2\presentation | | |
| deleteformpresentation.php | 2,194 | 4/6/2008 |
| detailspresentation.php | 2,129 | 4/6/2008 |
| filter.php | 1,677 | 11/8/2007 |
| formpresentation.php | 24,483 | 10/17/2008 |
| generdatewidget.php | 14,643 | 10/2/2008 |
| genervoicewidget.php | 2,446 | 11/8/2007 |
| generwidget.php | 12,480 | 10/17/2008 |
| listpresentation.php | 7,950 | 5/27/2008 |
| lllproperties.php | 2,177 | 4/6/2008 |
| presentation.php | 1,677 | 4/6/2008 |
| D:\webirs\webirs_source\gorum2\Savant2 | | |
| Compiler.php | 1,395 | 11/8/2007 |
| Error.php | 2,034 | 11/8/2007 |
| Filter.php | 1,467 | 11/8/2007 |
| package.xml | 16,186 | 11/8/2007 |
| PHPCodeAnalyzer.php | 10,741 | 4/18/2008 |
| Plugin.php | 1,412 | 11/8/2007 |
| Savant2_Compiler_basic.php | 17,538 | 11/8/2007 |
| Savant2_Error_exception.php | 1,214 | 11/8/2007 |
| Savant2_Error_pear.php | 1,239 | 11/8/2007 |
| Savant2_Error_stack.php | 1,408 | 11/8/2007 |
| Savant2_Filter_colorizeCode.php | 3,640 | 11/8/2007 |
| Savant2_Filter_stripLinks.php | 517 | 11/8/2007 |
| Savant2_Filter_trimwhitespace.php | 3,128 | 11/8/2007 |
| Savant2_Plugin_ahref.php | 2,655 | 11/8/2007 |
| Savant2_Plugin_checkbox.php | 2,635 | 11/8/2007 |
| Savant2_Plugin_cycle.php | 2,380 | 11/8/2007 |
| Savant2_Plugin_dateformat.php | 3,143 | 11/8/2007 |
| Savant2_Plugin_form.php | 38,287 | 11/8/2007 |
| Savant2_Plugin_image.php | 4,934 | 11/8/2007 |
| Savant2_Plugin_input.php | 2,000 | 11/8/2007 |
| Savant2_Plugin_javascript.php | 1,322 | 11/8/2007 |
| Savant2_Plugin_modify.php | 2,163 | 11/8/2007 |
| Savant2_Plugin_options.php | 3,104 | 11/8/2007 |
| Savant2_Plugin_radios.php | 3,440 | 11/8/2007 |
| Savant2_Plugin_stylesheet.php | 1,347 | 11/8/2007 |
| Savant2_Plugin_textarea.php | 2,125 | 11/8/2007 |
| D:\webirs\webirs_source\gorum2\templates\style01 | | |
| default_deleteform.tpl.php | 920 | 11/8/2007 |
| default_details.tpl.php | 1,466 | 11/8/2007 |
| default_form.tpl.php | 2,344 | 11/8/2007 |
| default_list.tpl.php | 2,019 | 4/6/2008 |
| D:\webirs\webirs_source\gorum2\templates\style02 | | |
| default_deleteform.tpl.php | 913 | 11/8/2007 |
| default_details.tpl.php | 1,839 | 1/16/2008 |
| default_form.tpl.php | 2,512 | 11/8/2007 |
| default_list.tpl.php | 2,085 | 4/6/2008 |
| D:\webirs\webirs_source\gorum2\templates\style03 | | |
| default_deleteform.tpl.php | 1,106 | 11/8/2007 |
| default_details.tpl.php | 1,959 | 11/8/2007 |
| default_form.tpl.php | 2,792 | 11/8/2007 |
| default_list.tpl.php | 2,455 | 4/6/2008 |
| D:\webirs\webirs_source\gorum2\templates\style04 | | |
| default_deleteform.tpl.php | 913 | 9/10/2008 |
| default_details.tpl.php | 1,839 | 9/10/2008 |
| default_form.tpl.php | 2,512 | 9/10/2008 |
| default_list.tpl.php | 2,479 | 9/10/2008 |
| D:\webirs\webirs_source\gorum2\tests | | |
| all_tests.php | 276 | 4/6/2008 |
| date_test.php | 301 | 4/6/2008 |
| D:\webirs\webirs_source\handler | | |
| handler.php | 6,450 | 9/10/2008 |
| handler_artissue.php | 4,089 | 9/10/2008 |
| handler_expenseitem.php | 676 | 9/10/2008 |
| handler_issue.php | 6,110 | 9/10/2008 |
| handler_project.php | 629 | 10/17/2008 |
| handler_resaleitem.php | 240 | 9/10/2008 |
| log.php | 6,845 | 9/10/2008 |
| logaction.php | 7,244 | 9/10/2008 |
| logsubscription.php | 4,700 | 11/18/2008 |
| notification.php | 27,662 | 10/2/2008 |
| notifsubscription.php | 13,997 | 10/23/2008 |
| D:\webirs\webirs_source\images | | |
| arrow2_bottom.gif | 98 | 12/19/2007 |
| arrow2_down.gif | 78 | 7/25/2007 |
| arrow2_top.gif | 98 | 12/19/2007 |
| arrow2_up.gif | 76 | 7/25/2007 |
| arrowleft.gif | 76 | 11/8/2007 |
| arrowright.gif | 77 | 11/8/2007 |
| arrow_down.gif | 87 | 7/25/2007 |
| arrow_up.gif | 84 | 7/25/2007 |
| asc.gif | 54 | 7/25/2007 |
| b.gif | 43 | 7/25/2007 |
| banner_bg.jpg | 7,277 | 11/8/2007 |
| bell_small.gif | 1,191 | 11/8/2007 |
| busy.gif | 1,608 | 7/25/2007 |
| close-dark.png | 699 | 10/17/2008 |
| close_icon.png | 183 | 12/19/2007 |
| custom_logo.gif | 3,040 | 11/7/2007 |
| desc.gif | 55 | 7/25/2007 |
| exp.gif | 399 | 7/25/2007 |
| minus.gif | 76 | 7/25/2007 |
| no.gif | 564 | 7/25/2007 |
| plus.gif | 115 | 7/25/2007 |
| resize.gif | 862 | 10/17/2008 |
| resize.jpg | 434 | 11/8/2007 |
| sortable.gif | 63 | 11/8/2007 |
| sorted_down.gif | 71 | 11/8/2007 |
| sorted_up.gif | 71 | 11/8/2007 |
| wait.gif | 432 | 11/8/2007 |
| webirs_logo_big.gif | 4,255 | 11/8/2007 |
| webirs_logo_small.gif | 1,361 | 11/8/2007 |
| workrep.gif | 411 | 7/25/2007 |
| yes.gif | 369 | 7/25/2007 |
| D:\webirs\webirs_source\images\icons | | |
| cog_go.png | 859 | 8/14/2007 |
| filter.gif | 321 | 8/14/2007 |
| page-first-disabled.gif | 925 | 8/14/2007 |
| page-first.gif | 925 | 8/14/2007 |
| page-last-disabled.gif | 923 | 8/14/2007 |
| page-last.gif | 923 | 8/14/2007 |
| page-next-disabled.gif | 875 | 8/14/2007 |
| page-next.gif | 875 | 8/14/2007 |
| page-prev-disabled.gif | 879 | 8/14/2007 |
| page-prev.gif | 879 | 8/14/2007 |
| sortable.gif | 68 | 8/14/2007 |
| sorted_down.gif | 77 | 8/14/2007 |
| sorted_up.gif | 77 | 8/14/2007 |
| space.gif | 80 | 8/14/2007 |
| submenuArrow.png | 179 | 8/14/2007 |
| text_align_center.png | 234 | 8/14/2007 |
| text_align_left.png | 209 | 8/14/2007 |
| text_align_right.png | 209 | 8/14/2007 |
| text_bold.png | 304 | 8/14/2007 |
| text_italic.png | 223 | 8/14/2007 |
| text_underline.png | 273 | 8/14/2007 |
| toolbar.gif | 91 | 8/14/2007 |
| D:\webirs\webirs_source\images\jscalendar | | |
| active-bg.gif | 89 | 4/18/2008 |
| dark-bg.gif | 85 | 4/18/2008 |
| hover-bg.gif | 89 | 4/18/2008 |
| menuarrow.gif | 49 | 4/18/2008 |
| normal-bg.gif | 110 | 4/18/2008 |
| rowhover-bg.gif | 110 | 4/18/2008 |
| status-bg.gif | 116 | 4/18/2008 |
| title-bg.gif | 116 | 4/18/2008 |
| today-bg.gif | 1,122 | 4/18/2008 |
| D:\webirs\webirs_source\images\markitup | | |
| bg-container.png | 28,455 | 9/10/2008 |
| bg-editor-bbcode.png | 1,642 | 9/10/2008 |
| bg-editor-dotclear.png | 1,682 | 9/10/2008 |
| bg-editor-html.png | 1,534 | 9/10/2008 |
| bg-editor-json.png | 1,529 | 9/10/2008 |
| bg-editor-markdown.png | 1,783 | 9/10/2008 |
| bg-editor-textile.png | 1,659 | 9/10/2008 |
| bg-editor-wiki.png | 1,488 | 9/10/2008 |
| bg-editor-xml.png | 1,495 | 9/10/2008 |
| bg-editor.png | 1,745 | 9/10/2008 |
| bold.png | 304 | 9/10/2008 |
| code.png | 859 | 9/10/2008 |
| h1.png | 276 | 9/10/2008 |
| h2.png | 304 | 9/10/2008 |
| h3.png | 306 | 9/10/2008 |
| h4.png | 293 | 9/10/2008 |
| h5.png | 304 | 9/10/2008 |
| h6.png | 310 | 9/10/2008 |
| handle.png | 258 | 9/10/2008 |
| italic.png | 223 | 9/10/2008 |
| link.png | 343 | 9/10/2008 |
| list-bullet.png | 344 | 9/10/2008 |
| list-numeric.png | 357 | 9/10/2008 |
| menu.png | 27,151 | 9/10/2008 |
| picture.png | 606 | 9/10/2008 |
| preview.png | 537 | 9/10/2008 |
| quotes.png | 743 | 9/10/2008 |
| stroke.png | 269 | 9/10/2008 |
| submenu.png | 240 | 9/10/2008 |
| url.png | 957 | 9/10/2008 |
| D:\webirs\webirs_source\lang | | |
| lang_en.php | 61,162 | 10/2/2008 |
| D:\webirs\webirs_source\language | | |
| phpmailer.lang-en.php | 1,062 | 4/6/2008 |
| D:\webirs\webirs_source\phpdoc | | |
| blank.html | 401 | 1/14/2009 |
| classtrees_WebIRS.html | 6,319 | 1/14/2009 |
| elementindex.html | 387,804 | 1/14/2009 |
| elementindex_WebIRS.html | 388,105 | 1/14/2009 |
| errors.html | 14,065 | 1/14/2009 |
| index.html | 934 | 1/14/2009 |
| li_WebIRS.html | 40,082 | 1/14/2009 |
| packages.html | 906 | 1/14/2009 |
| D:\webirs\webirs_source\phpdoc\HTMLframesConverter\default | | |
| blank.html | 381 | 1/13/2009 |
| classtrees_Savant2.html | 865 | 1/13/2009 |
| classtrees_WebIRS.html | 6,079 | 1/13/2009 |
| elementindex.html | 630,575 | 1/13/2009 |
| elementindex_Savant2.html | 21,852 | 1/13/2009 |
| elementindex_WebIRS.html | 614,182 | 1/13/2009 |
| errors.html | 167,113 | 1/13/2009 |
| index.html | 934 | 1/13/2009 |
| li_Savant2.html | 1,366 | 1/13/2009 |
| li_WebIRS.html | 58,134 | 1/13/2009 |
| packages.html | 1,145 | 1/13/2009 |
| D:\webirs\webirs_source\phpdoc\HTMLframesConverter\ | | |
| default\26d3399f63abd43a7d72f8c21440dcb0 | | |
| %%-13\hat{ }%%-135052920\hat{ }header.tpl.php | 750 | 3/30/2008 |
| %%-17\hat{ }%%-1708446885\hat{ }blank.tpl.php | 711 | 3/30/2008 |
| %%-19\hat{ }%%-1910644431\hat{ }basicindex.tpl.php | 11,355 | 3/30/2008 |
| %%-20\hat{ }%%-2040098360\hat{ }filesource.tpl.php | 958 | 3/30/2008 |
| %%-39\hat{ }%%-392581648\hat{ }top_frame.tpl.php | 6,008 | 3/30/2008 |
| %%-65\hat{ }%%-658603405\hat{ }page.tpl.php | 12,059 | 3/30/2008 |
| %%-72\hat{ }%%-727729411\hat{ }left_frame.tpl.php | 32,304 | 3/30/2008 |
| %%117\hat{ }%%1172603085\hat{ }index.tpl.php | 1,178 | 3/30/2008 |
| %%127\hat{ }%%12781687\hat{ }pkgelementindex.tpl.php | 3,036 | 3/30/2008 |
| %%131\hat{ }%%131447552\hat{ }elementindex.tpl.php | 2,707 | 3/30/2008 |
| %%202\hat{ }%%2027336986\hat{ }classtrees.tpl.php | 5,071 | 3/30/2008 |
| %%239\hat{ }%%239105369\hat{ }footer.tpl.php | 492 | 3/30/2008 |
| %%972\hat{ }%%972954595\hat{ }docblock.tpl.php | 2,394 | 3/30/2008 |
| D:\webirs\webirs_source\phpdoc\HTMLframesConverter\default\media | | |
| banner.css | 425 | 1/13/2009 |
| stylesheet.css | 5,551 | 1/13/2009 |
| D:\webirs\webirs_source\phpdoc\HTMLframesConverter\default\Savant2 | | |
| Savant2.html | 72,868 | 1/13/2009 |
| _alloc---gorum2---Savant2.php.html | 5,571 | 1/13/2009 |
| _gorum2---Savant2.php.html | 1,936 | 1/13/2009 |
| D:\webirs\webirs_source\phpdoc\HTMLframesConverter\default\WebIRS | | |
| AllocError.html | 3,954 | 1/13/2009 |
| AllocXajaxResponse.html | 8,494 | 1/13/2009 |
| AppCategory.html | 12,781 | 1/13/2009 |
| AppInit.html | 12,979 | 1/13/2009 |
| AppObject.html | 59,891 | 1/13/2009 |
| AppUser.html | 18,814 | 1/13/2009 |
| Article.html | 37,048 | 1/13/2009 |
| ArticleSearch.html | 19,946 | 1/13/2009 |
| ArticleSearchQuery.html | 8,629 | 1/13/2009 |
| ArtIssue.html | 37,345 | 1/13/2009 |
| ArtIssueHandler.html | 14,743 | 1/13/2009 |
| ArtIssueSearch.html | 33,054 | 1/13/2009 |
| ArtPrIssue.html | 75,256 | 1/13/2009 |
| Attach.html | 18,170 | 1/13/2009 |
| Breadcrumb.html | 4,538 | 1/13/2009 |
| Cache.html | 4,767 | 1/13/2009 |
| Category.html | 20,686 | 1/13/2009 |
| CategoryReport.html | 4,464 | 1/13/2009 |
| CharConvert.html | 5,828 | 1/13/2009 |
| Client.html | 12,347 | 1/13/2009 |
| ClientGroup.html | 4,568 | 1/13/2009 |
| Date.html | 90,825 | 1/13/2009 |
| DeleteFormPresentation.html | 4,511 | 1/13/2009 |
| DetailsPresentation.html | 6,290 | 1/13/2009 |
| DisplayError.html | 3,186 | 1/13/2009 |
| DistributedItemDef.html | 10,630 | 1/13/2009 |
| EmployeeActivityReport.html | 23,151 | 1/13/2009 |
| EmployeeReport.html | 4,465 | 1/13/2009 |
| ExpenseItem.html | 28,669 | 1/13/2009 |
| ExpenseItemHandler.html | 8,365 | 1/13/2009 |
| Filter.html | 10,853 | 1/13/2009 |
| FirePHP.html | 26,880 | 1/13/2009 |
| Flag.html | 15,250 | 1/13/2009 |
| Flood.html | 1,279 | 1/13/2009 |
| FormDisplayType.html | 6,040 | 1/13/2009 |
| FormPresentation.html | 54,966 | 1/13/2009 |
| G.html | 12,696 | 1/13/2009 |
| GenerDateWidget.html | 13,147 | 1/13/2009 |
| GenerVoiceWidget.html | 4,072 | 1/13/2009 |
| GenerWidget.html | 33,441 | 1/13/2009 |
| Handler.html | 20,532 | 1/13/2009 |
| HasMany.html | 15,010 | 1/13/2009 |
| HasManyAttrs.html | 8,841 | 1/13/2009 |
| HasManyWithLinkClass.html | 12,084 | 1/13/2009 |
| HasManyWithoutLinkClass.html | 14,834 | 1/13/2009 |
| Init.html | 19,634 | 1/13/2009 |
| Issue.html | 87,978 | 1/13/2009 |
| IssueHandler.html | 20,173 | 1/13/2009 |
| IssueListPresentation.html | 5,043 | 1/13/2009 |
| IssueSearch.html | 36,830 | 1/13/2009 |
| IssueSearchQuery.html | 49,788 | 1/13/2009 |
| Item.html | 47,320 | 1/13/2009 |
| ItemList.html | 8,605 | 1/13/2009 |
| ItemReport.html | 15,311 | 1/13/2009 |
| ItemSearch.html | 7,860 | 1/13/2009 |
| JavaScript.html | 27,608 | 1/13/2009 |
| Labor.html | 6,297 | 1/13/2009 |
| ListPresentation.html | 9,452 | 1/13/2009 |
| LllProperties.html | 16,273 | 1/13/2009 |
| Log.html | 18,185 | 1/13/2009 |
| LogAction.html | 10,974 | 1/13/2009 |
| LogSubscription.html | 21,775 | 1/13/2009 |
| MilageRate.html | 14,649 | 1/13/2009 |
| MilageReport.html | 29,227 | 1/13/2009 |
| Note.html | 32,515 | 1/13/2009 |
| NoteList.html | 9,332 | 1/13/2009 |
| Notif.html | 19,960 | 1/13/2009 |
| NotifSubscription.html | 33,012 | 1/13/2009 |
| Object.html | 74,532 | 1/13/2009 |
| ObjectNoteList.html | 10,821 | 1/13/2009 |
| PayrollReport.html | 6,235 | 1/13/2009 |
| Period.html | 66,518 | 1/13/2009 |
| PeriodList.html | 8,643 | 1/13/2009 |
| Perm.html | 57,774 | 1/13/2009 |
| PermGroup.html | 4,532 | 1/13/2009 |
| Permission.html | 25,678 | 1/13/2009 |
| PHPMailer.html | 65,294 | 1/13/2009 |
| Portal.html | 12,023 | 1/13/2009 |
| PortalAttr.html | 15,211 | 1/13/2009 |
| Presentation.html | 8,459 | 1/13/2009 |
| PriorityIndex.html | 9,680 | 1/13/2009 |
| PrIssueSearch.html | 33,072 | 1/13/2009 |
| Project.html | 47,047 | 1/13/2009 |
| ProjectHandler.html | 11,436 | 1/13/2009 |
| ProjectSearch.html | 21,555 | 1/13/2009 |
| ProjectSearchQuery.html | 24,592 | 1/13/2009 |
| Rate.html | 20,622 | 1/13/2009 |
| ReadState.html | 3,838 | 1/13/2009 |
| RecurringItemDef.html | 6,616 | 1/13/2009 |
| ReimbursableItem.html | 23,600 | 1/13/2009 |
| RelativeDate.html | 21,309 | 1/13/2009 |
| Report.html | 13,698 | 1/13/2009 |
| ResaleItem.html | 27,612 | 1/13/2009 |
| ResaleItemHandler.html | 7,045 | 1/13/2009 |
| Roll.html | 13,445 | 1/13/2009 |
| Search.html | 7,692 | 1/13/2009 |
| SearchQuery.html | 27,975 | 1/13/2009 |
| Settings.html | 1,275 | 1/13/2009 |
| SMTP.html | 32,760 | 1/13/2009 |
| SpecItem.html | 11,664 | 1/13/2009 |
| SpecItemDef.html | 20,576 | 1/13/2009 |
| Stopwatch.html | 5,005 | 1/13/2009 |
| User.html | 19,325 | 1/13/2009 |
| Vacation.html | 12,168 | 1/13/2009 |
| VacationReport.html | 4,465 | 1/13/2009 |
| VarFields.html | 9,764 | 1/13/2009 |
| Version.html | 10,127 | 1/13/2009 |
| View.html | 29,142 | 1/13/2009 |
| WorkReport.html | 23,946 | 1/13/2009 |
| _alloc---artissue---article.php.html | 2,855 | 1/13/2009 |
| _alloc---artissue---articlesearch.php.html | 2,909 | 1/13/2009 |
| _alloc---artissue---articlesearchquery.php.html | 2,005 | 1/13/2009 |
| _alloc---artissue---articlesearch_typ.php.html | 1,227 | 1/13/2009 |
| _alloc---artissue---article_typ.php.html | 1,209 | 1/13/2009 |
| _alloc---artissue---artissue.php.html | 1,955 | 1/13/2009 |
| _alloc---artissue---artissuesearch.php.html | 1,985 | 1/13/2009 |
| _alloc---artissue---artprissue.php.html | 4,116 | 1/13/2009 |
| _alloc---artissue---issue.php.html | 5,596 | 1/13/2009 |
| _alloc---artissue---issuelistpresentation.php.html | 2,020 | 1/13/2009 |
| _alloc---artissue---issuesearch.php.html | 2,890 | 1/13/2009 |
| _alloc---artissue---issuesearchquery.php.html | 1,995 | 1/13/2009 |
| _alloc---artissue---issuesearch_typ.php.html | 1,221 | 1/13/2009 |
| _alloc---artissue---issue_typ.php.html | 1,203 | 1/13/2009 |
| _alloc---artissue---priorityindex.php.html | 1,980 | 1/13/2009 |
| _alloc---artissue---prissuesearch.php.html | 4,280 | 1/13/2009 |
| _alloc---artissue---project.php.html | 2,855 | 1/13/2009 |
| _alloc---artissue---projectsearch.php.html | 2,909 | 1/13/2009 |
| _alloc---artissue---projectsearchquery.php.html | 2,005 | 1/13/2009 |
| _alloc---artissue---projectsearch_typ.php.html | 1,227 | 1/13/2009 |
| _alloc---artissue---project_typ.php.html | 1,209 | 1/13/2009 |
| _alloc---artissue---searchquery.php.html | 1,970 | 1/13/2009 |
| _alloc---attach.php.html | 1,928 | 1/13/2009 |
| _alloc---billableitem---expenseitem.php.html | 1,978 | 1/13/2009 |
| _alloc---billableitem---item.php.html | 1,943 | 1/13/2009 |
| _alloc---billableitem---itemsearch.php.html | 1,973 | 1/13/2009 |
| _alloc---billableitem---labor.php.html | 1,948 | 1/13/2009 |
| _alloc---billableitem---milagereport.php.html | 1,983 | 1/13/2009 |
| _alloc---billableitem---reimbursableitem.php.html | 2,003 | 1/13/2009 |
| _alloc---billableitem---resaleitem.php.html | 1,973 | 1/13/2009 |
| _alloc---billableitem---workreport.php.html | 1,973 | 1/13/2009 |
| _alloc---category.php.html | 1,944 | 1/13/2009 |
| _alloc---clientgroup.php.html | 1,953 | 1/13/2009 |
| _alloc---clock.php.html | 1,991 | 1/13/2009 |
| _alloc---combine.php.html | 4,957 | 1/13/2009 |
| _alloc---config.php.html | 1,177 | 1/13/2009 |
| _alloc---constants.php.html | 33,697 | 1/13/2009 |
| _alloc---createflag.php.html | 2,012 | 1/13/2009 |
| _alloc---cronjob.php.html | 2,928 | 1/13/2009 |
| _alloc---dokuwiki.php.html | 11,040 | 1/13/2009 |
| _alloc---error.php.html | 3,220 | 1/13/2009 |
| _alloc---flag.php.html | 1,918 | 1/13/2009 |
| _alloc---get_css.php.html | 4,074 | 1/13/2009 |
| _alloc---get_js.php.html | 2,846 | 1/13/2009 |
| _alloc---gorum2---adodb-time.php.html | 17,132 | 1/13/2009 |
| _alloc---gorum2---category.php.html | 2,916 | 1/13/2009 |
| _alloc---gorum2---changename.php.html | 1,202 | 1/13/2009 |
| _alloc---gorum2---charconvert.php.html | 1,966 | 1/13/2009 |
| _alloc---gorum2---constants.php.html | 22,384 | 1/13/2009 |
| _alloc---gorum2---date.php.html | 1,931 | 1/13/2009 |
| _alloc---gorum2---dbproperty.php.html | 20,500 | 1/13/2009 |
| _alloc---gorum2---dbtreeproperty.php.html | 10,857 | 1/13/2009 |
| _alloc---gorum2---flood.php.html | 3,053 | 1/13/2009 |
| _alloc---gorum2---form.php.html | 1,953 | 1/13/2009 |
| _alloc---gorum2---g.php.html | 1,916 | 1/13/2009 |
| _alloc---gorum2---gorum.php.html | 22,436 | 1/13/2009 |
| _alloc---gorum2---gorumlib.php.html | 17,283 | 1/13/2009 |
| _alloc---gorum2---gorum_db.php.html | 8,824 | 1/13/2009 |
| _alloc---gorum2---hasmany.php.html | 2,557 | 1/13/2009 |
| _alloc---gorum2---htmllist.php.html | 5,414 | 1/13/2009 |
| _alloc---gorum2---imap.php.html | 2,608 | 1/13/2009 |
| _alloc---gorum2---init.php.html | 3,359 | 1/13/2009 |
| _alloc---gorum2---installlib.php.html | 14,393 | 1/13/2009 |
| _alloc---gorum2---javascript.php.html | 1,961 | 1/13/2009 |
| _alloc---gorum2---loginlib.php.html | 5,344 | 1/13/2009 |
| _alloc---gorum2---loginlib_high.php.html | 1,211 | 1/13/2009 |
| _alloc---gorum2---object.php.html | 1,941 | 1/13/2009 |
| _alloc---gorum2---presentation---deleteformpresentation.php.html | 2,046 | 1/13/2009 |
| _alloc---gorum2---presentation---detailspresentation.php.html | 2,031 | 1/13/2009 |
| _alloc---gorum2---presentation---filter.php.html | 1,966 | 1/13/2009 |
| _alloc---gorum2---presentation---formpresentation.php.html | 2,016 | 1/13/2009 |
| _alloc---gorum2---presentation---generdatewidget.php.html | 2,011 | 1/13/2009 |
| _alloc---gorum2---presentation---genervoicewidget.php.html | 2,016 | 1/13/2009 |
| _alloc---gorum2---presentation---generwidget.php.html | 1,991 | 1/13/2009 |
| _alloc---gorum2---presentation---listpresentation.php.html | 2,016 | 1/13/2009 |
| _alloc---gorum2---presentation---lllproperties.php.html | 2,001 | 1/13/2009 |
| _alloc---gorum2---presentation---presentation.php.html | 1,996 | 1/13/2009 |
| _alloc---gorum2---privilegeproperty.php.html | 9,435 | 1/13/2009 |
| _alloc---gorum2---relativedate.php.html | 2,861 | 1/13/2009 |
| _alloc---gorum2---roll.php.html | 4,768 | 1/13/2009 |
| _alloc---gorum2---sqlparser.php.html | 27,765 | 1/13/2009 |
| _alloc---gorum2---stopwatch.php.html | 1,956 | 1/13/2009 |
| _alloc---gorum2---tools.php.html | 11,427 | 1/13/2009 |
| _alloc---gorum2---updatelib.php.html | 2,927 | 1/13/2009 |
| _alloc---gorum2---user_email.php.html | 1,949 | 1/13/2009 |
| _alloc---gorum2---user_high.php.html | 1,908 | 1/13/2009 |
| _alloc---gorum2---user_simple.php.html | 3,561 | 1/13/2009 |
| _alloc---gorum2---view.php.html | 1,931 | 1/13/2009 |
| _alloc---gorum2---xdebug.php.html | 2,798 | 1/13/2009 |
| _alloc---group.php.html | 1,931 | 1/13/2009 |
| _alloc---handler---handler.php.html | 1,948 | 1/13/2009 |
| _alloc---handler---handler_artissue.php.html | 1,991 | 1/13/2009 |
| _alloc---handler---handler_expenseitem.php.html | 2,006 | 1/13/2009 |
| _alloc---handler---handler_issue.php.html | 1,976 | 1/13/2009 |
| _alloc---handler---handler_project.php.html | 1,986 | 1/13/2009 |
| _alloc---handler---handler_resaleitem.php.html | 2,001 | 1/13/2009 |
| _alloc---handler---log.php.html | 1,928 | 1/13/2009 |
| _alloc---handler---logaction.php.html | 1,958 | 1/13/2009 |
| _alloc---handler---logsubscription.php.html | 1,988 | 1/13/2009 |
| _alloc---handler---notification.php.html | 3,125 | 1/13/2009 |
| _alloc---handler---notifsubscription.php.html | 1,998 | 1/13/2009 |
| _alloc---include.php.html | 39,707 | 1/13/2009 |
| _alloc---index.php.html | 3,744 | 1/13/2009 |
| _alloc---init.php.html | 6,493 | 1/13/2009 |
| _alloc---itemlist.php.html | 1,938 | 1/13/2009 |
| _alloc---js_css_map.php.html | 1,189 | 1/13/2009 |
| _alloc---myform.php.html | 1,995 | 1/13/2009 |
| _alloc---note.php.html | 1,918 | 1/13/2009 |
| _alloc---notelist.php.html | 1,938 | 1/13/2009 |
| _alloc---object.php.html | 1,934 | 1/13/2009 |
| _alloc---objectnotelist.php.html | 1,968 | 1/13/2009 |
| _alloc---period.php.html | 3,120 | 1/13/2009 |
| _alloc---periodlist.php.html | 1,948 | 1/13/2009 |
| _alloc---permconfig.js.php.html | 3,477 | 1/13/2009 |
| _alloc---permconfig.php.html | 1,936 | 1/13/2009 |
| _alloc---permission.php.html | 3,278 | 1/13/2009 |
| _alloc---portal.php.html | 1,928 | 1/13/2009 |
| _alloc---portalattr.php.html | 3,098 | 1/13/2009 |
| _alloc---rarities---assignments.php.html | 1,209 | 1/13/2009 |
| _alloc---rarities---breadcrumb.php.html | 1,965 | 1/13/2009 |
| _alloc---rarities---cache.php.html | 1,940 | 1/13/2009 |
| _alloc---rarities---class.phpmailer.php.html | 1,978 | 1/13/2009 |
| _alloc---rarities---class.smtp.php.html | 1,953 | 1/13/2009 |
| _alloc---rarities---client.php.html | 1,945 | 1/13/2009 |
| _alloc---rarities---comingsoon.php.html | 1,206 | 1/13/2009 |
| _alloc---rarities---displayerror.php.html | 1,975 | 1/13/2009 |
| _alloc---rarities---proxy.php.html | 1,191 | 1/13/2009 |
| _alloc---rarities---rate.php.html | 1,935 | 1/13/2009 |
| _alloc---rarities---rate_milage.php.html | 1,968 | 1/13/2009 |
| _alloc---rarities---readstate.php.html | 3,478 | 1/13/2009 |
| _alloc---recurring---distributeditemdef.php.html | 2,935 | 1/13/2009 |
| _alloc---recurring---recurringitemdef.php.html | 1,997 | 1/13/2009 |
| _alloc---recurring---specitem.php.html | 1,957 | 1/13/2009 |
| _alloc---recurring---specitemdef.php.html | 1,972 | 1/13/2009 |
| _alloc---report---report.php.html | 1,941 | 1/13/2009 |
| _alloc---report---report_category.php.html | 1,984 | 1/13/2009 |
| _alloc---report---report_employee.php.html | 4,519 | 1/13/2009 |
| _alloc---report---report_employeeactivity.php.html | 2,024 | 1/13/2009 |
| _alloc---report---report_item.php.html | 3,278 | 1/13/2009 |
| _alloc---report---report_payroll.php.html | 1,979 | 1/13/2009 |
| _alloc---report---report_vacation.php.html | 1,984 | 1/13/2009 |
| _alloc---search.php.html | 1,928 | 1/13/2009 |
| _alloc---settings.php.html | 1,938 | 1/13/2009 |
| _alloc---smsclock.php.html | 3,367 | 1/13/2009 |
| _alloc---testauth.php.html | 1,183 | 1/13/2009 |
| _alloc---update_items.php.html | 3,354 | 1/13/2009 |
| _alloc---update_logs.php.html | 3,347 | 1/13/2009 |
| _alloc---update_notes.php.html | 3,354 | 1/13/2009 |
| _alloc---update_searches.php.html | 3,375 | 1/13/2009 |
| _alloc---user.php.html | 1,924 | 1/13/2009 |
| _alloc---vacation.php.html | 1,938 | 1/13/2009 |
| _alloc---varfields.php.html | 4,162 | 1/13/2009 |
| _alloc---version.php.html | 1,933 | 1/13/2009 |
| _alloc---xajax.php.html | 2,786 | 1/13/2009 |
| _alloc---xajax_server.php.html | 36,596 | 1/13/2009 |
| _gorum2---adodb-time.php.html | 1,191 | 1/13/2009 |
| _gorum2---category.php.html | 1,894 | 1/13/2009 |
| _gorum2---changename.php.html | 1,191 | 1/13/2009 |
| _gorum2---charconvert.php.html | 1,903 | 1/13/2009 |
| _gorum2---constants.php.html | 1,188 | 1/13/2009 |
| _gorum2---date.php.html | 1,882 | 1/13/2009 |
| _gorum2---dbproperty.php.html | 1,191 | 1/13/2009 |
| _gorum2---dbtreeproperty.php.html | 1,203 | 1/13/2009 |
| _gorum2---firephp---fb.php.html | 3,721 | 1/13/2009 |
| _gorum2---firephp---FirePHP.class.php.html | 2,022 | 1/13/2009 |
| _gorum2---flood.php.html | 1,885 | 1/13/2009 |
| _gorum2---form.php.html | 1,882 | 1/13/2009 |
| _gorum2---g.php.html | 1,873 | 1/13/2009 |
| _gorum2---gorum.php.html | 15,214 | 1/13/2009 |
| _gorum2---gorumlib.php.html | 1,185 | 1/13/2009 |
| _gorum2---gorum_db.php.html | 8,729 | 1/13/2009 |
| _gorum2---hasmany.php.html | 2,302 | 1/13/2009 |
| _gorum2---htmllist.php.html | 1,185 | 1/13/2009 |
| _gorum2---imap.php.html | 1,173 | 1/13/2009 |
| _gorum2---init.php.html | 1,882 | 1/13/2009 |
| _gorum2---installlib.php.html | 1,191 | 1/13/2009 |
| _gorum2---javascript.php.html | 1,900 | 1/13/2009 |
| _gorum2---loginlib.php.html | 1,185 | 1/13/2009 |
| _gorum2---loginlib_high.php.html | 1,200 | 1/13/2009 |
| _gorum2---object.php.html | 1,888 | 1/13/2009 |
| _gorum2---presentation---deleteformpresentation.php.html | 1,961 | 1/13/2009 |
| _gorum2---presentation---detailspresentation.php.html | 1,952 | 1/13/2009 |
| _gorum2---presentation---filter.php.html | 1,913 | 1/13/2009 |
| _gorum2---presentation---formpresentation.php.html | 1,943 | 1/13/2009 |
| _gorum2---presentation---generdatewidget.php.html | 1,940 | 1/13/2009 |
| _gorum2---presentation---genervoicewidget.php.html | 1,943 | 1/13/2009 |
| _gorum2---presentation---generwidget.php.html | 1,928 | 1/13/2009 |
| _gorum2---presentation---listpresentation.php.html | 1,943 | 1/13/2009 |
| _gorum2---presentation---lllproperties.php.html | 1,934 | 1/13/2009 |
| _gorum2---presentation---presentation.php.html | 1,931 | 1/13/2009 |
| _gorum2---privilegeproperty.php.html | 1,212 | 1/13/2009 |
| _gorum2---relativedate.php.html | 2,782 | 1/13/2009 |
| _gorum2---roll.php.html | 1,882 | 1/13/2009 |
| _gorum2---sqlparser.php.html | 1,188 | 1/13/2009 |
| _gorum2---stopwatch.php.html | 1,897 | 1/13/2009 |
| _gorum2---tools.php.html | 1,176 | 1/13/2009 |
| _gorum2---updatelib.php.html | 1,188 | 1/13/2009 |
| _gorum2---user_email.php.html | 1,900 | 1/13/2009 |
| _gorum2---user_high.php.html | 1,897 | 1/13/2009 |
| _gorum2---user_simple.php.html | 1,903 | 1/13/2009 |
| _gorum2---view.php.html | 1,882 | 1/13/2009 |
| _gorum2---xdebug.php.html | 1,179 | 1/13/2009 |
| D:\webirs\webirs_source\phpdoc\HTMLframesConverter\default\_filesource | | |
| fsource_Savant2_allocgorum2Savant2.php.html | 352,428 | 1/13/2009 |
| fsource_Savant2_gorum2Savant2.php.html | 352,420 | 1/13/2009 |
| fsource_WebIRS_allocartissuearticle.php.html | 43,588 | 1/13/2009 |
| fsource_WebIRS_allocartissuearticlesearch.php.html | 29,101 | 1/13/2009 |
| fsource_WebIRS_allocartissuearticlesearchquery.php.html | 5,863 | 1/13/2009 |
| fsource_WebIRS_allocartissuearticlesearch_typ.php.html | 73,796 | 1/13/2009 |
| fsource_WebIRS_allocartissuearticle_typ.php.html | 77,210 | 1/13/2009 |
| fsource_WebIRS_allocartissueartissue.php.html | 127,919 | 1/13/2009 |
| fsource_WebIRS_allocartissueartissuesearch.php.html | 74,588 | 1/13/2009 |
| fsource_WebIRS_allocartissueartprissue.php.html | 279,897 | 1/13/2009 |
| fsource_WebIRS_allocartissueissue.php.html | 578,428 | 1/13/2009 |
| fsource_WebIRS_allocartissueissuelistpresentation.php.html | 113,725 | 1/13/2009 |
| fsource_WebIRS_allocartissueissuesearch.php.html | 185,783 | 1/13/2009 |
| fsource_WebIRS_allocartissueissuesearchquery.php.html | 163,230 | 1/13/2009 |
| fsource_WebIRS_allocartissueissuesearch_typ.php.html | 159,475 | 1/13/2009 |
| fsource_WebIRS_allocartissueissue_typ.php.html | 238,532 | 1/13/2009 |
| fsource_WebIRS_allocartissuepriorityindex.php.html | 29,458 | 1/13/2009 |
| fsource_WebIRS_allocartissueprissuesearch.php.html | 175,795 | 1/13/2009 |
| fsource_WebIRS_allocartissueproject.php.html | 92,475 | 1/13/2009 |
| fsource_WebIRS_allocartissueprojectsearch.php.html | 32,481 | 1/13/2009 |
| fsource_WebIRS_allocartissueprojectsearchquery.php.html | 19,674 | 1/13/2009 |
| fsource_WebIRS_allocartissueprojectsearch_typ.php.html | 90,790 | 1/13/2009 |
| fsource_WebIRS_allocartissueproject_typ.php.html | 93,193 | 1/13/2009 |
| fsource_WebIRS_allocartissuesearchquery.php.html | 87,777 | 1/13/2009 |
| fsource_WebIRS_allocattach.php.html | 125,091 | 1/13/2009 |
| fsource_WebIRS_allocbillableitemexpenseitem.php.html | 75,356 | 1/13/2009 |
| fsource_WebIRS_allocbillableitemitem.php.html | 220,694 | 1/13/2009 |
| fsource_WebIRS_allocbillableitemitemsearch.php.html | 81,265 | 1/13/2009 |
| fsource_WebIRS_allocbillableitemlabor.php.html | 27,894 | 1/13/2009 |
| fsource_WebIRS_allocbillableitemmilagereport.php.html | 45,802 | 1/13/2009 |
| fsource_WebIRS_allocbillableitemreimbursableitem.php.html | 9,000 | 1/13/2009 |
| fsource_WebIRS_allocbillableitemresaleitem.php.html | 54,657 | 1/13/2009 |
| fsource_WebIRS_allocbillableitemworkreport.php.html | 57,086 | 1/13/2009 |
| fsource_WebIRS_alloccategory.php.html | 58,765 | 1/13/2009 |
| fsource_WebIRS_allocclientgroup.php.html | 14,096 | 1/13/2009 |
| fsource_WebIRS_allocclock.php.html | 2,113 | 1/13/2009 |
| fsource_WebIRS_alloccombine.php.html | 40,125 | 1/13/2009 |
| fsource_WebIRS_allocconfig.php.html | 6,357 | 1/13/2009 |
| fsource_WebIRS_allocconstants.php.html | 80,905 | 1/13/2009 |
| fsource_WebIRS_alloccreateflag.php.html | 1,847 | 1/13/2009 |
| fsource_WebIRS_alloccronjob.php.html | 4,591 | 1/13/2009 |
| fsource_WebIRS_allocdokuwiki.php.html | 110,322 | 1/13/2009 |
| fsource_WebIRS_allocerror.php.html | 20,714 | 1/13/2009 |
| fsource_WebIRS_allocflag.php.html | 113,918 | 1/13/2009 |
| fsource_WebIRS_allocget_css.php.html | 16,373 | 1/13/2009 |
| fsource_WebIRS_allocget_js.php.html | 10,322 | 1/13/2009 |
| fsource_WebIRS_allocgorum2adodb-time.php.html | 244,820 | 1/13/2009 |
| fsource_WebIRS_allocgorum2category.php.html | 95,911 | 1/13/2009 |
| fsource_WebIRS_allocgorum2changename.php.html | 15,812 | 1/13/2009 |
| fsource_WebIRS_allocgorum2charconvert.php.html | 6,963 | 1/13/2009 |
| fsource_WebIRS_allocgorum2constants.php.html | 43,419 | 1/13/2009 |
| fsource_WebIRS_allocgorum2date.php.html | 228,961 | 1/13/2009 |
| fsource_WebIRS_allocgorum2dbproperty.php.html | 128,659 | 1/13/2009 |
| fsource_WebIRS_allocgorum2dbtreeproperty.php.html | 38,286 | 1/13/2009 |
| fsource_WebIRS_allocgorum2flood.php.html | 8,604 | 1/13/2009 |
| fsource_WebIRS_allocgorum2form.php.html | 10,605 | 1/13/2009 |
| fsource_WebIRS_allocgorum2g.php.html | 37,417 | 1/13/2009 |
| fsource_WebIRS_allocgorum2gorum.php.html | 22,850 | 1/13/2009 |
| fsource_WebIRS_allocgorum2gorumlib.php.html | 99,464 | 1/13/2009 |
| fsource_WebIRS_allocgorum2gorum_db.php.html | 16,581 | 1/13/2009 |
| fsource_WebIRS_allocgorum2hasmany.php.html | 60,126 | 1/13/2009 |
| fsource_WebIRS_allocgorum2htmllist.php.html | 47,563 | 1/13/2009 |
| fsource_WebIRS_allocgorum2imap.php.html | 10,478 | 1/13/2009 |
| fsource_WebIRS_allocgorum2init.php.html | 98,766 | 1/13/2009 |
| fsource_WebIRS_allocgorum2installlib.php.html | 188,775 | 1/13/2009 |
| fsource_WebIRS_allocgorum2javascript.php.html | 45,990 | 1/13/2009 |
| fsource_WebIRS_allocgorum2loginlib.php.html | 74,759 | 1/13/2009 |
| fsource_WebIRS_allocgorum2loginlib_high.php.html | 29,336 | 1/13/2009 |
| fsource_WebIRS_allocgorum2object.php.html | 288,080 | 1/13/2009 |
| fsource_WebIRS_allocgorum2presentationdeleteformpresentation.php.html | 20,474 | 1/13/2009 |
| fsource_WebIRS_allocgorum2presentationdetailspresentation.php.html | 21,493 | 1/13/2009 |
| fsource_WebIRS_allocgorum2presentationfilter.php.html | 15,733 | 1/13/2009 |
| fsource_WebIRS_allocgorum2presentationformpresentation.php.html | 225,756 | 1/13/2009 |
| fsource_WebIRS_allocgorum2presentationgenerdatewidget.php.html | 119,268 | 1/13/2009 |
| fsource_WebIRS_allocgorum2presentationgenervoicewidget.php.html | 14,981 | 1/13/2009 |
| fsource_WebIRS_allocgorum2presentationgenerwidget.php.html | 107,568 | 1/13/2009 |
| fsource_WebIRS_allocgorum2presentationlistpresentation.php.html | 70,573 | 1/13/2009 |
| fsource_WebIRS_allocgorum2presentationlllproperties.php.html | 23,828 | 1/13/2009 |
| fsource_WebIRS_allocgorum2presentationpresentation.php.html | 14,743 | 1/13/2009 |
| fsource_WebIRS_allocgorum2privilegeproperty.php.html | 58,029 | 1/13/2009 |
| fsource_WebIRS_allocgorum2relativedate.php.html | 85,208 | 1/13/2009 |
| fsource_WebIRS_allocgorum2roll.php.html | 72,383 | 1/13/2009 |
| fsource_WebIRS_allocgorum2sqlparser.php.html | 559,832 | 1/13/2009 |
| fsource_WebIRS_allocgorum2stopwatch.php.html | 18,303 | 1/13/2009 |
| fsource_WebIRS_allocgorum2tools.php.html | 166,776 | 1/13/2009 |
| fsource_WebIRS_allocgorum2updatelib.php.html | 6,335 | 1/13/2009 |
| fsource_WebIRS_allocgorum2user_email.php.html | 182,691 | 1/13/2009 |
| fsource_WebIRS_allocgorum2user_high.php.html | 66,430 | 1/13/2009 |
| fsource_WebIRS_allocgorum2user_simple.php.html | 204,041 | 1/13/2009 |
| fsource_WebIRS_allocgorum2view.php.html | 47,736 | 1/13/2009 |
| fsource_WebIRS_allocgorum2xdebug.php.html | 5,289 | 1/13/2009 |
| fsource_WebIRS_allocgroup.php.html | 14,362 | 1/13/2009 |
| fsource_WebIRS_allochandlerhandler.php.html | 60,499 | 1/13/2009 |
| fsource_WebIRS_allochandlerhandler_artissue.php.html | 40,176 | 1/13/2009 |
| fsource_WebIRS_allochandlerhandler_expenseitem.php.html | 7,227 | 1/13/2009 |
| fsource_WebIRS_allochandlerhandler_issue.php.html | 59,126 | 1/13/2009 |
| fsource_WebIRS_allochandlerhandler_project.php.html | 6,598 | 1/13/2009 |
| fsource_WebIRS_allochandlerhandler_resaleitem.php.html | 3,019 | 1/13/2009 |
| fsource_WebIRS_allochandlerlog.php.html | 58,440 | 1/13/2009 |
| fsource_WebIRS_allochandlerlogaction.php.html | 58,705 | 1/13/2009 |
| fsource_WebIRS_allochandlerlogsubscription.php.html | 44,590 | 1/13/2009 |
| fsource_WebIRS_allochandlernotification.php.html | 227,734 | 1/13/2009 |
| fsource_WebIRS_allochandlernotifsubscription.php.html | 115,985 | 1/13/2009 |
| fsource_WebIRS_allocinclude.php.html | 21,104 | 1/13/2009 |
| fsource_WebIRS_allocindex.php.html | 4,365 | 1/13/2009 |
| fsource_WebIRS_allocinit.php.html | 202,058 | 1/13/2009 |
| fsource_WebIRS_allocitemlist.php.html | 40,739 | 1/13/2009 |
| fsource_WebIRS_allocjs_css_map.php.html | 16,884 | 1/13/2009 |
| fsource_WebIRS_allocmyform.php.html | 2,027 | 1/13/2009 |
| fsource_WebIRS_allocnote.php.html | 98,134 | 1/13/2009 |
| fsource_WebIRS_allocnotelist.php.html | 50,117 | 1/13/2009 |
| fsource_WebIRS_allocobject.php.html | 114,479 | 1/13/2009 |
| fsource_WebIRS_allocobjectnotelist.php.html | 33,175 | 1/13/2009 |
| fsource_WebIRS_allocperiod.php.html | 536,719 | 1/13/2009 |
| fsource_WebIRS_allocperiodlist.php.html | 34,457 | 1/13/2009 |
| fsource_WebIRS_allocpermconfig.js.php.html | 5,130 | 1/13/2009 |
| fsource_WebIRS_allocpermconfig.php.html | 103,563 | 1/13/2009 |
| fsource_WebIRS_allocpermission.php.html | 131,714 | 1/13/2009 |
| fsource_WebIRS_allocportal.php.html | 40,073 | 1/13/2009 |
| fsource_WebIRS_allocportalattr.php.html | 174,681 | 1/13/2009 |
| fsource_WebIRS_allocraritiesassignments.php.html | 2,010 | 1/13/2009 |
| fsource_WebIRS_allocraritiesbreadcrumb.php.html | 23,335 | 1/13/2009 |
| fsource_WebIRS_allocraritiescache.php.html | 7,322 | 1/13/2009 |
| fsource_WebIRS_allocraritiesclass.phpmailer.php.html | 411,346 | 1/13/2009 |
| fsource_WebIRS_allocraritiesclass.smtp.php.html | 241,273 | 1/13/2009 |
| fsource_WebIRS_allocraritiesclient.php.html | 66,582 | 1/13/2009 |
| fsource_WebIRS_allocraritiescomingsoon.php.html | 18,684 | 1/13/2009 |
| fsource_WebIRS_allocraritiesdisplayerror.php.html | 3,950 | 1/13/2009 |
| fsource_WebIRS_allocraritiesproxy.php.html | 3,381 | 1/13/2009 |
| fsource_WebIRS_allocraritiesrate.php.html | 93,457 | 1/13/2009 |
| fsource_WebIRS_allocraritiesrate_milage.php.html | 58,677 | 1/13/2009 |
| fsource_WebIRS_allocraritiesreadstate.php.html | 9,240 | 1/13/2009 |
| fsource_WebIRS_allocrecurringdistributeditemdef.php.html | 23,659 | 1/13/2009 |
| fsource_WebIRS_allocrecurringrecurringitemdef.php.html | 3,369 | 1/13/2009 |
| fsource_WebIRS_allocrecurringspecitem.php.html | 55,293 | 1/13/2009 |
| fsource_WebIRS_allocrecurringspecitemdef.php.html | 89,969 | 1/13/2009 |
| fsource_WebIRS_allocreportreport.php.html | 68,618 | 1/13/2009 |
| fsource_WebIRS_allocreportreport_category.php.html | 104,154 | 1/13/2009 |
| fsource_WebIRS_allocreportreport_employee.php.html | 71,760 | 1/13/2009 |
| fsource_WebIRS_allocreportreport_employeeactivity.php.html | 30,199 | 1/13/2009 |
| fsource_WebIRS_allocreportreport_item.php.html | 245,701 | 1/13/2009 |
| fsource_WebIRS_allocreportreport_payroll.php.html | 68,664 | 1/13/2009 |
| fsource_WebIRS_allocreportreport_vacation.php.html | 36,264 | 1/13/2009 |
| fsource_WebIRS_allocsearch.php.html | 104,107 | 1/13/2009 |
| fsource_WebIRS_allocsettings.php.html | 5,347 | 1/13/2009 |
| fsource_WebIRS_allocsmsclock.php.html | 5,873 | 1/13/2009 |
| fsource_WebIRS_alloctestauth.php.html | 1,867 | 1/13/2009 |
| fsource_WebIRS_allocupdate_items.php.html | 37,033 | 1/13/2009 |
| fsource_WebIRS_allocupdate_logs.php.html | 13,080 | 1/13/2009 |
| fsource_WebIRS_allocupdate_notes.php.html | 8,070 | 1/13/2009 |
| fsource_WebIRS_allocupdate_searches.php.html | 47,224 | 1/13/2009 |
| fsource_WebIRS_allocuser.php.html | 191,436 | 1/13/2009 |
| fsource_WebIRS_allocvacation.php.html | 76,194 | 1/13/2009 |
| fsource_WebIRS_allocvarfields.php.html | 191,486 | 1/13/2009 |
| fsource_WebIRS_allocversion.php.html | 62,887 | 1/13/2009 |
| fsource_WebIRS_allocxajax.php.html | 8,087 | 1/13/2009 |
| fsource_WebIRS_allocxajax_server.php.html | 140,333 | 1/13/2009 |
| fsource_WebIRS_gorum2adodb-time.php.html | 244,812 | 1/13/2009 |
| fsource_WebIRS_gorum2category.php.html | 95,903 | 1/13/2009 |
| fsource_WebIRS_gorum2changename.php.html | 15,804 | 1/13/2009 |
| fsource_WebIRS_gorum2charconvert.php.html | 6,955 | 1/13/2009 |
| fsource_WebIRS_gorum2constants.php.html | 43,752 | 1/13/2009 |
| fsource_WebIRS_gorum2date.php.html | 230,925 | 1/13/2009 |
| fsource_WebIRS_gorum2dbproperty.php.html | 128,651 | 1/13/2009 |
| fsource_WebIRS_gorum2dbtreeproperty.php.html | 38,278 | 1/13/2009 |
| fsource_WebIRS_gorum2firephpfb.php.html | 12,335 | 1/13/2009 |
| fsource_WebIRS_gorum2firephpFirePHP.class.php.html | 160,425 | 1/13/2009 |
| fsource_WebIRS_gorum2flood.php.html | 8,596 | 1/13/2009 |
| fsource_WebIRS_gorum2form.php.html | 10,597 | 1/13/2009 |
| fsource_WebIRS_gorum2g.php.html | 37,409 | 1/13/2009 |
| fsource_WebIRS_gorum2gorum.php.html | 22,842 | 1/13/2009 |
| fsource_WebIRS_gorum2gorumlib.php.html | 99,456 | 1/13/2009 |
| fsource_WebIRS_gorum2gorum_db.php.html | 16,573 | 1/13/2009 |
| fsource_WebIRS_gorum2hasmany.php.html | 60,118 | 1/13/2009 |
| fsource_WebIRS_gorum2htmllist.php.html | 47,555 | 1/13/2009 |
| fsource_WebIRS_gorum2imap.php.html | 10,470 | 1/13/2009 |
| fsource_WebIRS_gorum2init.php.html | 98,758 | 1/13/2009 |
| fsource_WebIRS_gorum2installlib.php.html | 188,767 | 1/13/2009 |
| fsource_WebIRS_gorum2javascript.php.html | 45,982 | 1/13/2009 |
| fsource_WebIRS_gorum2loginlib.php.html | 74,751 | 1/13/2009 |
| fsource_WebIRS_gorum2loginlib_high.php.html | 29,328 | 1/13/2009 |
| fsource_WebIRS_gorum2object.php.html | 288,072 | 1/13/2009 |
| fsource_WebIRS_gorum2presentationdeleteformpresentation.php.html | 20,466 | 1/13/2009 |
| fsource_WebIRS_gorum2presentationdetailspresentation.php.html | 21,485 | 1/13/2009 |
| fsource_WebIRS_gorum2presentationfilter.php.html | 15,725 | 1/13/2009 |
| fsource_WebIRS_gorum2presentationformpresentation.php.html | 228,368 | 1/13/2009 |
| fsource_WebIRS_gorum2presentationgenerdatewidget.php.html | 119,260 | 1/13/2009 |
| fsource_WebIRS_gorum2presentationgenervoicewidget.php.html | 14,973 | 1/13/2009 |
| fsource_WebIRS_gorum2presentationgenerwidget.php.html | 111,189 | 1/13/2009 |
| fsource_WebIRS_gorum2presentationlistpresentation.php.html | 70,565 | 1/13/2009 |
| fsource_WebIRS_gorum2presentationlllproperties.php.html | 23,820 | 1/13/2009 |
| fsource_WebIRS_gorum2presentationpresentation.php.html | 14,735 | 1/13/2009 |
| fsource_WebIRS_gorum2privilegeproperty.php.html | 58,021 | 1/13/2009 |
| fsource_WebIRS_gorum2relativedate.php.html | 85,200 | 1/13/2009 |
| fsource_WebIRS_gorum2roll.php.html | 72,375 | 1/13/2009 |
| fsource_WebIRS_gorum2sqlparser.php.html | 559,824 | 1/13/2009 |
| fsource_WebIRS_gorum2stopwatch.php.html | 18,295 | 1/13/2009 |
| fsource_WebIRS_gorum2tools.php.html | 168,006 | 1/13/2009 |
| fsource_WebIRS_gorum2updatelib.php.html | 6,327 | 1/13/2009 |
| fsource_WebIRS_gorum2user_email.php.html | 182,683 | 1/13/2009 |
| fsource_WebIRS_gorum2user_high.php.html | 66,422 | 1/13/2009 |
| fsource_WebIRS_gorum2user_simple.php.html | 204,033 | 1/13/2009 |
| fsource_WebIRS_gorum2view.php.html | 47,728 | 1/13/2009 |
| fsource_WebIRS_gorum2xdebug.php.html | 5,281 | 1/13/2009 |
| D:\webirs\webirs_source\phpdoc\HTMLframesConverter\earthli | | |
| blank.html | 381 | 1/13/2009 |
| classtrees_Savant2.html | 865 | 1/13/2009 |
| classtrees_WebIRS.html | 6,079 | 1/13/2009 |
| elementindex.html | 810,460 | 1/13/2009 |
| elementindex_Savant2.html | 25,740 | 1/13/2009 |
| elementindex_WebIRS.html | 790,179 | 1/13/2009 |
| errors.html | 152,217 | 1/13/2009 |
| index.html | 934 | 1/13/2009 |
| li_Savant2.html | 1,691 | 1/13/2009 |
| li_WebIRS.html | 91,789 | 1/13/2009 |
| packages.html | 1,246 | 1/13/2009 |
| D:\webirs\webirs_source\phpdoc\HTMLframesConverter\earthli\media | | |
| banner.css | 448 | 1/13/2009 |
| stylesheet.css | 5,841 | 1/13/2009 |
| D:\webirs\webirs_source\phpdoc\HTMLframesConverter\earthli\Savant2 | | |
| Savant2.html | 76,759 | 1/13/2009 |
| _alloc---gorum2---Savant2.php.html | 6,126 | 1/13/2009 |
| _gorum2---Savant2.php.html | 2,131 | 1/13/2009 |
| D:\webirs\webirs_source\phpdoc\HTMLframesConverter\earthli\WebIRS | | |
| AllocError.html | 4,293 | 1/13/2009 |
| AllocXajaxResponse.html | 9,015 | 1/13/2009 |
| AppCategory.html | 14,080 | 1/13/2009 |
| AppInit.html | 14,460 | 1/13/2009 |
| AppObject.html | 66,177 | 1/13/2009 |
| AppUser.html | 20,775 | 1/13/2009 |
| Article.html | 45,525 | 1/13/2009 |
| ArticleSearch.html | 24,726 | 1/13/2009 |
| ArticleSearchQuery.html | 10,278 | 1/13/2009 |
| ArtIssue.html | 45,372 | 1/13/2009 |
| ArtIssueHandler.html | 16,881 | 1/13/2009 |
| ArtIssueSearch.html | 38,302 | 1/13/2009 |
| ArtPrIssue.html | 84,440 | 1/13/2009 |
| Attach.html | 20,035 | 1/13/2009 |
| Breadcrumb.html | 4,867 | 1/13/2009 |
| Cache.html | 5,192 | 1/13/2009 |
| Category.html | 22,657 | 1/13/2009 |
| CategoryReport.html | 5,027 | 1/13/2009 |
| CharConvert.html | 6,163 | 1/13/2009 |
| Client.html | 13,364 | 1/13/2009 |
| ClientGroup.html | 4,897 | 1/13/2009 |
| Date.html | 98,998 | 1/13/2009 |
| DeleteFormPresentation.html | 4,850 | 1/13/2009 |
| DetailsPresentation.html | 6,731 | 1/13/2009 |
| DisplayError.html | 3,419 | 1/13/2009 |
| DistributedItemDef.html | 12,223 | 1/13/2009 |
| EmployeeActivityReport.html | 29,292 | 1/13/2009 |
| EmployeeReport.html | 5,028 | 1/13/2009 |
| ExpenseItem.html | 34,457 | 1/13/2009 |
| ExpenseItemHandler.html | 9,735 | 1/13/2009 |
| Filter.html | 11,498 | 1/13/2009 |
| FirePHP.html | 28,356 | 1/13/2009 |
| Flag.html | 16,539 | 1/13/2009 |
| Flood.html | 1,418 | 1/13/2009 |
| FormDisplayType.html | 6,375 | 1/13/2009 |
| FormPresentation.html | 58,291 | 1/13/2009 |
| G.html | 13,505 | 1/13/2009 |
| GenerDateWidget.html | 13,764 | 1/13/2009 |
| GenerVoiceWidget.html | 4,401 | 1/13/2009 |
| GenerWidget.html | 34,730 | 1/13/2009 |
| Handler.html | 22,556 | 1/13/2009 |
| HasMany.html | 16,579 | 1/13/2009 |
| HasManyAttrs.html | 9,676 | 1/13/2009 |
| HasManyWithLinkClass.html | 13,509 | 1/13/2009 |
| HasManyWithoutLinkClass.html | 16,552 | 1/13/2009 |
| Init.html | 21,595 | 1/13/2009 |
| Issue.html | 101,361 | 1/13/2009 |
| IssueHandler.html | 23,245 | 1/13/2009 |
| IssueListPresentation.html | 5,372 | 1/13/2009 |
| IssueSearch.html | 43,550 | 1/13/2009 |
| IssueSearchQuery.html | 55,885 | 1/13/2009 |
| Item.html | 53,538 | 1/13/2009 |
| ItemList.html | 9,339 | 1/13/2009 |
| ItemReport.html | 16,642 | 1/13/2009 |
| ItemSearch.html | 8,583 | 1/13/2009 |
| JavaScript.html | 30,181 | 1/13/2009 |
| Labor.html | 6,818 | 1/13/2009 |
| ListPresentation.html | 10,292 | 1/13/2009 |
| LllProperties.html | 18,098 | 1/13/2009 |
| Log.html | 21,951 | 1/13/2009 |
| LogAction.html | 12,008 | 1/13/2009 |
| LogSubscription.html | 24,065 | 1/13/2009 |
| MilageRate.html | 16,261 | 1/13/2009 |
| MilageReport.html | 36,020 | 1/13/2009 |
| Note.html | 38,064 | 1/13/2009 |
| NoteList.html | 10,162 | 1/13/2009 |
| Notif.html | 21,433 | 1/13/2009 |
| NotifSubscription.html | 36,688 | 1/13/2009 |
| Object.html | 80,733 | 1/13/2009 |
| ObjectNoteList.html | 11,651 | 1/13/2009 |
| PayrollReport.html | 6,894 | 1/13/2009 |
| Period.html | 74,422 | 1/13/2009 |
| PeriodList.html | 9,377 | 1/13/2009 |
| Perm.html | 59,061 | 1/13/2009 |
| PermGroup.html | 4,861 | 1/13/2009 |
| Permission.html | 27,303 | 1/13/2009 |
| PHPMailer.html | 71,145 | 1/13/2009 |
| Portal.html | 13,120 | 1/13/2009 |
| PortalAttr.html | 16,692 | 1/13/2009 |
| Presentation.html | 9,203 | 1/13/2009 |
| PriorityIndex.html | 10,491 | 1/13/2009 |
| PrIssueSearch.html | 38,950 | 1/13/2009 |
| Project.html | 55,810 | 1/13/2009 |
| ProjectHandler.html | 13,961 | 1/13/2009 |
| ProjectSearch.html | 26,958 | 1/13/2009 |
| ProjectSearchQuery.html | 28,978 | 1/13/2009 |
| Rate.html | 22,693 | 1/13/2009 |
| ReadState.html | 4,071 | 1/13/2009 |
| RecurringItemDef.html | 7,825 | 1/13/2009 |
| ReimbursableItem.html | 29,757 | 1/13/2009 |
| RelativeDate.html | 22,988 | 1/13/2009 |
| Report.html | 15,566 | 1/13/2009 |
| ResaleItem.html | 33,667 | 1/13/2009 |
| ResaleItemHandler.html | 8,264 | 1/13/2009 |
| Roll.html | 14,254 | 1/13/2009 |
| Search.html | 8,415 | 1/13/2009 |
| SearchQuery.html | 31,138 | 1/13/2009 |
| Settings.html | 1,414 | 1/13/2009 |
| SMTP.html | 35,040 | 1/13/2009 |
| SpecItem.html | 12,761 | 1/13/2009 |
| SpecItemDef.html | 22,579 | 1/13/2009 |
| Stopwatch.html | 5,536 | 1/13/2009 |
| User.html | 20,998 | 1/13/2009 |
| Vacation.html | 13,265 | 1/13/2009 |
| VacationReport.html | 5,028 | 1/13/2009 |
| VarFields.html | 10,669 | 1/13/2009 |
| Version.html | 11,032 | 1/13/2009 |
| View.html | 31,727 | 1/13/2009 |
| WorkReport.html | 29,473 | 1/13/2009 |
| _alloc---artissue---article.php.html | 3,099 | 1/13/2009 |
| _alloc---artissue---articlesearch.php.html | 3,153 | 1/13/2009 |
| _alloc---artissue---articlesearchquery.php.html | 2,200 | 1/13/2009 |
| _alloc---artissue---articlesearch_typ.php.html | 1,310 | 1/13/2009 |
| _alloc---artissue---article_typ.php.html | 1,292 | 1/13/2009 |
| _alloc---artissue---artissue.php.html | 2,150 | 1/13/2009 |
| _alloc---artissue---artissuesearch.php.html | 2,180 | 1/13/2009 |
| _alloc---artissue---artprissue.php.html | 4,397 | 1/13/2009 |
| _alloc---artissue---issue.php.html | 5,969 | 1/13/2009 |
| _alloc---artissue---issuelistpresentation.php.html | 2,215 | 1/13/2009 |
| _alloc---artissue---issuesearch.php.html | 3,134 | 1/13/2009 |
| _alloc---artissue---issuesearchquery.php.html | 2,190 | 1/13/2009 |
| _alloc---artissue---issuesearch_typ.php.html | 1,304 | 1/13/2009 |
| _alloc---artissue---issue_typ.php.html | 1,286 | 1/13/2009 |
| _alloc---artissue---priorityindex.php.html | 2,175 | 1/13/2009 |
| _alloc---artissue---prissuesearch.php.html | 4,700 | 1/13/2009 |
| _alloc---artissue---project.php.html | 3,099 | 1/13/2009 |
| _alloc---artissue---projectsearch.php.html | 3,153 | 1/13/2009 |
| _alloc---artissue---projectsearchquery.php.html | 2,200 | 1/13/2009 |
| _alloc---artissue---projectsearch_typ.php.html | 1,310 | 1/13/2009 |
| _alloc---artissue---project_typ.php.html | 1,292 | 1/13/2009 |
| _alloc---artissue---searchquery.php.html | 2,165 | 1/13/2009 |
| _alloc---attach.php.html | 2,123 | 1/13/2009 |
| _alloc---billableitem---expenseitem.php.html | 2,173 | 1/13/2009 |
| _alloc---billableitem---item.php.html | 2,138 | 1/13/2009 |
| _alloc---billableitem---itemsearch.php.html | 2,168 | 1/13/2009 |
| _alloc---billableitem---labor.php.html | 2,143 | 1/13/2009 |
| _alloc---billableitem---milagereport.php.html | 2,178 | 1/13/2009 |
| _alloc---billableitem---reimbursableitem.php.html | 2,198 | 1/13/2009 |
| _alloc---billableitem---resaleitem.php.html | 2,168 | 1/13/2009 |
| _alloc---billableitem---workreport.php.html | 2,168 | 1/13/2009 |
| _alloc---category.php.html | 2,139 | 1/13/2009 |
| _alloc---clientgroup.php.html | 2,148 | 1/13/2009 |
| _alloc---clock.php.html | 2,123 | 1/13/2009 |
| _alloc---combine.php.html | 5,273 | 1/13/2009 |
| _alloc---config.php.html | 1,260 | 1/13/2009 |
| _alloc---constants.php.html | 37,785 | 1/13/2009 |
| _alloc---createflag.php.html | 2,144 | 1/13/2009 |
| _alloc---cronjob.php.html | 3,103 | 1/13/2009 |
| _alloc---dokuwiki.php.html | 11,467 | 1/13/2009 |
| _alloc---error.php.html | 3,513 | 1/13/2009 |
| _alloc---flag.php.html | 2,113 | 1/13/2009 |
| _alloc---get_css.php.html | 4,341 | 1/13/2009 |
| _alloc---get_js.php.html | 3,076 | 1/13/2009 |
| _alloc---gorum2---adodb-time.php.html | 17,907 | 1/13/2009 |
| _alloc---gorum2---category.php.html | 3,154 | 1/13/2009 |
| _alloc---gorum2---changename.php.html | 1,285 | 1/13/2009 |
| _alloc---gorum2---charconvert.php.html | 2,161 | 1/13/2009 |
| _alloc---gorum2---constants.php.html | 24,987 | 1/13/2009 |
| _alloc---gorum2---date.php.html | 2,126 | 1/13/2009 |
| _alloc---gorum2---dbproperty.php.html | 21,486 | 1/13/2009 |
| _alloc---gorum2---dbtreeproperty.php.html | 11,284 | 1/13/2009 |
| _alloc---gorum2---flood.php.html | 3,291 | 1/13/2009 |
| _alloc---gorum2---form.php.html | 2,148 | 1/13/2009 |
| _alloc---gorum2---g.php.html | 2,111 | 1/13/2009 |
| _alloc---gorum2---gorum.php.html | 24,897 | 1/13/2009 |
| _alloc---gorum2---gorumlib.php.html | 18,140 | 1/13/2009 |
| _alloc---gorum2---gorum_db.php.html | 9,740 | 1/13/2009 |
| _alloc---gorum2---hasmany.php.html | 3,088 | 1/13/2009 |
| _alloc---gorum2---htmllist.php.html | 5,712 | 1/13/2009 |
| _alloc---gorum2---imap.php.html | 2,734 | 1/13/2009 |
| _alloc---gorum2---init.php.html | 3,640 | 1/13/2009 |
| _alloc---gorum2---installlib.php.html | 15,250 | 1/13/2009 |
| _alloc---gorum2---javascript.php.html | 2,156 | 1/13/2009 |
| _alloc---gorum2---loginlib.php.html | 5,685 | 1/13/2009 |
| _alloc---gorum2---loginlib_high.php.html | 1,294 | 1/13/2009 |
| _alloc---gorum2---object.php.html | 2,136 | 1/13/2009 |
| _alloc---gorum2---presentation---deleteformpresentation.php.html | 2,241 | 1/13/2009 |
| _alloc---gorum2---presentation---detailspresentation.php.html | 2,226 | 1/13/2009 |
| _alloc---gorum2---presentation---filter.php.html | 2,161 | 1/13/2009 |
| _alloc---gorum2---presentation---formpresentation.php.html | 2,211 | 1/13/2009 |
| _alloc---gorum2---presentation---generdatewidget.php.html | 2,206 | 1/13/2009 |
| _alloc---gorum2---presentation---genervoicewidget.php.html | 2,211 | 1/13/2009 |
| _alloc---gorum2---presentation---generwidget.php.html | 2,186 | 1/13/2009 |
| _alloc---gorum2---presentation---listpresentation.php.html | 2,211 | 1/13/2009 |
| _alloc---gorum2---presentation---lllproperties.php.html | 2,196 | 1/13/2009 |
| _alloc---gorum2---presentation---presentation.php.html | 2,191 | 1/13/2009 |
| _alloc---gorum2---privilegeproperty.php.html | 9,819 | 1/13/2009 |
| _alloc---gorum2---relativedate.php.html | 3,105 | 1/13/2009 |
| _alloc---gorum2---roll.php.html | 5,135 | 1/13/2009 |
| _alloc---gorum2---sqlparser.php.html | 28,710 | 1/13/2009 |
| _alloc---gorum2---stopwatch.php.html | 2,151 | 1/13/2009 |
| _alloc---gorum2---tools.php.html | 12,112 | 1/13/2009 |
| _alloc---gorum2---updatelib.php.html | 3,096 | 1/13/2009 |
| _alloc---gorum2---user_email.php.html | 2,144 | 1/13/2009 |
| _alloc---gorum2---user_high.php.html | 2,103 | 1/13/2009 |
| _alloc---gorum2---user_simple.php.html | 3,799 | 1/13/2009 |
| _alloc---gorum2---view.php.html | 2,126 | 1/13/2009 |
| _alloc---gorum2---xdebug.php.html | 2,967 | 1/13/2009 |
| _alloc---group.php.html | 2,126 | 1/13/2009 |
| _alloc---handler---handler.php.html | 2,143 | 1/13/2009 |
| _alloc---handler---handler_artissue.php.html | 2,186 | 1/13/2009 |
| _alloc---handler---handler_expenseitem.php.html | 2,201 | 1/13/2009 |
| _alloc---handler---handler_issue.php.html | 2,171 | 1/13/2009 |
| _alloc---handler---handler_project.php.html | 2,181 | 1/13/2009 |
| _alloc---handler---handler_resaleitem.php.html | 2,196 | 1/13/2009 |
| _alloc---handler---log.php.html | 2,123 | 1/13/2009 |
| _alloc---handler---logaction.php.html | 2,153 | 1/13/2009 |
| _alloc---handler---logsubscription.php.html | 2,183 | 1/13/2009 |
| _alloc---handler---notification.php.html | 3,363 | 1/13/2009 |
| _alloc---handler---notifsubscription.php.html | 2,193 | 1/13/2009 |
| _alloc---include.php.html | 43,710 | 1/13/2009 |
| _alloc---index.php.html | 4,072 | 1/13/2009 |
| _alloc---init.php.html | 6,946 | 1/13/2009 |
| _alloc---itemlist.php.html | 2,133 | 1/13/2009 |
| _alloc---js_css_map.php.html | 1,272 | 1/13/2009 |
| _alloc---myform.php.html | 2,127 | 1/13/2009 |
| _alloc---note.php.html | 2,113 | 1/13/2009 |
| _alloc---notelist.php.html | 2,133 | 1/13/2009 |
| _alloc---object.php.html | 2,129 | 1/13/2009 |
| _alloc---objectnotelist.php.html | 2,163 | 1/13/2009 |
| _alloc---period.php.html | 3,358 | 1/13/2009 |
| _alloc---periodlist.php.html | 2,143 | 1/13/2009 |
| _alloc---permconfig.js.php.html | 3,652 | 1/13/2009 |
| _alloc---permconfig.php.html | 2,131 | 1/13/2009 |
| _alloc---permission.php.html | 3,516 | 1/13/2009 |
| _alloc---portal.php.html | 2,123 | 1/13/2009 |
| _alloc---portalattr.php.html | 3,383 | 1/13/2009 |
| _alloc---rarities---assignments.php.html | 1,292 | 1/13/2009 |
| _alloc---rarities---breadcrumb.php.html | 2,160 | 1/13/2009 |
| _alloc---rarities---cache.php.html | 2,135 | 1/13/2009 |
| _alloc---rarities---class.phpmailer.php.html | 2,173 | 1/13/2009 |
| _alloc---rarities---class.smtp.php.html | 2,148 | 1/13/2009 |
| _alloc---rarities---client.php.html | 2,140 | 1/13/2009 |
| _alloc---rarities---comingsoon.php.html | 1,289 | 1/13/2009 |
| _alloc---rarities---displayerror.php.html | 2,170 | 1/13/2009 |
| _alloc---rarities---proxy.php.html | 1,274 | 1/13/2009 |
| _alloc---rarities---rate.php.html | 2,130 | 1/13/2009 |
| _alloc---rarities---rate_milage.php.html | 2,163 | 1/13/2009 |
| _alloc---rarities---readstate.php.html | 3,808 | 1/13/2009 |
| _alloc---recurring---distributeditemdef.php.html | 3,173 | 1/13/2009 |
| _alloc---recurring---recurringitemdef.php.html | 2,192 | 1/13/2009 |
| _alloc---recurring---specitem.php.html | 2,152 | 1/13/2009 |
| _alloc---recurring---specitemdef.php.html | 2,167 | 1/13/2009 |
| _alloc---report---report.php.html | 2,136 | 1/13/2009 |
| _alloc---report---report_category.php.html | 2,179 | 1/13/2009 |
| _alloc---report---report_employee.php.html | 4,800 | 1/13/2009 |
| _alloc---report---report_employeeactivity.php.html | 2,219 | 1/13/2009 |
| _alloc---report---report_item.php.html | 3,516 | 1/13/2009 |
| _alloc---report---report_payroll.php.html | 2,174 | 1/13/2009 |
| _alloc---report---report_vacation.php.html | 2,179 | 1/13/2009 |
| _alloc---search.php.html | 2,123 | 1/13/2009 |
| _alloc---settings.php.html | 2,133 | 1/13/2009 |
| _alloc---smsclock.php.html | 3,646 | 1/13/2009 |
| _alloc---testauth.php.html | 1,266 | 1/13/2009 |
| _alloc---update_items.php.html | 3,633 | 1/13/2009 |
| _alloc---update_logs.php.html | 3,626 | 1/13/2009 |
| _alloc---update_notes.php.html | 3,633 | 1/13/2009 |
| _alloc---update_searches.php.html | 3,654 | 1/13/2009 |
| _alloc---user.php.html | 2,119 | 1/13/2009 |
| _alloc---vacation.php.html | 2,133 | 1/13/2009 |
| _alloc---varfields.php.html | 4,582 | 1/13/2009 |
| _alloc---version.php.html | 2,128 | 1/13/2009 |
| _alloc---xajax.php.html | 3,030 | 1/13/2009 |
| _alloc---xajax_server.php.html | 39,639 | 1/13/2009 |
| _gorum2---adodb-time.php.html | 1,274 | 1/13/2009 |
| _gorum2---category.php.html | 2,089 | 1/13/2009 |
| _gorum2---changename.php.html | 1,274 | 1/13/2009 |
| _gorum2---charconvert.php.html | 2,098 | 1/13/2009 |
| _gorum2---constants.php.html | 1,271 | 1/13/2009 |
| _gorum2---date.php.html | 2,077 | 1/13/2009 |
| _gorum2---dbproperty.php.html | 1,274 | 1/13/2009 |
| _gorum2---dbtreeproperty.php.html | 1,286 | 1/13/2009 |
| _gorum2---firephp---fb.php.html | 3,896 | 1/13/2009 |
| _gorum2---firephp---FirePHP.class.php.html | 2,217 | 1/13/2009 |
| _gorum2---flood.php.html | 2,080 | 1/13/2009 |
| _gorum2---form.php.html | 2,077 | 1/13/2009 |
| _gorum2---g.php.html | 2,068 | 1/13/2009 |
| _gorum2---gorum.php.html | 16,865 | 1/13/2009 |
| _gorum2---gorumlib.php.html | 1,268 | 1/13/2009 |
| _gorum2---gorum_db.php.html | 9,645 | 1/13/2009 |
| _gorum2---hasmany.php.html | 2,833 | 1/13/2009 |
| _gorum2---htmllist.php.html | 1,268 | 1/13/2009 |
| _gorum2---imap.php.html | 1,256 | 1/13/2009 |
| _gorum2---init.php.html | 2,077 | 1/13/2009 |
| _gorum2---installlib.php.html | 1,274 | 1/13/2009 |
| _gorum2---javascript.php.html | 2,095 | 1/13/2009 |
| _gorum2---loginlib.php.html | 1,268 | 1/13/2009 |
| _gorum2---loginlib_high.php.html | 1,283 | 1/13/2009 |
| _gorum2---object.php.html | 2,083 | 1/13/2009 |
| _gorum2---presentation---deleteformpresentation.php.html | 2,156 | 1/13/2009 |
| _gorum2---presentation---detailspresentation.php.html | 2,147 | 1/13/2009 |
| _gorum2---presentation---filter.php.html | 2,108 | 1/13/2009 |
| _gorum2---presentation---formpresentation.php.html | 2,138 | 1/13/2009 |
| _gorum2---presentation---generdatewidget.php.html | 2,135 | 1/13/2009 |
| _gorum2---presentation---genervoicewidget.php.html | 2,138 | 1/13/2009 |
| _gorum2---presentation---generwidget.php.html | 2,123 | 1/13/2009 |
| _gorum2---presentation---listpresentation.php.html | 2,138 | 1/13/2009 |
| _gorum2---presentation---lllproperties.php.html | 2,129 | 1/13/2009 |
| _gorum2---presentation---presentation.php.html | 2,126 | 1/13/2009 |
| _gorum2---privilegeproperty.php.html | 1,295 | 1/13/2009 |
| _gorum2---relativedate.php.html | 3,026 | 1/13/2009 |
| _gorum2---roll.php.html | 2,077 | 1/13/2009 |
| _gorum2---sqlparser.php.html | 1,271 | 1/13/2009 |
| _gorum2---stopwatch.php.html | 2,092 | 1/13/2009 |
| _gorum2---tools.php.html | 1,259 | 1/13/2009 |
| _gorum2---updatelib.php.html | 1,271 | 1/13/2009 |
| _gorum2---user_email.php.html | 2,095 | 1/13/2009 |
| _gorum2---user_high.php.html | 2,092 | 1/13/2009 |
| _gorum2---user_simple.php.html | 2,098 | 1/13/2009 |
| _gorum2---view.php.html | 2,077 | 1/13/2009 |
| _gorum2---xdebug.php.html | 1,262 | 1/13/2009 |
| D:\webirs\webirs_source\phpdoc\HTMLframesConverter\earthli\_filesource | | |
| fsource_Savant2_allocgorum2Savant2.php.html | 352,428 | 1/13/2009 |
| fsource_Savant2_gorum2Savant2.php.html | 352,420 | 1/13/2009 |
| fsource_WebIRS_allocartissuearticle.php.html | 43,588 | 1/13/2009 |
| fsource_WebIRS_allocartissuearticlesearch.php.html | 29,101 | 1/13/2009 |
| fsource_WebIRS_allocartissuearticlesearchquery.php.html | 5,863 | 1/13/2009 |
| fsource_WebIRS_allocartissuearticlesearch_typ.php.html | 73,796 | 1/13/2009 |
| fsource_WebIRS_allocartissuearticle_typ.php.html | 77,210 | 1/13/2009 |
| fsource_WebIRS_allocartissueartissue.php.html | 127,919 | 1/13/2009 |
| fsource_WebIRS_allocartissueartissuesearch.php.html | 74,588 | 1/13/2009 |
| fsource_WebIRS_allocartissueartprissue.php.html | 279,897 | 1/13/2009 |
| fsource_WebIRS_allocartissueissue.php.html | 578,428 | 1/13/2009 |
| fsource_WebIRS_allocartissueissuelistpresentation.php.html | 113,725 | 1/13/2009 |
| fsource_WebIRS_allocartissueissuesearch.php.html | 185,783 | 1/13/2009 |
| fsource_WebIRS_allocartissueissuesearchquery.php.html | 163,230 | 1/13/2009 |
| fsource_WebIRS_allocartissueissuesearch_typ.php.html | 159,475 | 1/13/2009 |
| fsource_WebIRS_allocartissueissue_typ.php.html | 238,532 | 1/13/2009 |
| fsource_WebIRS_allocartissuepriorityindex.php.html | 29,458 | 1/13/2009 |
| fsource_WebIRS_allocartissueprissuesearch.php.html | 175,795 | 1/13/2009 |
| fsource_WebIRS_allocartissueproject.php.html | 92,475 | 1/13/2009 |
| fsource_WebIRS_allocartissueprojectsearch.php.html | 32,481 | 1/13/2009 |
| fsource_WebIRS_allocartissueprojectsearchquery.php.html | 19,674 | 1/13/2009 |
| fsource_WebIRS_allocartissueprojectsearch_typ.php.html | 90,790 | 1/13/2009 |
| fsource_WebIRS_allocartissueproject_typ.php.html | 93,193 | 1/13/2009 |
| fsource_WebIRS_allocartissuesearchquery.php.html | 87,777 | 1/13/2009 |
| fsource_WebIRS_allocattach.php.html | 125,091 | 1/13/2009 |
| fsource_WebIRS_allocbillableitemexpenseitem.php.html | 75,356 | 1/13/2009 |
| fsource_WebIRS_allocbillableitemitem.php.html | 220,694 | 1/13/2009 |
| fsource_WebIRS_allocbillableitemitemsearch.php.html | 81,265 | 1/13/2009 |
| fsource_WebIRS_allocbillableitemlabor.php.html | 27,894 | 1/13/2009 |
| fsource_WebIRS_allocbillableitemmilagereport.php.html | 45,802 | 1/13/2009 |
| fsource_WebIRS_allocbillableitemreimbursableitem.php.html | 9,000 | 1/13/2009 |
| fsource_WebIRS_allocbillableitemresaleitem.php.html | 54,657 | 1/13/2009 |
| fsource_WebIRS_allocbillableitemworkreport.php.html | 57,086 | 1/13/2009 |
| fsource_WebIRS_alloccategory.php.html | 58,765 | 1/13/2009 |
| fsource_WebIRS_allocclientgroup.php.html | 14,096 | 1/13/2009 |
| fsource_WebIRS_allocclock.php.html | 2,113 | 1/13/2009 |
| fsource_WebIRS_alloccombine.php.html | 40,125 | 1/13/2009 |
| fsource_WebIRS_allocconfig.php.html | 6,357 | 1/13/2009 |
| fsource_WebIRS_allocconstants.php.html | 80,905 | 1/13/2009 |
| fsource_WebIRS_alloccreateflag.php.html | 1,847 | 1/13/2009 |
| fsource_WebIRS_alloccronjob.php.html | 4,591 | 1/13/2009 |
| fsource_WebIRS_allocdokuwiki.php.html | 110,322 | 1/13/2009 |
| fsource_WebIRS_allocerror.php.html | 20,714 | 1/13/2009 |
| fsource_WebIRS_allocflag.php.html | 113,918 | 1/13/2009 |
| fsource_WebIRS_allocget_css.php.html | 16,373 | 1/13/2009 |
| fsource_WebIRS_allocget_js.php.html | 10,322 | 1/13/2009 |
| fsource_WebIRS_allocgorum2adodb-time.php.html | 244,820 | 1/13/2009 |
| fsource_WebIRS_allocgorum2category.php.html | 95,911 | 1/13/2009 |
| fsource_WebIRS_allocgorum2changename.php.html | 15,812 | 1/13/2009 |
| fsource_WebIRS_allocgorum2charconvert.php.html | 6,963 | 1/13/2009 |
| fsource_WebIRS_allocgorum2constants.php.html | 43,419 | 1/13/2009 |
| fsource_WebIRS_allocgorum2date.php.html | 228,961 | 1/13/2009 |
| fsource_WebIRS_allocgorum2dbproperty.php.html | 128,659 | 1/13/2009 |
| fsource_WebIRS_allocgorum2dbtreeproperty.php.html | 38,286 | 1/13/2009 |
| fsource_WebIRS_allocgorum2flood.php.html | 8,604 | 1/13/2009 |
| fsource_WebIRS_allocgorum2form.php.html | 10,605 | 1/13/2009 |
| fsource_WebIRS_allocgorum2g.php.html | 37,417 | 1/13/2009 |
| fsource_WebIRS_allocgorum2gorum.php.html | 22,850 | 1/13/2009 |
| fsource_WebIRS_allocgorum2gorumlib.php.html | 99,464 | 1/13/2009 |
| fsource_WebIRS_allocgorum2gorum_db.php.html | 16,581 | 1/13/2009 |
| fsource_WebIRS_allocgorum2hasmany.php.html | 60,126 | 1/13/2009 |
| fsource_WebIRS_allocgorum2htmllist.php.html | 47,563 | 1/13/2009 |
| fsource_WebIRS_allocgorum2imap.php.html | 10,478 | 1/13/2009 |
| fsource_WebIRS_allocgorum2init.php.html | 98,766 | 1/13/2009 |
| fsource_WebIRS_allocgorum2installlib.php.html | 188,775 | 1/13/2009 |
| fsource_WebIRS_allocgorum2javascript.php.html | 45,990 | 1/13/2009 |
| fsource_WebIRS_allocgorum2loginlib.php.html | 74,759 | 1/13/2009 |
| fsource_WebIRS_allocgorum2loginlib_high.php.html | 29,336 | 1/13/2009 |
| fsource_WebIRS_allocgorum2object.php.html | 288,080 | 1/13/2009 |
| fsource_WebIRS_allocgorum2presentationdeleteformpresentation.php.html | 20,474 | 1/13/2009 |
| fsource_WebIRS_allocgorum2presentationdetailspresentation.php.html | 21,493 | 1/13/2009 |
| fsource_WebIRS_allocgorum2presentationfilter.php.html | 15,733 | 1/13/2009 |
| fsource_WebIRS_allocgorum2presentationformpresentation.php.html | 225,756 | 1/13/2009 |
| fsource_WebIRS_allocgorum2presentationgenerdatewidget.php.html | 119,268 | 1/13/2009 |
| fsource_WebIRS_allocgorum2presentationgenervoicewidget.php.html | 14,981 | 1/13/2009 |
| fsource_WebIRS_allocgorum2presentationgenerwidget.php.html | 107,568 | 1/13/2009 |
| fsource_WebIRS_allocgorum2presentationlistpresentation.php.html | 70,573 | 1/13/2009 |
| fsource_WebIRS_allocgorum2presentationlllproperties.php.html | 23,828 | 1/13/2009 |
| fsource_WebIRS_allocgorum2presentationpresentation.php.html | 14,743 | 1/13/2009 |
| fsource_WebIRS_allocgorum2privilegeproperty.php.html | 58,029 | 1/13/2009 |
| fsource_WebIRS_allocgorum2relativedate.php.html | 85,208 | 1/13/2009 |
| fsource_WebIRS_allocgorum2roll.php.html | 72,383 | 1/13/2009 |
| fsource_WebIRS_allocgorum2sqlparser.php.html | 559,832 | 1/13/2009 |
| fsource_WebIRS_allocgorum2stopwatch.php.html | 18,303 | 1/13/2009 |
| fsource_WebIRS_allocgorum2tools.php.html | 166,776 | 1/13/2009 |
| fsource_WebIRS_allocgorum2updatelib.php.html | 6,335 | 1/13/2009 |
| fsource_WebIRS_allocgorum2user_email.php.html | 182,691 | 1/13/2009 |
| fsource_WebIRS_allocgorum2user_high.php.html | 66,430 | 1/13/2009 |
| fsource_WebIRS_allocgorum2user_simple.php.html | 204,041 | 1/13/2009 |
| fsource_WebIRS_allocgorum2view.php.html | 47,736 | 1/13/2009 |
| fsource_WebIRS_allocgorum2xdebug.php.html | 5,289 | 1/13/2009 |
| fsource_WebIRS_allocgroup.php.html | 14,362 | 1/13/2009 |
| fsource_WebIRS_allochandlerhandler.php.html | 60,499 | 1/13/2009 |
| fsource_WebIRS_allochandlerhandler_artissue.php.html | 40,176 | 1/13/2009 |
| fsource_WebIRS_allochandlerhandler_expenseitem.php.html | 7,227 | 1/13/2009 |
| fsource_WebIRS_allochandlerhandler_issue.php.html | 59,126 | 1/13/2009 |
| fsource_WebIRS_allochandlerhandler_project.php.html | 6,598 | 1/13/2009 |
| fsource_WebIRS_allochandlerhandler_resaleitem.php.html | 3,019 | 1/13/2009 |
| fsource_WebIRS_allochandlerlog.php.html | 58,440 | 1/13/2009 |
| fsource_WebIRS_allochandlerlogaction.php.html | 58,705 | 1/13/2009 |
| fsource_WebIRS_allochandlerlogsubscription.php.html | 44,590 | 1/13/2009 |
| fsource_WebIRS_allochandlernotification.php.html | 227,734 | 1/13/2009 |
| fsource_WebIRS_allochandlernotifsubscription.php.html | 115,985 | 1/13/2009 |
| fsource_WebIRS_allocinclude.php.html | 21,104 | 1/13/2009 |
| fsource_WebIRS_allocindex.php.html | 4,365 | 1/13/2009 |
| fsource_WebIRS_allocinit.php.html | 202,058 | 1/13/2009 |
| fsource_WebIRS_allocitemlist.php.html | 40,739 | 1/13/2009 |
| fsource_WebIRS_allocjs_css_map.php.html | 16,884 | 1/13/2009 |
| fsource_WebIRS_allocmyform.php.html | 2,027 | 1/13/2009 |
| fsource_WebIRS_allocnote.php.html | 98,134 | 1/13/2009 |
| fsource_WebIRS_allocnotelist.php.html | 50,117 | 1/13/2009 |
| fsource_WebIRS_allocobject.php.html | 114,479 | 1/13/2009 |
| fsource_WebIRS_allocobjectnotelist.php.html | 33,175 | 1/13/2009 |
| fsource_WebIRS_allocperiod.php.html | 536,719 | 1/13/2009 |
| fsource_WebIRS_allocperiodlist.php.html | 34,457 | 1/13/2009 |
| fsource_WebIRS_allocpermconfig.js.php.html | 5,130 | 1/13/2009 |
| fsource_WebIRS_allocpermconfig.php.html | 103,563 | 1/13/2009 |
| fsource_WebIRS_allocpermission.php.html | 131,714 | 1/13/2009 |
| fsource_WebIRS_allocportal.php.html | 40,073 | 1/13/2009 |
| fsource_WebIRS_allocportalattr.php.html | 174,681 | 1/13/2009 |
| fsource_WebIRS_allocraritiesassignments.php.html | 2,010 | 1/13/2009 |
| fsource_WebIRS_allocraritiesbreadcrumb.php.html | 23,335 | 1/13/2009 |
| fsource_WebIRS_allocraritiescache.php.html | 7,322 | 1/13/2009 |
| fsource_WebIRS_allocraritiesclass.phpmailer.php.html | 411,346 | 1/13/2009 |
| fsource_WebIRS_allocraritiesclass.smtp.php.html | 241,273 | 1/13/2009 |
| fsource_WebIRS_allocraritiesclient.php.html | 66,582 | 1/13/2009 |
| fsource_WebIRS_allocraritiescomingsoon.php.html | 18,684 | 1/13/2009 |
| fsource_WebIRS_allocraritiesdisplayerror.php.html | 3,950 | 1/13/2009 |
| fsource_WebIRS_allocraritiesproxy.php.html | 3,381 | 1/13/2009 |
| fsource_WebIRS_allocraritiesrate.php.html | 93,457 | 1/13/2009 |
| fsource_WebIRS_allocraritiesrate_milage.php.html | 58,677 | 1/13/2009 |
| fsource_WebIRS_allocraritiesreadstate.php.html | 9,240 | 1/13/2009 |
| fsource_WebIRS_allocrecurringdistributeditemdef.php.html | 23,659 | 1/13/2009 |
| fsource_WebIRS_allocrecurringrecurringitemdef.php.html | 3,369 | 1/13/2009 |
| fsource_WebIRS_allocrecurringspecitem.php.html | 55,293 | 1/13/2009 |
| fsource_WebIRS_allocrecurringspecitemdef.php.html | 89,969 | 1/13/2009 |
| fsource_WebIRS_allocreportreport.php.html | 68,618 | 1/13/2009 |
| fsource_WebIRS_allocreportreport_category.php.html | 104,154 | 1/13/2009 |
| fsource_WebIRS_allocreportreport_employee.php.html | 71,760 | 1/13/2009 |
| fsource_WebIRS_allocreportreport_employeeactivity.php.html | 30,199 | 1/13/2009 |
| fsource_WebIRS_allocreportreport_item.php.html | 245,701 | 1/13/2009 |
| fsource_WebIRS_allocreportreport_payroll.php.html | 68,664 | 1/13/2009 |
| fsource_WebIRS_allocreportreport_vacation.php.html | 36,264 | 1/13/2009 |
| fsource_WebIRS_allocsearch.php.html | 104,107 | 1/13/2009 |
| fsource_WebIRS_allocsettings.php.html | 5,347 | 1/13/2009 |
| fsource_WebIRS_allocsmsclock.php.html | 5,873 | 1/13/2009 |
| fsource_WebIRS_alloctestauth.php.html | 1,867 | 1/13/2009 |
| fsource_WebIRS_allocupdate_items.php.html | 37,033 | 1/13/2009 |
| fsource_WebIRS_allocupdate_logs.php.html | 13,080 | 1/13/2009 |
| fsource_WebIRS_allocupdate_notes.php.html | 8,070 | 1/13/2009 |
| fsource_WebIRS_allocupdate_searches.php.html | 47,224 | 1/13/2009 |
| fsource_WebIRS_allocuser.php.html | 191,436 | 1/13/2009 |
| fsource_WebIRS_allocvacation.php.html | 76,194 | 1/13/2009 |
| fsource_WebIRS_allocvarfields.php.html | 191,486 | 1/13/2009 |
| fsource_WebIRS_allocversion.php.html | 62,887 | 1/13/2009 |
| fsource_WebIRS_allocxajax.php.html | 8,087 | 1/13/2009 |
| fsource_WebIRS_allocxajax_server.php.html | 140,333 | 1/13/2009 |
| fsource_WebIRS_gorum2adodb-time.php.html | 244,812 | 1/13/2009 |
| fsource_WebIRS_gorum2category.php.html | 95,903 | 1/13/2009 |
| fsource_WebIRS_gorum2changename.php.html | 15,804 | 1/13/2009 |
| fsource_WebIRS_gorum2charconvert.php.html | 6,955 | 1/13/2009 |
| fsource_WebIRS_gorum2constants.php.html | 43,752 | 1/13/2009 |
| fsource_WebIRS_gorum2date.php.html | 230,925 | 1/13/2009 |
| fsource_WebIRS_gorum2dbproperty.php.html | 128,651 | 1/13/2009 |
| fsource_WebIRS_gorum2dbtreeproperty.php.html | 38,278 | 1/13/2009 |
| fsource_WebIRS_gorum2firephpfb.php.html | 12,335 | 1/13/2009 |
| fsource_WebIRS_gorum2firephpFirePHP.class.php.html | 160,425 | 1/13/2009 |
| fsource_WebIRS_gorum2flood.php.html | 8,596 | 1/13/2009 |
| fsource_WebIRS_gorum2form.php.html | 10,597 | 1/13/2009 |
| fsource_WebIRS_gorum2g.php.html | 37,409 | 1/13/2009 |
| fsource_WebIRS_gorum2gorum.php.html | 22,842 | 1/13/2009 |
| fsource_WebIRS_gorum2gorumlib.php.html | 99,456 | 1/13/2009 |
| fsource_WebIRS_gorum2gorum_db.php.html | 16,573 | 1/13/2009 |
| fsource_WebIRS_gorum2hasmany.php.html | 60,118 | 1/13/2009 |
| fsource_WebIRS_gorum2htmllist.php.html | 47,555 | 1/13/2009 |
| fsource_WebIRS_gorum2imap.php.html | 10,470 | 1/13/2009 |
| fsource_WebIRS_gorum2init.php.html | 98,758 | 1/13/2009 |
| fsource_WebIRS_gorum2installlib.php.html | 188,767 | 1/13/2009 |
| fsource_WebIRS_gorum2javascript.php.html | 45,982 | 1/13/2009 |
| fsource_WebIRS_gorum2loginlib.php.html | 74,751 | 1/13/2009 |
| fsource_WebIRS_gorum2loginlib_high.php.html | 29,328 | 1/13/2009 |
| fsource_WebIRS_gorum2object.php.html | 288,072 | 1/13/2009 |
| fsource_WebIRS_gorum2presentationdeleteformpresentation.php.html | 20,466 | 1/13/2009 |
| fsource_WebIRS_gorum2presentationdetailspresentation.php.html | 21,485 | 1/13/2009 |
| fsource_WebIRS_gorum2presentationfilter.php.html | 15,725 | 1/13/2009 |
| fsource_WebIRS_gorum2presentationformpresentation.php.html | 228,368 | 1/13/2009 |
| fsource_WebIRS_gorum2presentationgenerdatewidget.php.html | 119,260 | 1/13/2009 |
| fsource_WebIRS_gorum2presentationgenervoicewidget.php.html | 14,973 | 1/13/2009 |
| fsource_WebIRS_gorum2presentationgenerwidget.php.html | 111,189 | 1/13/2009 |
| fsource_WebIRS_gorum2presentationlistpresentation.php.html | 70,565 | 1/13/2009 |
| fsource_WebIRS_gorum2presentationlllproperties.php.html | 23,820 | 1/13/2009 |
| fsource_WebIRS_gorum2presentationpresentation.php.html | 14,735 | 1/13/2009 |
| fsource_WebIRS_gorum2privilegeproperty.php.html | 58,021 | 1/13/2009 |
| fsource_WebIRS_gorum2relativedate.php.html | 85,200 | 1/13/2009 |
| fsource_WebIRS_gorum2roll.php.html | 72,375 | 1/13/2009 |
| fsource_WebIRS_gorum2sqlparser.php.html | 559,824 | 1/13/2009 |
| fsource_WebIRS_gorum2stopwatch.php.html | 18,295 | 1/13/2009 |
| fsource_WebIRS_gorum2tools.php.html | 168,006 | 1/13/2009 |
| fsource_WebIRS_gorum2updatelib.php.html | 6,327 | 1/13/2009 |
| fsource_WebIRS_gorum2user_email.php.html | 182,683 | 1/13/2009 |
| fsource_WebIRS_gorum2user_high.php.html | 66,422 | 1/13/2009 |
| fsource_WebIRS_gorum2user_simple.php.html | 204,033 | 1/13/2009 |
| fsource_WebIRS_gorum2view.php.html | 47,728 | 1/13/2009 |
| fsource_WebIRS_gorum2xdebug.php.html | 5,281 | 1/13/2009 |
| D:\webirs\webirs_source\phpdoc\HTMLframesConverter\I0I33t | | |
| blank.html | 381 | 1/13/2009 |
| classtrees_Savant2.html | 868 | 1/13/2009 |
| classtrees_WebIRS.html | 6,082 | 1/13/2009 |
| elementindex.html | 630,578 | 1/13/2009 |
| elementindex_Savant2.html | 21,855 | 1/13/2009 |
| elementindex_WebIRS.html | 614,185 | 1/13/2009 |
| errors.html | 182,012 | 1/13/2009 |
| index.html | 934 | 1/13/2009 |
| li_Savant2.html | 1,475 | 1/13/2009 |
| li_WebIRS.html | 58,243 | 1/13/2009 |
| packages.html | 1,246 | 1/13/2009 |
| D:\webirs\webirs_source\phpdoc\HTMLframesConverter\I0I33t\media | | |
| banner.css | 442 | 1/13/2009 |
| bg_left.png | 181 | 1/13/2009 |
| stylesheet.css | 5,728 | 1/13/2009 |
| D:\webirs\webirs_source\phpdoc\HTMLframesConverter\I0I33t\Savant2 | | |
| Savant2.html | 72,989 | 1/13/2009 |
| _alloc---gorum2---Savant2.php.html | 5,574 | 1/13/2009 |
| _gorum2---Savant2.php.html | 1,939 | 1/13/2009 |
| D:\webirs\webirs_source\phpdoc\HTMLframesConverter\I0I33t\WebIRS | | |
| AllocError.html | 3,964 | 1/13/2009 |
| AllocXajaxResponse.html | 8,510 | 1/13/2009 |
| AppCategory.html | 12,821 | 1/13/2009 |
| AppInit.html | 13,025 | 1/13/2009 |
| AppObject.html | 60,019 | 1/13/2009 |
| AppUser.html | 18,875 | 1/13/2009 |
| Article.html | 37,095 | 1/13/2009 |
| ArticleSearch.html | 19,972 | 1/13/2009 |
| ArticleSearchQuery.html | 8,637 | 1/13/2009 |
| ArtIssue.html | 37,392 | 1/13/2009 |
| ArtIssueHandler.html | 14,778 | 1/13/2009 |
| ArtIssueSearch.html | 33,119 | 1/13/2009 |
| ArtPrIssue.html | 75,444 | 1/13/2009 |
| Attach.html | 18,228 | 1/13/2009 |
| Breadcrumb.html | 4,548 | 1/13/2009 |
| Cache.html | 4,780 | 1/13/2009 |
| Category.html | 20,747 | 1/13/2009 |
| CategoryReport.html | 4,471 | 1/13/2009 |
| CharConvert.html | 5,836 | 1/13/2009 |
| Client.html | 12,376 | 1/13/2009 |
| ClientGroup.html | 4,578 | 1/13/2009 |
| Date.html | 90,992 | 1/13/2009 |
| DeleteFormPresentation.html | 4,521 | 1/13/2009 |
| DetailsPresentation.html | 6,301 | 1/13/2009 |
| DisplayError.html | 3,193 | 1/13/2009 |
| DistributedItemDef.html | 10,652 | 1/13/2009 |
| EmployeeActivityReport.html | 23,165 | 1/13/2009 |
| EmployeeReport.html | 4,472 | 1/13/2009 |
| ExpenseItem.html | 28,704 | 1/13/2009 |
| ExpenseItemHandler.html | 8,376 | 1/13/2009 |
| Filter.html | 10,864 | 1/13/2009 |
| FirePHP.html | 26,903 | 1/13/2009 |
| Flag.html | 15,290 | 1/13/2009 |
| Flood.html | 1,282 | 1/13/2009 |
| FormDisplayType.html | 6,048 | 1/13/2009 |
| FormPresentation.html | 55,052 | 1/13/2009 |
| G.html | 12,721 | 1/13/2009 |
| GenerDateWidget.html | 13,166 | 1/13/2009 |
| GenerVoiceWidget.html | 4,082 | 1/13/2009 |
| GenerWidget.html | 33,481 | 1/13/2009 |
| Handler.html | 20,579 | 1/13/2009 |
| HasMany.html | 15,033 | 1/13/2009 |
| HasManyAttrs.html | 8,864 | 1/13/2009 |
| HasManyWithLinkClass.html | 12,107 | 1/13/2009 |
| HasManyWithoutLinkClass.html | 14,863 | 1/13/2009 |
| Init.html | 19,695 | 1/13/2009 |
| Issue.html | 88,172 | 1/13/2009 |
| IssueHandler.html | 20,220 | 1/13/2009 |
| IssueListPresentation.html | 5,053 | 1/13/2009 |
| IssueSearch.html | 36,886 | 1/13/2009 |
| IssueSearchQuery.html | 49,832 | 1/13/2009 |
| Item.html | 47,415 | 1/13/2009 |
| ItemList.html | 8,622 | 1/13/2009 |
| ItemReport.html | 15,342 | 1/13/2009 |
| ItemSearch.html | 7,882 | 1/13/2009 |
| JavaScript.html | 27,673 | 1/13/2009 |
| Labor.html | 6,313 | 1/13/2009 |
| ListPresentation.html | 9,466 | 1/13/2009 |
| LllProperties.html | 16,302 | 1/13/2009 |
| Log.html | 18,214 | 1/13/2009 |
| LogAction.html | 10,964 | 1/13/2009 |
| LogSubscription.html | 21,738 | 1/13/2009 |
| MilageRate.html | 14,677 | 1/13/2009 |
| MilageReport.html | 29,262 | 1/13/2009 |
| Note.html | 32,571 | 1/13/2009 |
| NoteList.html | 9,352 | 1/13/2009 |
| Notif.html | 19,980 | 1/13/2009 |
| NotifSubscription.html | 33,008 | 1/13/2009 |
| Object.html | 74,723 | 1/13/2009 |
| ObjectNoteList.html | 10,841 | 1/13/2009 |
| PayrollReport.html | 6,245 | 1/13/2009 |
| Period.html | 66,676 | 1/13/2009 |
| PeriodList.html | 8,660 | 1/13/2009 |
| Perm.html | 57,761 | 1/13/2009 |
| PermGroup.html | 4,542 | 1/13/2009 |
| Permission.html | 25,608 | 1/13/2009 |
| PHPMailer.html | 65,386 | 1/13/2009 |
| Portal.html | 12,057 | 1/13/2009 |
| PortalAttr.html | 15,257 | 1/13/2009 |
| Presentation.html | 8,470 | 1/13/2009 |
| PriorityIndex.html | 9,664 | 1/13/2009 |
| PrIssueSearch.html | 33,116 | 1/13/2009 |
| Project.html | 47,127 | 1/13/2009 |
| ProjectHandler.html | 11,447 | 1/13/2009 |
| ProjectSearch.html | 21,575 | 1/13/2009 |
| ProjectSearchQuery.html | 24,615 | 1/13/2009 |
| Rate.html | 20,629 | 1/13/2009 |
| ReadState.html | 3,845 | 1/13/2009 |
| RecurringItemDef.html | 6,626 | 1/13/2009 |
| ReimbursableItem.html | 23,617 | 1/13/2009 |
| RelativeDate.html | 21,350 | 1/13/2009 |
| Report.html | 13,720 | 1/13/2009 |
| ResaleItem.html | 27,638 | 1/13/2009 |
| ResaleItemHandler.html | 7,053 | 1/13/2009 |
| Roll.html | 13,470 | 1/13/2009 |
| Search.html | 7,714 | 1/13/2009 |
| SearchQuery.html | 28,016 | 1/13/2009 |
| Settings.html | 1,278 | 1/13/2009 |
| SMTP.html | 32,819 | 1/13/2009 |
| SpecItem.html | 11,698 | 1/13/2009 |
| SpecItemDef.html | 20,628 | 1/13/2009 |
| Stopwatch.html | 5,021 | 1/13/2009 |
| User.html | 19,377 | 1/13/2009 |
| Vacation.html | 12,202 | 1/13/2009 |
| VacationReport.html | 4,472 | 1/13/2009 |
| VarFields.html | 9,792 | 1/13/2009 |
| Version.html | 10,155 | 1/13/2009 |
| View.html | 29,066 | 1/13/2009 |
| WorkReport.html | 23,978 | 1/13/2009 |
| _alloc---artissue---article.php.html | 2,858 | 1/13/2009 |
| _alloc---artissue---articlesearch.php.html | 2,912 | 1/13/2009 |
| _alloc---artissue---articlesearchquery.php.html | 2,008 | 1/13/2009 |
| _alloc---artissue---articlesearch_typ.php.html | 1,230 | 1/13/2009 |
| _alloc---artissue---article_typ.php.html | 1,212 | 1/13/2009 |
| _alloc---artissue---artissue.php.html | 1,958 | 1/13/2009 |
| _alloc---artissue---artissuesearch.php.html | 1,988 | 1/13/2009 |
| _alloc---artissue---artprissue.php.html | 4,119 | 1/13/2009 |
| _alloc---artissue---issue.php.html | 5,599 | 1/13/2009 |
| _alloc---artissue---issuelistpresentation.php.html | 2,023 | 1/13/2009 |
| _alloc---artissue---issuesearch.php.html | 2,893 | 1/13/2009 |
| _alloc---artissue---issuesearchquery.php.html | 1,998 | 1/13/2009 |
| _alloc---artissue---issuesearch_typ.php.html | 1,224 | 1/13/2009 |
| _alloc---artissue---issue_typ.php.html | 1,206 | 1/13/2009 |
| _alloc---artissue---priorityindex.php.html | 1,983 | 1/13/2009 |
| _alloc---artissue---prissuesearch.php.html | 4,283 | 1/13/2009 |
| _alloc---artissue---project.php.html | 2,858 | 1/13/2009 |
| _alloc---artissue---projectsearch.php.html | 2,912 | 1/13/2009 |
| _alloc---artissue---projectsearchquery.php.html | 2,008 | 1/13/2009 |
| _alloc---artissue---projectsearch_typ.php.html | 1,230 | 1/13/2009 |
| _alloc---artissue---project_typ.php.html | 1,212 | 1/13/2009 |
| _alloc---artissue---searchquery.php.html | 1,973 | 1/13/2009 |
| _alloc---attach.php.html | 1,931 | 1/13/2009 |
| _alloc---billableitem---expenseitem.php.html | 1,981 | 1/13/2009 |
| _alloc---billableitem---item.php.html | 1,946 | 1/13/2009 |
| _alloc---billableitem---itemsearch.php.html | 1,976 | 1/13/2009 |
| _alloc---billableitem---labor.php.html | 1,951 | 1/13/2009 |
| _alloc---billableitem---milagereport.php.html | 1,986 | 1/13/2009 |
| _alloc---billableitem---reimbursableitem.php.html | 2,006 | 1/13/2009 |
| _alloc---billableitem---resaleitem.php.html | 1,976 | 1/13/2009 |
| _alloc---billableitem---workreport.php.html | 1,976 | 1/13/2009 |
| _alloc---category.php.html | 1,947 | 1/13/2009 |
| _alloc---clientgroup.php.html | 1,956 | 1/13/2009 |
| _alloc---clock.php.html | 1,994 | 1/13/2009 |
| _alloc---combine.php.html | 4,960 | 1/13/2009 |
| _alloc---config.php.html | 1,180 | 1/13/2009 |
| _alloc---constants.php.html | 33,700 | 1/13/2009 |
| _alloc---createflag.php.html | 2,015 | 1/13/2009 |
| _alloc---cronjob.php.html | 2,931 | 1/13/2009 |
| _alloc---dokuwiki.php.html | 11,043 | 1/13/2009 |
| _alloc---error.php.html | 3,223 | 1/13/2009 |
| _alloc---flag.php.html | 1,921 | 1/13/2009 |
| _alloc---get_css.php.html | 4,077 | 1/13/2009 |
| _alloc---get_js.php.html | 2,849 | 1/13/2009 |
| _alloc---gorum2---adodb-time.php.html | 17,135 | 1/13/2009 |
| _alloc---gorum2---category.php.html | 2,919 | 1/13/2009 |
| _alloc---gorum2---changename.php.html | 1,205 | 1/13/2009 |
| _alloc---gorum2---charconvert.php.html | 1,969 | 1/13/2009 |
| _alloc---gorum2---constants.php.html | 22,387 | 1/13/2009 |
| _alloc---gorum2---date.php.html | 1,934 | 1/13/2009 |
| _alloc---gorum2---dbproperty.php.html | 20,503 | 1/13/2009 |
| _alloc---gorum2---dbtreeproperty.php.html | 10,860 | 1/13/2009 |
| _alloc---gorum2---flood.php.html | 3,056 | 1/13/2009 |
| _alloc---gorum2---form.php.html | 1,956 | 1/13/2009 |
| _alloc---gorum2---g.php.html | 1,919 | 1/13/2009 |
| _alloc---gorum2---gorum.php.html | 22,439 | 1/13/2009 |
| _alloc---gorum2---gorumlib.php.html | 17,286 | 1/13/2009 |
| _alloc---gorum2---gorum_db.php.html | 8,827 | 1/13/2009 |
| _alloc---gorum2---hasmany.php.html | 2,560 | 1/13/2009 |
| _alloc---gorum2---htmllist.php.html | 5,417 | 1/13/2009 |
| _alloc---gorum2---imap.php.html | 2,611 | 1/13/2009 |
| _alloc---gorum2---init.php.html | 3,362 | 1/13/2009 |
| _alloc---gorum2---installlib.php.html | 14,396 | 1/13/2009 |
| _alloc---gorum2---javascript.php.html | 1,964 | 1/13/2009 |
| _alloc---gorum2---loginlib.php.html | 5,347 | 1/13/2009 |
| _alloc---gorum2---loginlib_high.php.html | 1,214 | 1/13/2009 |
| _alloc---gorum2---object.php.html | 1,944 | 1/13/2009 |
| _alloc---gorum2---presentation---deleteformpresentation.php.html | 2,049 | 1/13/2009 |
| _alloc---gorum2---presentation---detailspresentation.php.html | 2,034 | 1/13/2009 |
| _alloc---gorum2---presentation---filter.php.html | 1,969 | 1/13/2009 |
| _alloc---gorum2---presentation---formpresentation.php.html | 2,019 | 1/13/2009 |
| _alloc---gorum2---presentation---generdatewidget.php.html | 2,014 | 1/13/2009 |
| _alloc---gorum2---presentation---genervoicewidget.php.html | 2,019 | 1/13/2009 |
| _alloc---gorum2---presentation---generwidget.php.html | 1,994 | 1/13/2009 |
| _alloc---gorum2---presentation---listpresentation.php.html | 2,019 | 1/13/2009 |
| _alloc---gorum2---presentation---lllproperties.php.html | 2,004 | 1/13/2009 |
| _alloc---gorum2---presentation---presentation.php.html | 1,999 | 1/13/2009 |
| _alloc---gorum2---privilegeproperty.php.html | 9,438 | 1/13/2009 |
| _alloc---gorum2---relativedate.php.html | 2,864 | 1/13/2009 |
| _alloc---gorum2---roll.php.html | 4,771 | 1/13/2009 |
| _alloc---gorum2---sqlparser.php.html | 27,768 | 1/13/2009 |
| _alloc---gorum2---stopwatch.php.html | 1,959 | 1/13/2009 |
| _alloc---gorum2---tools.php.html | 11,430 | 1/13/2009 |
| _alloc---gorum2---updatelib.php.html | 2,930 | 1/13/2009 |
| _alloc---gorum2---user_email.php.html | 1,952 | 1/13/2009 |
| _alloc---gorum2---user_high.php.html | 1,911 | 1/13/2009 |
| _alloc---gorum2---user_simple.php.html | 3,564 | 1/13/2009 |
| _alloc---gorum2---view.php.html | 1,934 | 1/13/2009 |
| _alloc---gorum2---xdebug.php.html | 2,801 | 1/13/2009 |
| _alloc---group.php.html | 1,934 | 1/13/2009 |
| _alloc---handler---handler.php.html | 1,951 | 1/13/2009 |
| _alloc---handler---handler_artissue.php.html | 1,994 | 1/13/2009 |
| _alloc---handler---handler_expenseitem.php.html | 2,009 | 1/13/2009 |
| _alloc---handler---handler_issue.php.html | 1,979 | 1/13/2009 |
| _alloc---handler---handler_project.php.html | 1,989 | 1/13/2009 |
| _alloc---handler---handler_resaleitem.php.html | 2,004 | 1/13/2009 |
| _alloc---handler---log.php.html | 1,931 | 1/13/2009 |
| _alloc---handler---logaction.php.html | 1,961 | 1/13/2009 |
| _alloc---handler---logsubscription.php.html | 1,991 | 1/13/2009 |
| _alloc---handler---notification.php.html | 3,128 | 1/13/2009 |
| _alloc---handler---notifsubscription.php.html | 2,001 | 1/13/2009 |
| _alloc---include.php.html | 39,710 | 1/13/2009 |
| _alloc---index.php.html | 3,747 | 1/13/2009 |
| _alloc---init.php.html | 6,496 | 1/13/2009 |
| _alloc---itemlist.php.html | 1,941 | 1/13/2009 |
| _alloc---js_css_map.php.html | 1,192 | 1/13/2009 |
| _alloc---myform.php.html | 1,998 | 1/13/2009 |
| _alloc---note.php.html | 1,921 | 1/13/2009 |
| _alloc---notelist.php.html | 1,941 | 1/13/2009 |
| _alloc---object.php.html | 1,937 | 1/13/2009 |
| _alloc---objectnotelist.php.html | 1,971 | 1/13/2009 |
| _alloc---period.php.html | 3,123 | 1/13/2009 |
| _alloc---periodlist.php.html | 1,951 | 1/13/2009 |
| _alloc---permconfig.js.php.html | 3,480 | 1/13/2009 |
| _alloc---permconfig.php.html | 1,939 | 1/13/2009 |
| _alloc---permission.php.html | 3,281 | 1/13/2009 |
| _alloc---portal.php.html | 1,931 | 1/13/2009 |
| _alloc---portalattr.php.html | 3,101 | 1/13/2009 |
| _alloc---rarities---assignments.php.html | 1,212 | 1/13/2009 |
| _alloc---rarities---breadcrumb.php.html | 1,968 | 1/13/2009 |
| _alloc---rarities---cache.php.html | 1,943 | 1/13/2009 |
| _alloc---rarities---class.phpmailer.php.html | 1,981 | 1/13/2009 |
| _alloc---rarities---class.smtp.php.html | 1,956 | 1/13/2009 |
| _alloc---rarities---client.php.html | 1,948 | 1/13/2009 |
| _alloc---rarities---comingsoon.php.html | 1,209 | 1/13/2009 |
| _alloc---rarities---displayerror.php.html | 1,978 | 1/13/2009 |
| _alloc---rarities---proxy.php.html | 1,194 | 1/13/2009 |
| _alloc---rarities---rate.php.html | 1,938 | 1/13/2009 |
| _alloc---rarities---rate_milage.php.html | 1,971 | 1/13/2009 |
| _alloc---rarities---readstate.php.html | 3,481 | 1/13/2009 |
| _alloc---recurring---distributeditemdef.php.html | 2,938 | 1/13/2009 |
| _alloc---recurring---recurringitemdef.php.html | 2,000 | 1/13/2009 |
| _alloc---recurring---specitem.php.html | 1,960 | 1/13/2009 |
| _alloc---recurring---specitemdef.php.html | 1,975 | 1/13/2009 |
| _alloc---report---report.php.html | 1,944 | 1/13/2009 |
| _alloc---report---report_category.php.html | 1,987 | 1/13/2009 |
| _alloc---report---report_employee.php.html | 4,522 | 1/13/2009 |
| _alloc---report---report_employeeactivity.php.html | 2,027 | 1/13/2009 |
| _alloc---report---report_item.php.html | 3,281 | 1/13/2009 |
| _alloc---report---report_payroll.php.html | 1,982 | 1/13/2009 |
| _alloc---report---report_vacation.php.html | 1,987 | 1/13/2009 |
| _alloc---search.php.html | 1,931 | 1/13/2009 |
| _alloc---settings.php.html | 1,941 | 1/13/2009 |
| _alloc---smsclock.php.html | 3,370 | 1/13/2009 |
| _alloc---testauth.php.html | 1,186 | 1/13/2009 |
| _alloc---update_items.php.html | 3,357 | 1/13/2009 |
| _alloc---update_logs.php.html | 3,350 | 1/13/2009 |
| _alloc---update_notes.php.html | 3,357 | 1/13/2009 |
| _alloc---update_searches.php.html | 3,378 | 1/13/2009 |
| _alloc---user.php.html | 1,927 | 1/13/2009 |
| _alloc---vacation.php.html | 1,941 | 1/13/2009 |
| _alloc---varfields.php.html | 4,165 | 1/13/2009 |
| _alloc---version.php.html | 1,936 | 1/13/2009 |
| _alloc---xajax.php.html | 2,789 | 1/13/2009 |
| _alloc---xajax_server.php.html | 36,599 | 1/13/2009 |
| _gorum2---adodb-time.php.html | 1,194 | 1/13/2009 |
| _gorum2---category.php.html | 1,897 | 1/13/2009 |
| _gorum2---changename.php.html | 1,194 | 1/13/2009 |
| _gorum2---charconvert.php.html | 1,906 | 1/13/2009 |
| _gorum2---constants.php.html | 1,191 | 1/13/2009 |
| _gorum2---date.php.html | 1,885 | 1/13/2009 |
| _gorum2---dbproperty.php.html | 1,194 | 1/13/2009 |
| _gorum2---dbtreeproperty.php.html | 1,206 | 1/13/2009 |
| _gorum2---firephp---fb.php.html | 3,724 | 1/13/2009 |
| _gorum2---firephp---FirePHP.class.php.html | 2,025 | 1/13/2009 |
| _gorum2---flood.php.html | 1,888 | 1/13/2009 |
| _gorum2---form.php.html | 1,885 | 1/13/2009 |
| _gorum2---g.php.html | 1,876 | 1/13/2009 |
| _gorum2---gorum.php.html | 15,217 | 1/13/2009 |
| _gorum2---gorumlib.php.html | 1,188 | 1/13/2009 |
| _gorum2---gorum_db.php.html | 8,732 | 1/13/2009 |
| _gorum2---hasmany.php.html | 2,305 | 1/13/2009 |
| _gorum2---htmllist.php.html | 1,188 | 1/13/2009 |
| _gorum2---imap.php.html | 1,176 | 1/13/2009 |
| _gorum2---init.php.html | 1,885 | 1/13/2009 |
| _gorum2---installlib.php.html | 1,194 | 1/13/2009 |
| _gorum2---javascript.php.html | 1,903 | 1/13/2009 |
| _gorum2---loginlib.php.html | 1,188 | 1/13/2009 |
| _gorum2---loginlib_high.php.html | 1,203 | 1/13/2009 |
| _gorum2---object.php.html | 1,891 | 1/13/2009 |
| _gorum2---presentation---deleteformpresentation.php.html | 1,964 | 1/13/2009 |
| _gorum2---presentation---detailspresentation.php.html | 1,955 | 1/13/2009 |
| _gorum2---presentation---filter.php.html | 1,916 | 1/13/2009 |
| _gorum2---presentation---formpresentation.php.html | 1,946 | 1/13/2009 |
| _gorum2---presentation---generdatewidget.php.html | 1,943 | 1/13/2009 |
| _gorum2---presentation---genervoicewidget.php.html | 1,946 | 1/13/2009 |
| _gorum2---presentation---generwidget.php.html | 1,931 | 1/13/2009 |
| _gorum2---presentation---listpresentation.php.html | 1,946 | 1/13/2009 |
| _gorum2---presentation---lllproperties.php.html | 1,937 | 1/13/2009 |
| _gorum2---presentation---presentation.php.html | 1,934 | 1/13/2009 |
| _gorum2---privilegeproperty.php.html | 1,215 | 1/13/2009 |
| _gorum2---relativedate.php.html | 2,785 | 1/13/2009 |
| _gorum2---roll.php.html | 1,885 | 1/13/2009 |
| _gorum2---sqlparser.php.html | 1,191 | 1/13/2009 |
| _gorum2---stopwatch.php.html | 1,900 | 1/13/2009 |
| _gorum2---tools.php.html | 1,179 | 1/13/2009 |
| _gorum2---updatelib.php.html | 1,191 | 1/13/2009 |
| _gorum2---user_email.php.html | 1,903 | 1/13/2009 |
| _gorum2---user_high.php.html | 1,900 | 1/13/2009 |
| _gorum2---user_simple.php.html | 1,906 | 1/13/2009 |
| _gorum2---view.php.html | 1,885 | 1/13/2009 |
| _gorum2---xdebug.php.html | 1,182 | 1/13/2009 |
| D:\webirs\webirs_source\phpdoc\HTMLframesConverter\I0I33t\_filesource | | |
| fsource_Savant2_allocgorum2Savant2.php.html | 352,431 | 1/13/2009 |
| fsource_Savant2_gorum2Savant2.php.html | 352,423 | 1/13/2009 |
| fsource_WebIRS_allocartissuearticle.php.html | 43,591 | 1/13/2009 |
| fsource_WebIRS_allocartissuearticlesearch.php.html | 29,104 | 1/13/2009 |
| fsource_WebIRS_allocartissuearticlesearchquery.php.html | 5,866 | 1/13/2009 |
| fsource_WebIRS_allocartissuearticlesearch_typ.php.html | 73,799 | 1/13/2009 |
| fsource_WebIRS_allocartissuearticle_typ.php.html | 77,213 | 1/13/2009 |
| fsource_WebIRS_allocartissueartissue.php.html | 127,922 | 1/13/2009 |
| fsource_WebIRS_allocartissueartissuesearch.php.html | 74,591 | 1/13/2009 |
| fsource_WebIRS_allocartissueartprissue.php.html | 279,900 | 1/13/2009 |
| fsource_WebIRS_allocartissueissue.php.html | 578,431 | 1/13/2009 |
| fsource_WebIRS_allocartissueissuelistpresentation.php.html | 113,728 | 1/13/2009 |
| fsource_WebIRS_allocartissueissuesearch.php.html | 185,786 | 1/13/2009 |
| fsource_WebIRS_allocartissueissuesearchquery.php.html | 163,233 | 1/13/2009 |
| fsource_WebIRS_allocartissueissuesearch_typ.php.html | 159,478 | 1/13/2009 |
| fsource_WebIRS_allocartissueissue_typ.php.html | 238,535 | 1/13/2009 |
| fsource_WebIRS_allocartissuepriorityindex.php.html | 29,461 | 1/13/2009 |
| fsource_WebIRS_allocartissueprissuesearch.php.html | 175,798 | 1/13/2009 |
| fsource_WebIRS_allocartissueproject.php.html | 92,478 | 1/13/2009 |
| fsource_WebIRS_allocartissueprojectsearch.php.html | 32,484 | 1/13/2009 |
| fsource_WebIRS_allocartissueprojectsearchquery.php.html | 19,677 | 1/13/2009 |
| fsource_WebIRS_allocartissueprojectsearch_typ.php.html | 90,793 | 1/13/2009 |
| fsource_WebIRS_allocartissueproject_typ.php.html | 93,196 | 1/13/2009 |
| fsource_WebIRS_allocartissuesearchquery.php.html | 87,780 | 1/13/2009 |
| fsource_WebIRS_allocattach.php.html | 125,094 | 1/13/2009 |
| fsource_WebIRS_allocbillableitemexpenseitem.php.html | 75,359 | 1/13/2009 |
| fsource_WebIRS_allocbillableitemitem.php.html | 220,697 | 1/13/2009 |
| fsource_WebIRS_allocbillableitemitemsearch.php.html | 81,268 | 1/13/2009 |
| fsource_WebIRS_allocbillableitemlabor.php.html | 27,897 | 1/13/2009 |
| fsource_WebIRS_allocbillableitemmilagereport.php.html | 45,805 | 1/13/2009 |
| fsource_WebIRS_allocbillableitemreimbursableitem.php.html | 9,003 | 1/13/2009 |
| fsource_WebIRS_allocbillableitemresaleitem.php.html | 54,660 | 1/13/2009 |
| fsource_WebIRS_allocbillableitemworkreport.php.html | 57,089 | 1/13/2009 |
| fsource_WebIRS_alloccategory.php.html | 58,768 | 1/13/2009 |
| fsource_WebIRS_allocclientgroup.php.html | 14,099 | 1/13/2009 |
| fsource_WebIRS_allocclock.php.html | 2,116 | 1/13/2009 |
| fsource_WebIRS_alloccombine.php.html | 40,128 | 1/13/2009 |
| fsource_WebIRS_allocconfig.php.html | 6,360 | 1/13/2009 |
| fsource_WebIRS_allocconstants.php.html | 80,908 | 1/13/2009 |
| fsource_WebIRS_alloccreateflag.php.html | 1,850 | 1/13/2009 |
| fsource_WebIRS_alloccronjob.php.html | 4,594 | 1/13/2009 |
| fsource_WebIRS_allocdokuwiki.php.html | 110,325 | 1/13/2009 |
| fsource_WebIRS_allocerror.php.html | 20,717 | 1/13/2009 |
| fsource_WebIRS_allocflag.php.html | 113,921 | 1/13/2009 |
| fsource_WebIRS_allocget_css.php.html | 16,376 | 1/13/2009 |
| fsource_WebIRS_allocget_js.php.html | 10,325 | 1/13/2009 |
| fsource_WebIRS_allocgorum2adodb-time.php.html | 244,823 | 1/13/2009 |
| fsource_WebIRS_allocgorum2category.php.html | 95,914 | 1/13/2009 |
| fsource_WebIRS_allocgorum2changename.php.html | 15,815 | 1/13/2009 |
| fsource_WebIRS_allocgorum2charconvert.php.html | 6,966 | 1/13/2009 |
| fsource_WebIRS_allocgorum2constants.php.html | 43,422 | 1/13/2009 |
| fsource_WebIRS_allocgorum2date.php.html | 228,964 | 1/13/2009 |
| fsource_WebIRS_allocgorum2dbproperty.php.html | 128,662 | 1/13/2009 |
| fsource_WebIRS_allocgorum2dbtreeproperty.php.html | 38,289 | 1/13/2009 |
| fsource_WebIRS_allocgorum2flood.php.html | 8,607 | 1/13/2009 |
| fsource_WebIRS_allocgorum2form.php.html | 10,608 | 1/13/2009 |
| fsource_WebIRS_allocgorum2g.php.html | 37,420 | 1/13/2009 |
| fsource_WebIRS_allocgorum2gorum.php.html | 22,853 | 1/13/2009 |
| fsource_WebIRS_allocgorum2gorumlib.php.html | 99,467 | 1/13/2009 |
| fsource_WebIRS_allocgorum2gorum_db.php.html | 16,584 | 1/13/2009 |
| fsource_WebIRS_allocgorum2hasmany.php.html | 60,129 | 1/13/2009 |
| fsource_WebIRS_allocgorum2htmllist.php.html | 47,566 | 1/13/2009 |
| fsource_WebIRS_allocgorum2imap.php.html | 10,481 | 1/13/2009 |
| fsource_WebIRS_allocgorum2init.php.html | 98,769 | 1/13/2009 |
| fsource_WebIRS_allocgorum2installlib.php.html | 188,778 | 1/13/2009 |
| fsource_WebIRS_allocgorum2javascript.php.html | 45,993 | 1/13/2009 |
| fsource_WebIRS_allocgorum2loginlib.php.html | 74,762 | 1/13/2009 |
| fsource_WebIRS_allocgorum2loginlib_high.php.html | 29,339 | 1/13/2009 |
| fsource_WebIRS_allocgorum2object.php.html | 288,083 | 1/13/2009 |
| fsource_WebIRS_allocgorum2presentationdeleteformpresentation.php.html | 20,477 | 1/13/2009 |
| fsource_WebIRS_allocgorum2presentationdetailspresentation.php.html | 21,496 | 1/13/2009 |
| fsource_WebIRS_allocgorum2presentationfilter.php.html | 15,736 | 1/13/2009 |
| fsource_WebIRS_allocgorum2presentationformpresentation.php.html | 225,759 | 1/13/2009 |
| fsource_WebIRS_allocgorum2presentationgenerdatewidget.php.html | 119,271 | 1/13/2009 |
| fsource_WebIRS_allocgorum2presentationgenervoicewidget.php.html | 14,984 | 1/13/2009 |
| fsource_WebIRS_allocgorum2presentationgenerwidget.php.html | 107,571 | 1/13/2009 |
| fsource_WebIRS_allocgorum2presentationlistpresentation.php.html | 70,576 | 1/13/2009 |
| fsource_WebIRS_allocgorum2presentationlllproperties.php.html | 23,831 | 1/13/2009 |
| fsource_WebIRS_allocgorum2presentationpresentation.php.html | 14,746 | 1/13/2009 |
| fsource_WebIRS_allocgorum2privilegeproperty.php.html | 58,032 | 1/13/2009 |
| fsource_WebIRS_allocgorum2relativedate.php.html | 85,211 | 1/13/2009 |
| fsource_WebIRS_allocgorum2roll.php.html | 72,386 | 1/13/2009 |
| fsource_WebIRS_allocgorum2sqlparser.php.html | 559,835 | 1/13/2009 |
| fsource_WebIRS_allocgorum2stopwatch.php.html | 18,306 | 1/13/2009 |
| fsource_WebIRS_allocgorum2tools.php.html | 166,779 | 1/13/2009 |
| fsource_WebIRS_allocgorum2updatelib.php.html | 6,338 | 1/13/2009 |
| fsource_WebIRS_allocgorum2user_email.php.html | 182,694 | 1/13/2009 |
| fsource_WebIRS_allocgorum2user_high.php.html | 66,433 | 1/13/2009 |
| fsource_WebIRS_allocgorum2user_simple.php.html | 204,044 | 1/13/2009 |
| fsource_WebIRS_allocgorum2view.php.html | 47,739 | 1/13/2009 |
| fsource_WebIRS_allocgorum2xdebug.php.html | 5,292 | 1/13/2009 |
| fsource_WebIRS_allocgroup.php.html | 14,365 | 1/13/2009 |
| fsource_WebIRS_allochandlerhandler.php.html | 60,502 | 1/13/2009 |
| fsource_WebIRS_allochandlerhandler_artissue.php.html | 40,179 | 1/13/2009 |
| fsource_WebIRS_allochandlerhandler_expenseitem.php.html | 7,230 | 1/13/2009 |
| fsource_WebIRS_allochandlerhandler_issue.php.html | 59,129 | 1/13/2009 |
| fsource_WebIRS_allochandlerhandler_project.php.html | 6,601 | 1/13/2009 |
| fsource_WebIRS_allochandlerhandler_resaleitem.php.html | 3,022 | 1/13/2009 |
| fsource_WebIRS_allochandlerlog.php.html | 58,443 | 1/13/2009 |
| fsource_WebIRS_allochandlerlogaction.php.html | 58,708 | 1/13/2009 |
| fsource_WebIRS_allochandlerlogsubscription.php.html | 44,593 | 1/13/2009 |
| fsource_WebIRS_allochandlernotification.php.html | 227,737 | 1/13/2009 |
| fsource_WebIRS_allochandlernotifsubscription.php.html | 115,988 | 1/13/2009 |
| fsource_WebIRS_allocinclude.php.html | 21,107 | 1/13/2009 |
| fsource_WebIRS_allocindex.php.html | 4,368 | 1/13/2009 |
| fsource_WebIRS_allocinit.php.html | 202,061 | 1/13/2009 |
| fsource_WebIRS_allocitemlist.php.html | 40,742 | 1/13/2009 |
| fsource_WebIRS_allocjs_css_map.php.html | 16,887 | 1/13/2009 |
| fsource_WebIRS_allocmyform.php.html | 2,030 | 1/13/2009 |
| fsource_WebIRS_allocnote.php.html | 98,137 | 1/13/2009 |
| fsource_WebIRS_allocnotelist.php.html | 50,120 | 1/13/2009 |
| fsource_WebIRS_allocobject.php.html | 114,482 | 1/13/2009 |
| fsource_WebIRS_allocobjectnotelist.php.html | 33,178 | 1/13/2009 |
| fsource_WebIRS_allocperiod.php.html | 536,722 | 1/13/2009 |
| fsource_WebIRS_allocperiodlist.php.html | 34,460 | 1/13/2009 |
| fsource_WebIRS_allocpermconfig.js.php.html | 5,133 | 1/13/2009 |
| fsource_WebIRS_allocpermconfig.php.html | 103,566 | 1/13/2009 |
| fsource_WebIRS_allocpermission.php.html | 131,717 | 1/13/2009 |
| fsource_WebIRS_allocportal.php.html | 40,076 | 1/13/2009 |
| fsource_WebIRS_allocportalattr.php.html | 174,684 | 1/13/2009 |
| fsource_WebIRS_allocraritiesassignments.php.html | 2,013 | 1/13/2009 |
| fsource_WebIRS_allocraritiesbreadcrumb.php.html | 23,338 | 1/13/2009 |
| fsource_WebIRS_allocraritiescache.php.html | 7,325 | 1/13/2009 |
| fsource_WebIRS_allocraritiesclass.phpmailer.php.html | 411,349 | 1/13/2009 |
| fsource_WebIRS_allocraritiesclass.smtp.php.html | 241,276 | 1/13/2009 |
| fsource_WebIRS_allocraritiesclient.php.html | 66,585 | 1/13/2009 |
| fsource_WebIRS_allocraritiescomingsoon.php.html | 18,687 | 1/13/2009 |
| fsource_WebIRS_allocraritiesdisplayerror.php.html | 3,953 | 1/13/2009 |
| fsource_WebIRS_allocraritiesproxy.php.html | 3,384 | 1/13/2009 |
| fsource_WebIRS_allocraritiesrate.php.html | 93,460 | 1/13/2009 |
| fsource_WebIRS_allocraritiesrate_milage.php.html | 58,680 | 1/13/2009 |
| fsource_WebIRS_allocraritiesreadstate.php.html | 9,243 | 1/13/2009 |
| fsource_WebIRS_allocrecurringdistributeditemdef.php.html | 23,662 | 1/13/2009 |
| fsource_WebIRS_allocrecurringrecurringitemdef.php.html | 3,372 | 1/13/2009 |
| fsource_WebIRS_allocrecurringspecitem.php.html | 55,296 | 1/13/2009 |
| fsource_WebIRS_allocrecurringspecitemdef.php.html | 89,972 | 1/13/2009 |
| fsource_WebIRS_allocreportreport.php.html | 68,621 | 1/13/2009 |
| fsource_WebIRS_allocreportreport_category.php.html | 104,157 | 1/13/2009 |
| fsource_WebIRS_allocreportreport_employee.php.html | 71,763 | 1/13/2009 |
| fsource_WebIRS_allocreportreport_employeeactivity.php.html | 30,202 | 1/13/2009 |
| fsource_WebIRS_allocreportreport_item.php.html | 245,704 | 1/13/2009 |
| fsource_WebIRS_allocreportreport_payroll.php.html | 68,667 | 1/13/2009 |
| fsource_WebIRS_allocreportreport_vacation.php.html | 36,267 | 1/13/2009 |
| fsource_WebIRS_allocsearch.php.html | 104,110 | 1/13/2009 |
| fsource_WebIRS_allocsettings.php.html | 5,350 | 1/13/2009 |
| fsource_WebIRS_allocsmsclock.php.html | 5,876 | 1/13/2009 |
| fsource_WebIRS_alloctestauth.php.html | 1,870 | 1/13/2009 |
| fsource_WebIRS_allocupdate_items.php.html | 37,036 | 1/13/2009 |
| fsource_WebIRS_allocupdate_logs.php.html | 13,083 | 1/13/2009 |
| fsource_WebIRS_allocupdate_notes.php.html | 8,073 | 1/13/2009 |
| fsource_WebIRS_allocupdate_searches.php.html | 47,227 | 1/13/2009 |
| fsource_WebIRS_allocuser.php.html | 191,439 | 1/13/2009 |
| fsource_WebIRS_allocvacation.php.html | 76,197 | 1/13/2009 |
| fsource_WebIRS_allocvarfields.php.html | 191,489 | 1/13/2009 |
| fsource_WebIRS_allocversion.php.html | 62,890 | 1/13/2009 |
| fsource_WebIRS_allocxajax.php.html | 8,090 | 1/13/2009 |
| fsource_WebIRS_allocxajax_server.php.html | 140,336 | 1/13/2009 |
| fsource_WebIRS_gorum2adodb-time.php.html | 244,815 | 1/13/2009 |
| fsource_WebIRS_gorum2category.php.html | 95,906 | 1/13/2009 |
| fsource_WebIRS_gorum2changename.php.html | 15,807 | 1/13/2009 |
| fsource_WebIRS_gorum2charconvert.php.html | 6,958 | 1/13/2009 |
| fsource_WebIRS_gorum2constants.php.html | 43,755 | 1/13/2009 |
| fsource_WebIRS_gorum2date.php.html | 230,928 | 1/13/2009 |
| fsource_WebIRS_gorum2dbproperty.php.html | 128,654 | 1/13/2009 |
| fsource_WebIRS_gorum2dbtreeproperty.php.html | 38,281 | 1/13/2009 |
| fsource_WebIRS_gorum2firephpfb.php.html | 12,338 | 1/13/2009 |
| fsource_WebIRS_gorum2firephpFirePHP.class.php.html | 160,428 | 1/13/2009 |
| fsource_WebIRS_gorum2flood.php.html | 8,599 | 1/13/2009 |
| fsource_WebIRS_gorum2form.php.html | 10,600 | 1/13/2009 |
| fsource_WebIRS_gorum2g.php.html | 37,412 | 1/13/2009 |
| fsource_WebIRS_gorum2gorum.php.html | 22,845 | 1/13/2009 |
| fsource_WebIRS_gorum2gorumlib.php.html | 99,459 | 1/13/2009 |
| fsource_WebIRS_gorum2gorum_db.php.html | 16,576 | 1/13/2009 |
| fsource_WebIRS_gorum2hasmany.php.html | 60,121 | 1/13/2009 |
| fsource_WebIRS_gorum2htmllist.php.html | 47,558 | 1/13/2009 |
| fsource_WebIRS_gorum2imap.php.html | 10,473 | 1/13/2009 |
| fsource_WebIRS_gorum2init.php.html | 98,761 | 1/13/2009 |
| fsource_WebIRS_gorum2installlib.php.html | 188,770 | 1/13/2009 |
| fsource_WebIRS_gorum2javascript.php.html | 45,985 | 1/13/2009 |
| fsource_WebIRS_gorum2loginlib.php.html | 74,754 | 1/13/2009 |
| fsource_WebIRS_gorum2loginlib_high.php.html | 29,331 | 1/13/2009 |
| fsource_WebIRS_gorum2object.php.html | 288,075 | 1/13/2009 |
| fsource_WebIRS_gorum2presentationdeleteformpresentation.php.html | 20,469 | 1/13/2009 |
| fsource_WebIRS_gorum2presentationdetailspresentation.php.html | 21,488 | 1/13/2009 |
| fsource_WebIRS_gorum2presentationfilter.php.html | 15,728 | 1/13/2009 |
| fsource_WebIRS_gorum2presentationformpresentation.php.html | 228,371 | 1/13/2009 |
| fsource_WebIRS_gorum2presentationgenerdatewidget.php.html | 119,263 | 1/13/2009 |
| fsource_WebIRS_gorum2presentationgenervoicewidget.php.html | 14,976 | 1/13/2009 |
| fsource_WebIRS_gorum2presentationgenerwidget.php.html | 111,192 | 1/13/2009 |
| fsource_WebIRS_gorum2presentationlistpresentation.php.html | 70,568 | 1/13/2009 |
| fsource_WebIRS_gorum2presentationlllproperties.php.html | 23,823 | 1/13/2009 |
| fsource_WebIRS_gorum2presentationpresentation.php.html | 14,738 | 1/13/2009 |
| fsource_WebIRS_gorum2privilegeproperty.php.html | 58,024 | 1/13/2009 |
| fsource_WebIRS_gorum2relativedate.php.html | 85,203 | 1/13/2009 |
| fsource_WebIRS_gorum2roll.php.html | 72,378 | 1/13/2009 |
| fsource_WebIRS_gorum2sqlparser.php.html | 559,827 | 1/13/2009 |
| fsource_WebIRS_gorum2stopwatch.php.html | 18,298 | 1/13/2009 |
| fsource_WebIRS_gorum2tools.php.html | 168,009 | 1/13/2009 |
| fsource_WebIRS_gorum2updatelib.php.html | 6,330 | 1/13/2009 |
| fsource_WebIRS_gorum2user_email.php.html | 182,686 | 1/13/2009 |
| fsource_WebIRS_gorum2user_high.php.html | 66,425 | 1/13/2009 |
| fsource_WebIRS_gorum2user_simple.php.html | 204,036 | 1/13/2009 |
| fsource_WebIRS_gorum2view.php.html | 47,731 | 1/13/2009 |
| fsource_WebIRS_gorum2xdebug.php.html | 5,284 | 1/13/2009 |
| D:\webirs\webirs_source\phpdoc\HTMLframesConverter\phpdoc.de | | |
| blank.html | 381 | 1/13/2009 |
| classtrees_Savant2.html | 865 | 1/13/2009 |
| classtrees_WebIRS.html | 6,079 | 1/13/2009 |
| elementindex.html | 630,575 | 1/13/2009 |
| elementindex_Savant2.html | 21,852 | 1/13/2009 |
| elementindex_WebIRS.html | 614,182 | 1/13/2009 |
| errors.html | 196,905 | 1/13/2009 |
| index.html | 934 | 1/13/2009 |
| li_Savant2.html | 1,366 | 1/13/2009 |
| li_WebIRS.html | 58,134 | 1/13/2009 |
| packages.html | 1,246 | 1/13/2009 |
| D:\webirs\webirs_source\phpdoc\HTMLframesConverter\phpdoc.de\media | | |
| banner.css | 426 | 1/13/2009 |
| stylesheet.css | 5,605 | 1/13/2009 |
| D:\webirs\webirs_source\phpdoc\HTMLframesConverter\phpdoc.de\Savant2 | | |
| Savant2.html | 72,986 | 1/13/2009 |
| _alloc---gorum2---Savant2.php.html | 5,571 | 1/13/2009 |
| _gorum2---Savant2.php.html | 1,936 | 1/13/2009 |
| D:\webirs\webirs_source\phpdoc\HTMLframesConverter\phpdoc.de\WebIRS | | |
| AllocError.html | 3,961 | 1/13/2009 |
| AllocXajaxResponse.html | 8,507 | 1/13/2009 |
| AppCategory.html | 12,818 | 1/13/2009 |
| AppInit.html | 13,022 | 1/13/2009 |
| AppObject.html | 60,016 | 1/13/2009 |
| AppUser.html | 18,872 | 1/13/2009 |
| Article.html | 37,092 | 1/13/2009 |
| ArticleSearch.html | 19,969 | 1/13/2009 |
| ArticleSearchQuery.html | 8,634 | 1/13/2009 |
| ArtIssue.html | 37,389 | 1/13/2009 |
| ArtIssueHandler.html | 14,775 | 1/13/2009 |
| ArtIssueSearch.html | 33,116 | 1/13/2009 |
| ArtPrIssue.html | 75,441 | 1/13/2009 |
| Attach.html | 18,225 | 1/13/2009 |
| Breadcrumb.html | 4,545 | 1/13/2009 |
| Cache.html | 4,777 | 1/13/2009 |
| Category.html | 20,744 | 1/13/2009 |
| CategoryReport.html | 4,468 | 1/13/2009 |
| CharConvert.html | 5,833 | 1/13/2009 |
| Client.html | 12,373 | 1/13/2009 |
| ClientGroup.html | 4,575 | 1/13/2009 |
| Date.html | 90,989 | 1/13/2009 |
| DeleteFormPresentation.html | 4,518 | 1/13/2009 |
| DetailsPresentation.html | 6,298 | 1/13/2009 |
| DisplayError.html | 3,190 | 1/13/2009 |
| DistributedItemDef.html | 10,649 | 1/13/2009 |
| EmployeeActivityReport.html | 23,162 | 1/13/2009 |
| EmployeeReport.html | 4,469 | 1/13/2009 |
| ExpenseItem.html | 28,701 | 1/13/2009 |
| ExpenseItemHandler.html | 8,373 | 1/13/2009 |
| Filter.html | 10,861 | 1/13/2009 |
| FirePHP.html | 26,900 | 1/13/2009 |
| Flag.html | 15,287 | 1/13/2009 |
| Flood.html | 1,279 | 1/13/2009 |
| FormDisplayType.html | 6,045 | 1/13/2009 |
| FormPresentation.html | 55,049 | 1/13/2009 |
| G.html | 12,718 | 1/13/2009 |
| GenerDateWidget.html | 13,163 | 1/13/2009 |
| GenerVoiceWidget.html | 4,079 | 1/13/2009 |
| GenerWidget.html | 33,478 | 1/13/2009 |
| Handler.html | 20,576 | 1/13/2009 |
| HasMany.html | 15,030 | 1/13/2009 |
| HasManyAttrs.html | 8,861 | 1/13/2009 |
| HasManyWithLinkClass.html | 12,104 | 1/13/2009 |
| HasManyWithoutLinkClass.html | 14,860 | 1/13/2009 |
| Init.html | 19,692 | 1/13/2009 |
| Issue.html | 88,169 | 1/13/2009 |
| IssueHandler.html | 20,217 | 1/13/2009 |
| IssueListPresentation.html | 5,050 | 1/13/2009 |
| IssueSearch.html | 36,883 | 1/13/2009 |
| IssueSearchQuery.html | 49,829 | 1/13/2009 |
| Item.html | 47,412 | 1/13/2009 |
| ItemList.html | 8,619 | 1/13/2009 |
| ItemReport.html | 15,339 | 1/13/2009 |
| ItemSearch.html | 7,879 | 1/13/2009 |
| JavaScript.html | 27,670 | 1/13/2009 |
| Labor.html | 6,310 | 1/13/2009 |
| ListPresentation.html | 9,463 | 1/13/2009 |
| LllProperties.html | 16,299 | 1/13/2009 |
| Log.html | 18,211 | 1/13/2009 |
| LogAction.html | 10,961 | 1/13/2009 |
| LogSubscription.html | 21,735 | 1/13/2009 |
| MilageRate.html | 14,674 | 1/13/2009 |
| MilageReport.html | 29,259 | 1/13/2009 |
| Note.html | 32,568 | 1/13/2009 |
| NoteList.html | 9,349 | 1/13/2009 |
| Notif.html | 19,977 | 1/13/2009 |
| NotifSubscription.html | 33,005 | 1/13/2009 |
| Object.html | 74,720 | 1/13/2009 |
| ObjectNoteList.html | 10,838 | 1/13/2009 |
| PayrollReport.html | 6,242 | 1/13/2009 |
| Period.html | 66,673 | 1/13/2009 |
| PeriodList.html | 8,657 | 1/13/2009 |
| Perm.html | 57,758 | 1/13/2009 |
| PermGroup.html | 4,539 | 1/13/2009 |
| Permission.html | 25,605 | 1/13/2009 |
| PHPMailer.html | 65,383 | 1/13/2009 |
| Portal.html | 12,054 | 1/13/2009 |
| PortalAttr.html | 15,254 | 1/13/2009 |
| Presentation.html | 8,467 | 1/13/2009 |
| PriorityIndex.html | 9,661 | 1/13/2009 |
| PrIssueSearch.html | 33,113 | 1/13/2009 |
| Project.html | 47,124 | 1/13/2009 |
| ProjectHandler.html | 11,444 | 1/13/2009 |
| ProjectSearch.html | 21,572 | 1/13/2009 |
| ProjectSearchQuery.html | 24,612 | 1/13/2009 |
| Rate.html | 20,626 | 1/13/2009 |
| ReadState.html | 3,842 | 1/13/2009 |
| RecurringItemDef.html | 6,623 | 1/13/2009 |
| ReimbursableItem.html | 23,614 | 1/13/2009 |
| RelativeDate.html | 21,347 | 1/13/2009 |
| Report.html | 13,717 | 1/13/2009 |
| ResaleItem.html | 27,635 | 1/13/2009 |
| ResaleItemHandler.html | 7,050 | 1/13/2009 |
| Roll.html | 13,467 | 1/13/2009 |
| Search.html | 7,711 | 1/13/2009 |
| SearchQuery.html | 28,013 | 1/13/2009 |
| Settings.html | 1,275 | 1/13/2009 |
| SMTP.html | 32,816 | 1/13/2009 |
| SpecItem.html | 11,695 | 1/13/2009 |
| SpecItemDef.html | 20,625 | 1/13/2009 |
| Stopwatch.html | 5,018 | 1/13/2009 |
| User.html | 19,374 | 1/13/2009 |
| Vacation.html | 12,199 | 1/13/2009 |
| VacationReport.html | 4,469 | 1/13/2009 |
| VarFields.html | 9,789 | 1/13/2009 |
| Version.html | 10,152 | 1/13/2009 |
| View.html | 29,063 | 1/13/2009 |
| WorkReport.html | 23,975 | 1/13/2009 |
| _alloc---artissue---article.php.html | 2,855 | 1/13/2009 |
| _alloc---artissue---articlesearch.php.html | 2,909 | 1/13/2009 |
| _alloc---artissue---articlesearchquery.php.html | 2,005 | 1/13/2009 |
| _alloc---artissue---articlesearch_typ.php.html | 1,227 | 1/13/2009 |
| _alloc---artissue---article_typ.php.html | 1,209 | 1/13/2009 |
| _alloc---artissue---artissue.php.html | 1,955 | 1/13/2009 |
| _alloc---artissue---artissuesearch.php.html | 1,985 | 1/13/2009 |
| _alloc---artissue---artprissue.php.html | 4,116 | 1/13/2009 |
| _alloc---artissue---issue.php.html | 5,596 | 1/13/2009 |
| _alloc---artissue---issuelistpresentation.php.html | 2,020 | 1/13/2009 |
| _alloc---artissue---issuesearch.php.html | 2,890 | 1/13/2009 |
| _alloc---artissue---issuesearchquery.php.html | 1,995 | 1/13/2009 |
| _alloc---artissue---issuesearch_typ.php.html | 1,221 | 1/13/2009 |
| _alloc---artissue---issue_typ.php.html | 1,203 | 1/13/2009 |
| _alloc---artissue---priorityindex.php.html | 1,980 | 1/13/2009 |
| _alloc---artissue---prissuesearch.php.html | 4,280 | 1/13/2009 |
| _alloc---artissue---project.php.html | 2,855 | 1/13/2009 |
| _alloc---artissue---projectsearch.php.html | 2,909 | 1/13/2009 |
| _alloc---artissue---projectsearchquery.php.html | 2,005 | 1/13/2009 |
| _alloc---artissue---projectsearch_typ.php.html | 1,227 | 1/13/2009 |
| _alloc---artissue---project_typ.php.html | 1,209 | 1/13/2009 |
| _alloc---artissue---searchquery.php.html | 1,970 | 1/13/2009 |
| _alloc---attach.php.html | 1,928 | 1/13/2009 |
| _alloc---billableitem---expenseitem.php.html | 1,978 | 1/13/2009 |
| _alloc---billableitem---item.php.html | 1,943 | 1/13/2009 |
| _alloc---billableitem---itemsearch.php.html | 1,973 | 1/13/2009 |
| _alloc---billableitem---labor.php.html | 1,948 | 1/13/2009 |
| _alloc---billableitem---milagereport.php.html | 1,983 | 1/13/2009 |
| _alloc---billableitem---reimbursableitem.php.html | 2,003 | 1/13/2009 |
| _alloc---billableitem---resaleitem.php.html | 1,973 | 1/13/2009 |
| _alloc---billableitem---workreport.php.html | 1,973 | 1/13/2009 |
| _alloc---category.php.html | 1,944 | 1/13/2009 |
| _alloc---clientgroup.php.html | 1,953 | 1/13/2009 |
| _alloc---clock.php.html | 1,991 | 1/13/2009 |
| _alloc---combine.php.html | 4,957 | 1/13/2009 |
| _alloc---config.php.html | 1,177 | 1/13/2009 |
| _alloc---constants.php.html | 33,697 | 1/13/2009 |
| _alloc---createflag.php.html | 2,012 | 1/13/2009 |
| _alloc---cronjob.php.html | 2,928 | 1/13/2009 |
| _alloc---dokuwiki.php.html | 11,040 | 1/13/2009 |
| _alloc---error.php.html | 3,220 | 1/13/2009 |
| _alloc---flag.php.html | 1,918 | 1/13/2009 |
| _alloc---get_css.php.html | 4,074 | 1/13/2009 |
| _alloc---get_js.php.html | 2,846 | 1/13/2009 |
| _alloc---gorum2---adodb-time.php.html | 17,132 | 1/13/2009 |
| _alloc---gorum2---category.php.html | 2,916 | 1/13/2009 |
| _alloc---gorum2---changename.php.html | 1,202 | 1/13/2009 |
| _alloc---gorum2---charconvert.php.html | 1,966 | 1/13/2009 |
| _alloc---gorum2---constants.php.html | 22,384 | 1/13/2009 |
| _alloc---gorum2---date.php.html | 1,931 | 1/13/2009 |
| _alloc---gorum2---dbproperty.php.html | 20,500 | 1/13/2009 |
| _alloc---gorum2---dbtreeproperty.php.html | 10,857 | 1/13/2009 |
| _alloc---gorum2---flood.php.html | 3,053 | 1/13/2009 |
| _alloc---gorum2---form.php.html | 1,953 | 1/13/2009 |
| _alloc---gorum2---g.php.html | 1,916 | 1/13/2009 |
| _alloc---gorum2---gorum.php.html | 22,436 | 1/13/2009 |
| _alloc---gorum2---gorumlib.php.html | 17,283 | 1/13/2009 |
| _alloc---gorum2---gorum_db.php.html | 8,824 | 1/13/2009 |
| _alloc---gorum2---hasmany.php.html | 2,557 | 1/13/2009 |
| _alloc---gorum2---htmllist.php.html | 5,414 | 1/13/2009 |
| _alloc---gorum2---imap.php.html | 2,608 | 1/13/2009 |
| _alloc---gorum2---init.php.html | 3,359 | 1/13/2009 |
| _alloc---gorum2---installlib.php.html | 14,393 | 1/13/2009 |
| _alloc---gorum2---javascript.php.html | 1,961 | 1/13/2009 |
| _alloc---gorum2---loginlib.php.html | 5,344 | 1/13/2009 |
| _alloc---gorum2---loginlib_high.php.html | 1,211 | 1/13/2009 |
| _alloc---gorum2---object.php.html | 1,941 | 1/13/2009 |
| _alloc---gorum2---presentation---deleteformpresentation.php.html | 2,046 | 1/13/2009 |
| _alloc---gorum2---presentation---detailspresentation.php.html | 2,031 | 1/13/2009 |
| _alloc---gorum2---presentation---filter.php.html | 1,966 | 1/13/2009 |
| _alloc---gorum2---presentation---formpresentation.php.html | 2,016 | 1/13/2009 |
| _alloc---gorum2---presentation---generdatewidget.php.html | 2,011 | 1/13/2009 |
| _alloc---gorum2---presentation---genervoicewidget.php.html | 2,016 | 1/13/2009 |
| _alloc---gorum2---presentation---generwidget.php.html | 1,991 | 1/13/2009 |
| _alloc---gorum2---presentation---listpresentation.php.html | 2,016 | 1/13/2009 |
| _alloc---gorum2---presentation---lllproperties.php.html | 2,001 | 1/13/2009 |
| _alloc---gorum2---presentation---presentation.php.html | 1,996 | 1/13/2009 |
| _alloc---gorum2---privilegeproperty.php.html | 9,435 | 1/13/2009 |
| _alloc---gorum2---relativedate.php.html | 2,861 | 1/13/2009 |
| _alloc---gorum2---roll.php.html | 4,768 | 1/13/2009 |
| _alloc---gorum2---sqlparser.php.html | 27,765 | 1/13/2009 |
| _alloc---gorum2---stopwatch.php.html | 1,956 | 1/13/2009 |
| _alloc---gorum2---tools.php.html | 11,427 | 1/13/2009 |
| _alloc---gorum2---updatelib.php.html | 2,927 | 1/13/2009 |
| _alloc---gorum2---user_email.php.html | 1,949 | 1/13/2009 |
| _alloc---gorum2---user_high.php.html | 1,908 | 1/13/2009 |
| _alloc---gorum2---user_simple.php.html | 3,561 | 1/13/2009 |
| _alloc---gorum2---view.php.html | 1,931 | 1/13/2009 |
| _alloc---gorum2---xdebug.php.html | 2,798 | 1/13/2009 |
| _alloc---group.php.html | 1,931 | 1/13/2009 |
| _alloc---handler---handler.php.html | 1,948 | 1/13/2009 |
| _alloc---handler---handler_artissue.php.html | 1,991 | 1/13/2009 |
| _alloc---handler---handler_expenseitem.php.html | 2,006 | 1/13/2009 |
| _alloc---handler---handler_issue.php.html | 1,976 | 1/13/2009 |
| _alloc---handler---handler_project.php.html | 1,986 | 1/13/2009 |
| _alloc---handler---handler_resaleitem.php.html | 2,001 | 1/13/2009 |
| _alloc---handler---log.php.html | 1,928 | 1/13/2009 |
| _alloc---handler---logaction.php.html | 1,958 | 1/13/2009 |
| _alloc---handler---logsubscription.php.html | 1,988 | 1/13/2009 |
| _alloc---handler---notification.php.html | 3,125 | 1/13/2009 |
| _alloc---handler---notifsubscription.php.html | 1,998 | 1/13/2009 |
| _alloc---include.php.html | 39,707 | 1/13/2009 |
| _alloc---index.php.html | 3,744 | 1/13/2009 |
| _alloc---init.php.html | 6,493 | 1/13/2009 |
| _alloc---itemlist.php.html | 1,938 | 1/13/2009 |
| _alloc---js_css_map.php.html | 1,189 | 1/13/2009 |
| _alloc---myform.php.html | 1,995 | 1/13/2009 |
| _alloc---note.php.html | 1,918 | 1/13/2009 |
| _alloc---notelist.php.html | 1,938 | 1/13/2009 |
| _alloc---object.php.html | 1,934 | 1/13/2009 |
| _alloc---objectnotelist.php.html | 1,968 | 1/13/2009 |
| _alloc---period.php.html | 3,120 | 1/13/2009 |
| _alloc---periodlist.php.html | 1,948 | 1/13/2009 |
| _alloc---permconfig.js.php.html | 3,477 | 1/13/2009 |
| _alloc---permconfig.php.html | 1,936 | 1/13/2009 |
| _alloc---permission.php.html | 3,278 | 1/13/2009 |
| _alloc---portal.php.html | 1,928 | 1/13/2009 |
| _alloc---portalattr.php.html | 3,098 | 1/13/2009 |
| _alloc---rarities---assignments.php.html | 1,209 | 1/13/2009 |
| _alloc---rarities---breadcrumb.php.html | 1,965 | 1/13/2009 |
| _alloc---rarities---cache.php.html | 1,940 | 1/13/2009 |
| _alloc---rarities---class.phpmailer.php.html | 1,978 | 1/13/2009 |
| _alloc---rarities---class.smtp.php.html | 1,953 | 1/13/2009 |
| _alloc---rarities---client.php.html | 1,945 | 1/13/2009 |
| _alloc---rarities---comingsoon.php.html | 1,206 | 1/13/2009 |
| _alloc---rarities---displayerror.php.html | 1,975 | 1/13/2009 |
| _alloc---rarities---proxy.php.html | 1,191 | 1/13/2009 |
| _alloc---rarities---rate.php.html | 1,935 | 1/13/2009 |
| _alloc---rarities---rate_milage.php.html | 1,968 | 1/13/2009 |
| _alloc---rarities---readstate.php.html | 3,478 | 1/13/2009 |
| _alloc---recurring---distributeditemdef.php.html | 2,935 | 1/13/2009 |
| _alloc---recurring---recurringitemdef.php.html | 1,997 | 1/13/2009 |
| _alloc---recurring---specitem.php.html | 1,957 | 1/13/2009 |
| _alloc---recurring---specitemdef.php.html | 1,972 | 1/13/2009 |
| _alloc---report---report.php.html | 1,941 | 1/13/2009 |
| _alloc---report---report_category.php.html | 1,984 | 1/13/2009 |
| _alloc---report---report_employee.php.html | 4,519 | 1/13/2009 |
| _alloc---report---report_employeeactivity.php.html | 2,024 | 1/13/2009 |
| _alloc---report---report_item.php.html | 3,278 | 1/13/2009 |
| _alloc---report---report_payroll.php.html | 1,979 | 1/13/2009 |
| _alloc---report---report_vacation.php.html | 1,984 | 1/13/2009 |
| _alloc---search.php.html | 1,928 | 1/13/2009 |
| _alloc---settings.php.html | 1,938 | 1/13/2009 |
| _alloc---smsclock.php.html | 3,367 | 1/13/2009 |
| _alloc---testauth.php.html | 1,183 | 1/13/2009 |
| _alloc---update_items.php.html | 3,354 | 1/13/2009 |
| _alloc---update_logs.php.html | 3,347 | 1/13/2009 |
| _alloc---update_notes.php.html | 3,354 | 1/13/2009 |
| _alloc---update_searches.php.html | 3,375 | 1/13/2009 |
| _alloc---user.php.html | 1,924 | 1/13/2009 |
| _alloc---vacation.php.html | 1,938 | 1/13/2009 |
| _alloc---varfields.php.html | 4,162 | 1/13/2009 |
| _alloc---version.php.html | 1,933 | 1/13/2009 |
| _alloc---xajax.php.html | 2,786 | 1/13/2009 |
| _alloc---xajax_server.php.html | 36,596 | 1/13/2009 |
| _gorum2---adodb-time.php.html | 1,191 | 1/13/2009 |
| _gorum2---category.php.html | 1,894 | 1/13/2009 |
| _gorum2---changename.php.html | 1,191 | 1/13/2009 |
| _gorum2---charconvert.php.html | 1,903 | 1/13/2009 |
| _gorum2---constants.php.html | 1,188 | 1/13/2009 |
| _gorum2---date.php.html | 1,882 | 1/13/2009 |
| _gorum2---dbproperty.php.html | 1,191 | 1/13/2009 |
| _gorum2---dbtreeproperty.php.html | 1,203 | 1/13/2009 |
| _gorum2---firephp---fb.php.html | 3,721 | 1/13/2009 |
| _gorum2---firephp---FirePHP.class.php.html | 2,022 | 1/13/2009 |
| _gorum2---flood.php.html | 1,885 | 1/13/2009 |
| _gorum2---form.php.html | 1,882 | 1/13/2009 |
| _gorum2---g.php.html | 1,873 | 1/13/2009 |
| _gorum2---gorum.php.html | 15,214 | 1/13/2009 |
| _gorum2---gorumlib.php.html | 1,185 | 1/13/2009 |
| _gorum2---gorum_db.php.html | 8,729 | 1/13/2009 |
| _gorum2---hasmany.php.html | 2,302 | 1/13/2009 |
| _gorum2---htmllist.php.html | 1,185 | 1/13/2009 |
| _gorum2---imap.php.html | 1,173 | 1/13/2009 |
| _gorum2---init.php.html | 1,882 | 1/13/2009 |
| _gorum2---installlib.php.html | 1,191 | 1/13/2009 |
| _gorum2---javascript.php.html | 1,900 | 1/13/2009 |
| _gorum2---loginlib.php.html | 1,185 | 1/13/2009 |
| _gorum2---loginlib_high.php.html | 1,200 | 1/13/2009 |
| _gorum2---object.php.html | 1,888 | 1/13/2009 |
| _gorum2---presentation---deleteformpresentation.php.html | 1,961 | 1/13/2009 |
| _gorum2---presentation---detailspresentation.php.html | 1,952 | 1/13/2009 |
| _gorum2---presentation---filter.php.html | 1,913 | 1/13/2009 |
| _gorum2---presentation---formpresentation.php.html | 1,943 | 1/13/2009 |
| _gorum2---presentation---generdatewidget.php.html | 1,940 | 1/13/2009 |
| _gorum2---presentation---genervoicewidget.php.html | 1,943 | 1/13/2009 |
| _gorum2---presentation---generwidget.php.html | 1,928 | 1/13/2009 |
| _gorum2---presentation---listpresentation.php.html | 1,943 | 1/13/2009 |
| _gorum2---presentation---lllproperties.php.html | 1,934 | 1/13/2009 |
| _gorum2---presentation---presentation.php.html | 1,931 | 1/13/2009 |
| _gorum2---privilegeproperty.php.html | 1,212 | 1/13/2009 |
| _gorum2---relativedate.php.html | 2,782 | 1/13/2009 |
| _gorum2---roll.php.html | 1,882 | 1/13/2009 |
| _gorum2---sqlparser.php.html | 1,188 | 1/13/2009 |
| _gorum2---stopwatch.php.html | 1,897 | 1/13/2009 |
| _gorum2---tools.php.html | 1,176 | 1/13/2009 |
| _gorum2---updatelib.php.html | 1,188 | 1/13/2009 |
| _gorum2---user_email.php.html | 1,900 | 1/13/2009 |
| _gorum2---user_high.php.html | 1,897 | 1/13/2009 |
| _gorum2---user_simple.php.html | 1,903 | 1/13/2009 |
| _gorum2---view.php.html | 1,882 | 1/13/2009 |
| _gorum2---xdebug.php.html | 1,179 | 1/13/2009 |
| D:\webirs\webirs_source\phpdoc\HTMLframesConverter\phpdoc.de\_filesource | | |
| fsource_Savant2_allocgorum2Savant2.php.html | 352,428 | 1/13/2009 |
| fsource_Savant2_gorum2Savant2.php.html | 352,420 | 1/13/2009 |
| fsource_WebIRS_allocartissuearticle.php.html | 43,588 | 1/13/2009 |
| fsource_WebIRS_allocartissuearticlesearch.php.html | 29,101 | 1/13/2009 |
| fsource_WebIRS_allocartissuearticlesearchquery.php.html | 5,863 | 1/13/2009 |
| fsource_WebIRS_allocartissuearticlesearch_typ.php.html | 73,796 | 1/13/2009 |
| fsource_WebIRS_allocartissuearticle_typ.php.html | 77,210 | 1/13/2009 |
| fsource_WebIRS_allocartissueartissue.php.html | 127,919 | 1/13/2009 |
| fsource_WebIRS_allocartissueartissuesearch.php.html | 74,588 | 1/13/2009 |
| fsource_WebIRS_allocartissueartprissue.php.html | 279,897 | 1/13/2009 |
| fsource_WebIRS_allocartissueissue.php.html | 578,428 | 1/13/2009 |
| fsource_WebIRS_allocartissueissuelistpresentation.php.html | 113,725 | 1/13/2009 |
| fsource_WebIRS_allocartissueissuesearch.php.html | 185,783 | 1/13/2009 |
| fsource_WebIRS_allocartissueissuesearchquery.php.html | 163,230 | 1/13/2009 |
| fsource_WebIRS_allocartissueissuesearch_typ.php.html | 159,475 | 1/13/2009 |
| fsource_WebIRS_allocartissueissue_typ.php.html | 238,532 | 1/13/2009 |
| fsource_WebIRS_allocartissuepriorityindex.php.html | 29,458 | 1/13/2009 |
| fsource_WebIRS_allocartissueprissuesearch.php.html | 175,795 | 1/13/2009 |
| fsource_WebIRS_allocartissueproject.php.html | 92,475 | 1/13/2009 |
| fsource_WebIRS_allocartissueprojectsearch.php.html | 32,481 | 1/13/2009 |
| fsource_WebIRS_allocartissueprojectsearchquery.php.html | 19,674 | 1/13/2009 |
| fsource_WebIRS_allocartissueprojectsearch_typ.php.html | 90,790 | 1/13/2009 |
| fsource_WebIRS_allocartissueproject_typ.php.html | 93,193 | 1/13/2009 |
| fsource_WebIRS_allocartissuesearchquery.php.html | 87,777 | 1/13/2009 |
| fsource_WebIRS_allocattach.php.html | 125,091 | 1/13/2009 |
| fsource_WebIRS_allocbillableitemexpenseitem.php.html | 75,356 | 1/13/2009 |
| fsource_WebIRS_allocbillableitemitem.php.html | 220,694 | 1/13/2009 |
| fsource_WebIRS_allocbillableitemitemsearch.php.html | 81,265 | 1/13/2009 |
| fsource_WebIRS_allocbillableitemlabor.php.html | 27,894 | 1/13/2009 |
| fsource_WebIRS_allocbillableitemmilagereport.php.html | 45,802 | 1/13/2009 |
| fsource_WebIRS_allocbillableitemreimbursableitem.php.html | 9,000 | 1/13/2009 |
| fsource_WebIRS_allocbillableitemresaleitem.php.html | 54,657 | 1/13/2009 |
| fsource_WebIRS_allocbillableitemworkreport.php.html | 57,086 | 1/13/2009 |
| fsource_WebIRS_alloccategory.php.html | 58,765 | 1/13/2009 |
| fsource_WebIRS_allocclientgroup.php.html | 14,096 | 1/13/2009 |
| fsource_WebIRS_allocclock.php.html | 2,113 | 1/13/2009 |
| fsource_WebIRS_alloccombine.php.html | 40,125 | 1/13/2009 |
| fsource_WebIRS_allocconfig.php.html | 6,357 | 1/13/2009 |
| fsource_WebIRS_allocconstants.php.html | 80,905 | 1/13/2009 |
| fsource_WebIRS_alloccreateflag.php.html | 1,847 | 1/13/2009 |
| fsource_WebIRS_alloccronjob.php.html | 4,591 | 1/13/2009 |
| fsource_WebIRS_allocdokuwiki.php.html | 110,322 | 1/13/2009 |
| fsource_WebIRS_allocerror.php.html | 20,714 | 1/13/2009 |
| fsource_WebIRS_allocflag.php.html | 113,918 | 1/13/2009 |
| fsource_WebIRS_allocget_css.php.html | 16,373 | 1/13/2009 |
| fsource_WebIRS_allocget_js.php.html | 10,322 | 1/13/2009 |
| fsource_WebIRS_allocgorum2adodb-time.php.html | 244,820 | 1/13/2009 |
| fsource_WebIRS_allocgorum2category.php.html | 95,911 | 1/13/2009 |
| fsource_WebIRS_allocgorum2changename.php.html | 15,812 | 1/13/2009 |
| fsource_WebIRS_allocgorum2charconvert.php.html | 6,963 | 1/13/2009 |
| fsource_WebIRS_allocgorum2constants.php.html | 43,419 | 1/13/2009 |
| fsource_WebIRS_allocgorum2date.php.html | 228,961 | 1/13/2009 |
| fsource_WebIRS_allocgorum2dbproperty.php.html | 128,659 | 1/13/2009 |
| fsource_WebIRS_allocgorum2dbtreeproperty.php.html | 38,286 | 1/13/2009 |
| fsource_WebIRS_allocgorum2flood.php.html | 8,604 | 1/13/2009 |
| fsource_WebIRS_allocgorum2form.php.html | 10,605 | 1/13/2009 |
| fsource_WebIRS_allocgorum2g.php.html | 37,417 | 1/13/2009 |
| fsource_WebIRS_allocgorum2gorum.php.html | 22,850 | 1/13/2009 |
| fsource_WebIRS_allocgorum2gorumlib.php.html | 99,464 | 1/13/2009 |
| fsource_WebIRS_allocgorum2gorum_db.php.html | 16,581 | 1/13/2009 |
| fsource_WebIRS_allocgorum2hasmany.php.html | 60,126 | 1/13/2009 |
| fsource_WebIRS_allocgorum2htmllist.php.html | 47,563 | 1/13/2009 |
| fsource_WebIRS_allocgorum2imap.php.html | 10,478 | 1/13/2009 |
| fsource_WebIRS_allocgorum2init.php.html | 98,766 | 1/13/2009 |
| fsource_WebIRS_allocgorum2installlib.php.html | 188,775 | 1/13/2009 |
| fsource_WebIRS_allocgorum2javascript.php.html | 45,990 | 1/13/2009 |
| fsource_WebIRS_allocgorum2loginlib.php.html | 74,759 | 1/13/2009 |
| fsource_WebIRS_allocgorum2loginlib_high.php.html | 29,336 | 1/13/2009 |
| fsource_WebIRS_allocgorum2object.php.html | 288,080 | 1/13/2009 |
| fsource_WebIRS_allocgorum2presentationdeleteformpresentation.php.html | 20,474 | 1/13/2009 |
| fsource_WebIRS_allocgorum2presentationdetailspresentation.php.html | 21,493 | 1/13/2009 |
| fsource_WebIRS_allocgorum2presentationfilter.php.html | 15,733 | 1/13/2009 |
| fsource_WebIRS_allocgorum2presentationformpresentation.php.html | 225,756 | 1/13/2009 |
| fsource_WebIRS_allocgorum2presentationgenerdatewidget.php.html | 119,268 | 1/13/2009 |
| fsource_WebIRS_allocgorum2presentationgenervoicewidget.php.html | 14,981 | 1/13/2009 |
| fsource_WebIRS_allocgorum2presentationgenerwidget.php.html | 107,568 | 1/13/2009 |
| fsource_WebIRS_allocgorum2presentationlistpresentation.php.html | 70,573 | 1/13/2009 |
| fsource_WebIRS_allocgorum2presentationlllproperties.php.html | 23,828 | 1/13/2009 |
| fsource_WebIRS_allocgorum2presentationpresentation.php.html | 14,743 | 1/13/2009 |
| fsource_WebIRS_allocgorum2privilegeproperty.php.html | 58,029 | 1/13/2009 |
| fsource_WebIRS_allocgorum2relativedate.php.html | 85,208 | 1/13/2009 |
| fsource_WebIRS_allocgorum2roll.php.html | 72,383 | 1/13/2009 |
| fsource_WebIRS_allocgorum2sqlparser.php.html | 559,832 | 1/13/2009 |
| fsource_WebIRS_allocgorum2stopwatch.php.html | 18,303 | 1/13/2009 |
| fsource_WebIRS_allocgorum2tools.php.html | 166,776 | 1/13/2009 |
| fsource_WebIRS_allocgorum2updatelib.php.html | 6,335 | 1/13/2009 |
| fsource_WebIRS_allocgorum2user_email.php.html | 182,691 | 1/13/2009 |
| fsource_WebIRS_allocgorum2user_high.php.html | 66,430 | 1/13/2009 |
| fsource_WebIRS_allocgorum2user_simple.php.html | 204,041 | 1/13/2009 |
| fsource_WebIRS_allocgorum2view.php.html | 47,736 | 1/13/2009 |
| fsource_WebIRS_allocgorum2xdebug.php.html | 5,289 | 1/13/2009 |
| fsource_WebIRS_allocgroup.php.html | 14,362 | 1/13/2009 |
| fsource_WebIRS_allochandlerhandler.php.html | 60,499 | 1/13/2009 |
| fsource_WebIRS_allochandlerhandler_artissue.php.html | 40,176 | 1/13/2009 |
| fsource_WebIRS_allochandlerhandler_expenseitem.php.html | 7,227 | 1/13/2009 |
| fsource_WebIRS_allochandlerhandler_issue.php.html | 59,126 | 1/13/2009 |
| fsource_WebIRS_allochandlerhandler_project.php.html | 6,598 | 1/13/2009 |
| fsource_WebIRS_allochandlerhandler_resaleitem.php.html | 3,019 | 1/13/2009 |
| fsource_WebIRS_allochandlerlog.php.html | 58,440 | 1/13/2009 |
| fsource_WebIRS_allochandlerlogaction.php.html | 58,705 | 1/13/2009 |
| fsource_WebIRS_allochandlerlogsubscription.php.html | 44,590 | 1/13/2009 |
| fsource_WebIRS_allochandlernotification.php.html | 227,734 | 1/13/2009 |
| fsource_WebIRS_allochandlernotifsubscription.php.html | 115,985 | 1/13/2009 |
| fsource_WebIRS_allocinclude.php.html | 21,104 | 1/13/2009 |
| fsource_WebIRS_allocindex.php.html | 4,365 | 1/13/2009 |
| fsource_WebIRS_allocinit.php.html | 202,058 | 1/13/2009 |
| fsource_WebIRS_allocitemlist.php.html | 40,739 | 1/13/2009 |
| fsource_WebIRS_allocjs_css_map.php.html | 16,884 | 1/13/2009 |
| fsource_WebIRS_allocmyform.php.html | 2,027 | 1/13/2009 |
| fsource_WebIRS_allocnote.php.html | 98,134 | 1/13/2009 |
| fsource_WebIRS_allocnotelist.php.html | 50,117 | 1/13/2009 |
| fsource_WebIRS_allocobject.php.html | 114,479 | 1/13/2009 |
| fsource_WebIRS_allocobjectnotelist.php.html | 33,175 | 1/13/2009 |
| fsource_WebIRS_allocperiod.php.html | 536,719 | 1/13/2009 |
| fsource_WebIRS_allocperiodlist.php.html | 34,457 | 1/13/2009 |
| fsource_WebIRS_allocpermconfig.js.php.html | 5,130 | 1/13/2009 |
| fsource_WebIRS_allocpermconfig.php.html | 103,563 | 1/13/2009 |
| fsource_WebIRS_allocpermission.php.html | 131,714 | 1/13/2009 |
| fsource_WebIRS_allocportal.php.html | 40,073 | 1/13/2009 |
| fsource_WebIRS_allocportalattr.php.html | 174,681 | 1/13/2009 |
| fsource_WebIRS_allocraritiesassignments.php.html | 2,010 | 1/13/2009 |
| fsource_WebIRS_allocraritiesbreadcrumb.php.html | 23,335 | 1/13/2009 |
| fsource_WebIRS_allocraritiescache.php.html | 7,322 | 1/13/2009 |
| fsource_WebIRS_allocraritiesclass.phpmailer.php.html | 411,346 | 1/13/2009 |
| fsource_WebIRS_allocraritiesclass.smtp.php.html | 241,273 | 1/13/2009 |
| fsource_WebIRS_allocraritiesclient.php.html | 66,582 | 1/13/2009 |
| fsource_WebIRS_allocraritiescomingsoon.php.html | 18,684 | 1/13/2009 |
| fsource_WebIRS_allocraritiesdisplayerror.php.html | 3,950 | 1/13/2009 |
| fsource_WebIRS_allocraritiesproxy.php.html | 3,381 | 1/13/2009 |
| fsource_WebIRS_allocraritiesrate.php.html | 93,457 | 1/13/2009 |
| fsource_WebIRS_allocraritiesrate_milage.php.html | 58,677 | 1/13/2009 |
| fsource_WebIRS_allocraritiesreadstate.php.html | 9,240 | 1/13/2009 |
| fsource_WebIRS_allocrecurringdistributeditemdef.php.html | 23,659 | 1/13/2009 |
| fsource_WebIRS_allocrecurringrecurringitemdef.php.html | 3,369 | 1/13/2009 |
| fsource_WebIRS_allocrecurringspecitem.php.html | 55,293 | 1/13/2009 |
| fsource_WebIRS_allocrecurringspecitemdef.php.html | 89,969 | 1/13/2009 |
| fsource_WebIRS_allocreportreport.php.html | 68,618 | 1/13/2009 |
| fsource_WebIRS_allocreportreport_category.php.html | 104,154 | 1/13/2009 |
| fsource_WebIRS_allocreportreport_employee.php.html | 71,760 | 1/13/2009 |
| fsource_WebIRS_allocreportreport_employeeactivity.php.html | 30,199 | 1/13/2009 |
| fsource_WebIRS_allocreportreport_item.php.html | 245,701 | 1/13/2009 |
| fsource_WebIRS_allocreportreport_payroll.php.html | 68,664 | 1/13/2009 |
| fsource_WebIRS_allocreportreport_vacation.php.html | 36,264 | 1/13/2009 |
| fsource_WebIRS_allocsearch.php.html | 104,107 | 1/13/2009 |
| fsource_WebIRS_allocsettings.php.html | 5,347 | 1/13/2009 |
| fsource_WebIRS_allocsmsclock.php.html | 5,873 | 1/13/2009 |
| fsource_WebIRS_alloctestauth.php.html | 1,867 | 1/13/2009 |
| fsource_WebIRS_allocupdate_items.php.html | 37,033 | 1/13/2009 |
| fsource_WebIRS_allocupdate_logs.php.html | 13,080 | 1/13/2009 |
| fsource_WebIRS_allocupdate_notes.php.html | 8,070 | 1/13/2009 |
| fsource_WebIRS_allocupdate_searches.php.html | 47,224 | 1/13/2009 |
| fsource_WebIRS_allocuser.php.html | 191,436 | 1/13/2009 |
| fsource_WebIRS_allocvacation.php.html | 76,194 | 1/13/2009 |
| fsource_WebIRS_allocvarfields.php.html | 191,486 | 1/13/2009 |
| fsource_WebIRS_allocversion.php.html | 62,887 | 1/13/2009 |
| fsource_WebIRS_allocxajax.php.html | 8,087 | 1/13/2009 |
| fsource_WebIRS_allocxajax_server.php.html | 140,333 | 1/13/2009 |
| fsource_WebIRS_gorum2adodb-time.php.html | 244,812 | 1/13/2009 |
| fsource_WebIRS_gorum2category.php.html | 95,903 | 1/13/2009 |
| fsource_WebIRS_gorum2changename.php.html | 15,804 | 1/13/2009 |
| fsource_WebIRS_gorum2charconvert.php.html | 6,955 | 1/13/2009 |
| fsource_WebIRS_gorum2constants.php.html | 43,752 | 1/13/2009 |
| fsource_WebIRS_gorum2date.php.html | 230,925 | 1/13/2009 |
| fsource_WebIRS_gorum2dbproperty.php.html | 128,651 | 1/13/2009 |
| fsource_WebIRS_gorum2dbtreeproperty.php.html | 38,278 | 1/13/2009 |
| fsource_WebIRS_gorum2firephpfb.php.html | 12,335 | 1/13/2009 |
| fsource_WebIRS_gorum2firephpFirePHP.class.php.html | 160,425 | 1/13/2009 |
| fsource_WebIRS_gorum2flood.php.html | 8,596 | 1/13/2009 |
| fsource_WebIRS_gorum2form.php.html | 10,597 | 1/13/2009 |
| fsource_WebIRS_gorum2g.php.html | 37,409 | 1/13/2009 |
| fsource_WebIRS_gorum2gorum.php.html | 22,842 | 1/13/2009 |
| fsource_WebIRS_gorum2gorumlib.php.html | 99,456 | 1/13/2009 |
| fsource_WebIRS_gorum2gorum_db.php.html | 16,573 | 1/13/2009 |
| fsource_WebIRS_gorum2hasmany.php.html | 60,118 | 1/13/2009 |
| fsource_WebIRS_gorum2htmllist.php.html | 47,555 | 1/13/2009 |
| fsource_WebIRS_gorum2imap.php.html | 10,470 | 1/13/2009 |
| fsource_WebIRS_gorum2init.php.html | 98,758 | 1/13/2009 |
| fsource_WebIRS_gorum2installlib.php.html | 188,767 | 1/13/2009 |
| fsource_WebIRS_gorum2javascript.php.html | 45,982 | 1/13/2009 |
| fsource_WebIRS_gorum2loginlib.php.html | 74,751 | 1/13/2009 |
| fsource_WebIRS_gorum2loginlib_high.php.html | 29,328 | 1/13/2009 |
| fsource_WebIRS_gorum2object.php.html | 288,072 | 1/13/2009 |
| fsource_WebIRS_gorum2presentationdeleteformpresentation.php.html | 20,466 | 1/13/2009 |
| fsource_WebIRS_gorum2presentationdetailspresentation.php.html | 21,485 | 1/13/2009 |
| fsource_WebIRS_gorum2presentationfilter.php.html | 15,725 | 1/13/2009 |
| fsource_WebIRS_gorum2presentationformpresentation.php.html | 228,368 | 1/13/2009 |
| fsource_WebIRS_gorum2presentationgenerdatewidget.php.html | 119,260 | 1/13/2009 |
| fsource_WebIRS_gorum2presentationgenervoicewidget.php.html | 14,973 | 1/13/2009 |
| fsource_WebIRS_gorum2presentationgenerwidget.php.html | 111,189 | 1/13/2009 |
| fsource_WebIRS_gorum2presentationlistpresentation.php.html | 70,565 | 1/13/2009 |
| fsource_WebIRS_gorum2presentationlllproperties.php.html | 23,820 | 1/13/2009 |
| fsource_WebIRS_gorum2presentationpresentation.php.html | 14,735 | 1/13/2009 |
| fsource_WebIRS_gorum2privilegeproperty.php.html | 58,021 | 1/13/2009 |
| fsource_WebIRS_gorum2relativedate.php.html | 85,200 | 1/13/2009 |
| fsource_WebIRS_gorum2roll.php.html | 72,375 | 1/13/2009 |
| fsource_WebIRS_gorum2sqlparser.php.html | 559,824 | 1/13/2009 |
| fsource_WebIRS_gorum2stopwatch.php.html | 18,295 | 1/13/2009 |
| fsource_WebIRS_gorum2tools.php.html | 168,006 | 1/13/2009 |
| fsource_WebIRS_gorum2updatelib.php.html | 6,327 | 1/13/2009 |
| fsource_WebIRS_gorum2user_email.php.html | 182,683 | 1/13/2009 |
| fsource_WebIRS_gorum2user_high.php.html | 66,422 | 1/13/2009 |
| fsource_WebIRS_gorum2user_simple.php.html | 204,033 | 1/13/2009 |
| fsource_WebIRS_gorum2view.php.html | 47,728 | 1/13/2009 |
| fsource_WebIRS_gorum2xdebug.php.html | 5,281 | 1/13/2009 |
| D:\webirs\webirs_source\phpdoc\HTMLframesConverter\phphtmllib | | |
| blank.html | 381 | 1/13/2009 |
| classtrees_Savant2.html | 865 | 1/13/2009 |
| classtrees_WebIRS.html | 6,079 | 1/13/2009 |
| elementindex.html | 630,575 | 1/13/2009 |
| elementindex_Savant2.html | 21,852 | 1/13/2009 |
| elementindex_WebIRS.html | 614,182 | 1/13/2009 |
| index.html | 934 | 1/13/2009 |
| li_Savant2.html | 1,369 | 1/13/2009 |
| li_WebIRS.html | 58,137 | 1/13/2009 |
| packages.html | 1,246 | 1/13/2009 |
| D:\webirs\webirs_source\phpdoc\HTMLframesConverter\ | | |
| phphtmllib\6daa0bfbd1bdb9b394ab8f7ac16f02f7 | | |
| %%-13\hat{ }%%-135052920\hat{ }header.tpl.php | 750 | 3/30/2008 |
| %%-17\hat{ }%%-1708446885\hat{ }blank.tpl.php | 711 | 3/30/2008 |
| %%-19\hat{ }%%-1910644431\hat{ }basicindex.tpl.php | 11,355 | 3/30/2008 |
| %%-20\hat{ }%%-2040098360\hat{ }filesource.tpl.php | 958 | 3/30/2008 |
| %%-39\hat{ }%%-392581648\hat{ }top_frame.tpl.php | 5,814 | 3/30/2008 |
| %%-65\hat{ }%%-658603405\hat{ }page.tpl.php | 12,059 | 3/30/2008 |
| %%-72\hat{ }%%-727729411\hat{ }left_frame.tpl.php | 32,307 | 3/30/2008 |
| %%117\hat{ }%%1172603085\hat{ }index.tpl.php | 1,178 | 3/30/2008 |
| %%127\hat{ }%%12781687\hat{ }pkgelementindex.tpl.php | 3,036 | 3/30/2008 |
| %%131\hat{ }%%131447552\hat{ }elementindex.tpl.php | 2,707 | 3/30/2008 |
| %%202\hat{ }%%2027336986\hat{ }classtrees.tpl.php | 5,071 | 3/30/2008 |
| %%239\hat{ }%%239105369\hat{ }footer.tpl.php | 492 | 3/30/2008 |
| %%972\hat{ }%%972954595\hat{ }docblock.tpl.php | 2,394 | 3/30/2008 |
| D:\webirs\webirs_source\phpdoc\HTMLframesConverter\phphtmllib\media | | |
| banner.css | 417 | 1/13/2009 |
| stylesheet.css | 5,528 | 1/13/2009 |
| D:\webirs\webirs_source\phpdoc\HTMLframesConverter\phphtmllib\WebIRS | | |
| AllocError.html | 3,961 | 1/13/2009 |
| AppCategory.html | 12,818 | 1/13/2009 |
| Article.html | 37,092 | 1/13/2009 |
| ArticleSearch.html | 19,969 | 1/13/2009 |
| ArticleSearchQuery.html | 8,634 | 1/13/2009 |
| ArtIssue.html | 37,389 | 1/13/2009 |
| ArtIssueHandler.html | 14,775 | 1/13/2009 |
| ArtIssueSearch.html | 33,116 | 1/13/2009 |
| ArtPrIssue.html | 75,441 | 1/13/2009 |
| Attach.html | 18,225 | 1/13/2009 |
| Breadcrumb.html | 4,545 | 1/13/2009 |
| Cache.html | 4,777 | 1/13/2009 |
| Category.html | 20,744 | 1/13/2009 |
| CharConvert.html | 5,833 | 1/13/2009 |
| Client.html | 12,373 | 1/13/2009 |
| ClientGroup.html | 4,575 | 1/13/2009 |
| Date.html | 90,989 | 1/13/2009 |
| DeleteFormPresentation.html | 4,518 | 1/13/2009 |
| DetailsPresentation.html | 6,298 | 1/13/2009 |
| DisplayError.html | 3,190 | 1/13/2009 |
| DistributedItemDef.html | 10,649 | 1/13/2009 |
| ExpenseItem.html | 28,701 | 1/13/2009 |
| ExpenseItemHandler.html | 8,373 | 1/13/2009 |
| Filter.html | 10,861 | 1/13/2009 |
| FirePHP.html | 26,900 | 1/13/2009 |
| Flag.html | 15,287 | 1/13/2009 |
| Flood.html | 1,279 | 1/13/2009 |
| FormDisplayType.html | 6,045 | 1/13/2009 |
| FormPresentation.html | 55,049 | 1/13/2009 |
| G.html | 12,718 | 1/13/2009 |
| GenerDateWidget.html | 13,163 | 1/13/2009 |
| GenerVoiceWidget.html | 4,079 | 1/13/2009 |
| GenerWidget.html | 33,478 | 1/13/2009 |
| Handler.html | 20,576 | 1/13/2009 |
| HasMany.html | 15,030 | 1/13/2009 |
| HasManyAttrs.html | 8,861 | 1/13/2009 |
| HasManyWithLinkClass.html | 12,104 | 1/13/2009 |
| HasManyWithoutLinkClass.html | 14,860 | 1/13/2009 |
| IssueHandler.html | 20,217 | 1/13/2009 |
| PermGroup.html | 4,539 | 1/13/2009 |
| PHPMailer.html | 65,383 | 1/13/2009 |
| ProjectHandler.html | 11,444 | 1/13/2009 |
| ResaleItemHandler.html | 7,050 | 1/13/2009 |
| SMTP.html | 32,816 | 1/13/2009 |
| _alloc---artissue---article.php.html | 2,855 | 1/13/2009 |
| _alloc---artissue---articlesearch.php.html | 2,909 | 1/13/2009 |
| _alloc---artissue---articlesearchquery.php.html | 2,005 | 1/13/2009 |
| _alloc---artissue---articlesearch_typ.php.html | 1,227 | 1/13/2009 |
| _alloc---artissue---article_typ.php.html | 1,209 | 1/13/2009 |
| _alloc---artissue---artissue.php.html | 1,955 | 1/13/2009 |
| _alloc---artissue---artissuesearch.php.html | 1,985 | 1/13/2009 |
| _alloc---artissue---artprissue.php.html | 4,116 | 1/13/2009 |
| _alloc---attach.php.html | 1,928 | 1/13/2009 |
| _alloc---billableitem---expenseitem.php.html | 1,978 | 1/13/2009 |
| _alloc---category.php.html | 1,944 | 1/13/2009 |
| _alloc---clientgroup.php.html | 1,953 | 1/13/2009 |
| _alloc---clock.php.html | 1,991 | 1/13/2009 |
| _alloc---combine.php.html | 4,957 | 1/13/2009 |
| _alloc---config.php.html | 1,177 | 1/13/2009 |
| _alloc---constants.php.html | 33,697 | 1/13/2009 |
| _alloc---createflag.php.html | 2,012 | 1/13/2009 |
| _alloc---cronjob.php.html | 2,928 | 1/13/2009 |
| _alloc---dokuwiki.php.html | 11,040 | 1/13/2009 |
| _alloc---error.php.html | 3,220 | 1/13/2009 |
| _alloc---flag.php.html | 1,918 | 1/13/2009 |
| _alloc---get_css.php.html | 4,074 | 1/13/2009 |
| _alloc---get_js.php.html | 2,846 | 1/13/2009 |
| _alloc---gorum2---adodb-time.php.html | 17,132 | 1/13/2009 |
| _alloc---gorum2---category.php.html | 2,916 | 1/13/2009 |
| _alloc---gorum2---changename.php.html | 1,202 | 1/13/2009 |
| _alloc---gorum2---charconvert.php.html | 1,966 | 1/13/2009 |
| _alloc---gorum2---constants.php.html | 22,384 | 1/13/2009 |
| _alloc---gorum2---date.php.html | 1,931 | 1/13/2009 |
| _alloc---gorum2---dbproperty.php.html | 20,500 | 1/13/2009 |
| _alloc---gorum2---dbtreeproperty.php.html | 10,857 | 1/13/2009 |
| _alloc---gorum2---flood.php.html | 3,053 | 1/13/2009 |
| _alloc---gorum2---form.php.html | 1,953 | 1/13/2009 |
| _alloc---gorum2---g.php.html | 1,916 | 1/13/2009 |
| _alloc---gorum2---gorum.php.html | 22,436 | 1/13/2009 |
| _alloc---gorum2---gorumlib.php.html | 17,283 | 1/13/2009 |
| _alloc---gorum2---gorum_db.php.html | 8,824 | 1/13/2009 |
| _alloc---gorum2---hasmany.php.html | 2,557 | 1/13/2009 |
| _alloc---gorum2---htmllist.php.html | 5,414 | 1/13/2009 |
| _alloc---gorum2---imap.php.html | 2,608 | 1/13/2009 |
| _alloc---gorum2---presentation---deleteformpresentation.php.html | 2,046 | 1/13/2009 |
| _alloc---gorum2---presentation---detailspresentation.php.html | 2,031 | 1/13/2009 |
| _alloc---gorum2---presentation---filter.php.html | 1,966 | 1/13/2009 |
| _alloc---gorum2---presentation---formpresentation.php.html | 2,016 | 1/13/2009 |
| _alloc---gorum2---presentation---generdatewidget.php.html | 2,011 | 1/13/2009 |
| _alloc---gorum2---presentation---genervoicewidget.php.html | 2,016 | 1/13/2009 |
| _alloc---gorum2---presentation---generwidget.php.html | 1,991 | 1/13/2009 |
| _alloc---group.php.html | 1,931 | 1/13/2009 |
| _alloc---handler---handler.php.html | 1,948 | 1/13/2009 |
| _alloc---handler---handler_artissue.php.html | 1,991 | 1/13/2009 |
| _alloc---handler---handler_expenseitem.php.html | 2,006 | 1/13/2009 |
| _alloc---handler---handler_issue.php.html | 1,976 | 1/13/2009 |
| _alloc---handler---handler_project.php.html | 1,986 | 1/13/2009 |
| _alloc---handler---handler_resaleitem.php.html | 2,001 | 1/13/2009 |
| _alloc---include.php.html | 39,707 | 1/13/2009 |
| _alloc---index.php.html | 3,744 | 1/13/2009 |
| _alloc---rarities---assignments.php.html | 1,209 | 1/13/2009 |
| _alloc---rarities---breadcrumb.php.html | 1,965 | 1/13/2009 |
| _alloc---rarities---cache.php.html | 1,940 | 1/13/2009 |
| _alloc---rarities---class.phpmailer.php.html | 1,978 | 1/13/2009 |
| _alloc---rarities---class.smtp.php.html | 1,953 | 1/13/2009 |
| _alloc---rarities---client.php.html | 1,945 | 1/13/2009 |
| _alloc---rarities---comingsoon.php.html | 1,206 | 1/13/2009 |
| _alloc---rarities---displayerror.php.html | 1,975 | 1/13/2009 |
| _alloc---recurring---distributeditemdef.php.html | 2,935 | 1/13/2009 |
| _gorum2---adodb-time.php.html | 1,191 | 1/13/2009 |
| _gorum2---category.php.html | 1,894 | 1/13/2009 |
| _gorum2---changename.php.html | 1,191 | 1/13/2009 |
| _gorum2---charconvert.php.html | 1,903 | 1/13/2009 |
| _gorum2---constants.php.html | 1,188 | 1/13/2009 |
| _gorum2---date.php.html | 1,882 | 1/13/2009 |
| _gorum2---dbproperty.php.html | 1,191 | 1/13/2009 |
| _gorum2---dbtreeproperty.php.html | 1,203 | 1/13/2009 |
| _gorum2---firephp---fb.php.html | 3,721 | 1/13/2009 |
| _gorum2---firephp---FirePHP.class.php.html | 2,022 | 1/13/2009 |
| _gorum2---flood.php.html | 1,885 | 1/13/2009 |
| _gorum2---form.php.html | 1,882 | 1/13/2009 |
| _gorum2---g.php.html | 1,873 | 1/13/2009 |
| _gorum2---gorum.php.html | 15,214 | 1/13/2009 |
| _gorum2---gorumlib.php.html | 1,185 | 1/13/2009 |
| _gorum2---gorum_db.php.html | 8,729 | 1/13/2009 |
| _gorum2---hasmany.php.html | 2,302 | 1/13/2009 |
| _gorum2---htmllist.php.html | 1,185 | 1/13/2009 |
| _gorum2---imap.php.html | 1,173 | 1/13/2009 |
| _gorum2---presentation---deleteformpresentation.php.html | 1,961 | 1/13/2009 |
| _gorum2---presentation---detailspresentation.php.html | 1,952 | 1/13/2009 |
| _gorum2---presentation---filter.php.html | 1,913 | 1/13/2009 |
| _gorum2---presentation---formpresentation.php.html | 1,943 | 1/13/2009 |
| _gorum2---presentation---generdatewidget.php.html | 1,940 | 1/13/2009 |
| _gorum2---presentation---genervoicewidget.php.html | 1,943 | 1/13/2009 |
| _gorum2---presentation---generwidget.php.html | 1,928 | 1/13/2009 |
| D:\webirs\webirs_source\phpdoc\HTMLframesConverter\phphtmllib\_filesource | | |
| fsource_WebIRS_allocartissuearticle.php.html | 43,588 | 1/13/2009 |
| fsource_WebIRS_allocartissuearticlesearch.php.html | 29,101 | 1/13/2009 |
| fsource_WebIRS_allocartissuearticlesearchquery.php.html | 5,863 | 1/13/2009 |
| fsource_WebIRS_allocartissuearticlesearch_typ.php.html | 73,796 | 1/13/2009 |
| fsource_WebIRS_allocartissuearticle_typ.php.html | 77,210 | 1/13/2009 |
| fsource_WebIRS_allocartissueartissue.php.html | 127,919 | 1/13/2009 |
| fsource_WebIRS_allocartissueartissuesearch.php.html | 74,588 | 1/13/2009 |
| fsource_WebIRS_allocartissueartprissue.php.html | 279,897 | 1/13/2009 |
| fsource_WebIRS_allocattach.php.html | 125,091 | 1/13/2009 |
| fsource_WebIRS_allocbillableitemexpenseitem.php.html | 75,356 | 1/13/2009 |
| fsource_WebIRS_alloccategory.php.html | 58,765 | 1/13/2009 |
| fsource_WebIRS_allocclientgroup.php.html | 14,096 | 1/13/2009 |
| fsource_WebIRS_allocclock.php.html | 2,113 | 1/13/2009 |
| fsource_WebIRS_alloccombine.php.html | 40,125 | 1/13/2009 |
| fsource_WebIRS_allocconfig.php.html | 6,357 | 1/13/2009 |
| fsource_WebIRS_allocconstants.php.html | 80,905 | 1/13/2009 |
| fsource_WebIRS_alloccreateflag.php.html | 1,847 | 1/13/2009 |
| fsource_WebIRS_alloccronjob.php.html | 4,591 | 1/13/2009 |
| fsource_WebIRS_allocdokuwiki.php.html | 110,322 | 1/13/2009 |
| fsource_WebIRS_allocerror.php.html | 20,714 | 1/13/2009 |
| fsource_WebIRS_allocflag.php.html | 113,918 | 1/13/2009 |
| fsource_WebIRS_allocget_css.php.html | 16,373 | 1/13/2009 |
| fsource_WebIRS_allocget_js.php.html | 10,322 | 1/13/2009 |
| fsource_WebIRS_allocgorum2adodb-time.php.html | 244,820 | 1/13/2009 |
| fsource_WebIRS_allocgorum2category.php.html | 95,911 | 1/13/2009 |
| fsource_WebIRS_allocgorum2changename.php.html | 15,812 | 1/13/2009 |
| fsource_WebIRS_allocgorum2charconvert.php.html | 6,963 | 1/13/2009 |
| fsource_WebIRS_allocgorum2constants.php.html | 43,419 | 1/13/2009 |
| fsource_WebIRS_allocgorum2date.php.html | 228,961 | 1/13/2009 |
| fsource_WebIRS_allocgorum2dbproperty.php.html | 128,659 | 1/13/2009 |
| fsource_WebIRS_allocgorum2dbtreeproperty.php.html | 38,286 | 1/13/2009 |
| fsource_WebIRS_allocgorum2flood.php.html | 8,604 | 1/13/2009 |
| fsource_WebIRS_allocgorum2form.php.html | 10,605 | 1/13/2009 |
| fsource_WebIRS_allocgorum2g.php.html | 37,417 | 1/13/2009 |
| fsource_WebIRS_allocgorum2gorum.php.html | 22,850 | 1/13/2009 |
| fsource_WebIRS_allocgorum2gorumlib.php.html | 99,464 | 1/13/2009 |
| fsource_WebIRS_allocgorum2gorum_db.php.html | 16,581 | 1/13/2009 |
| fsource_WebIRS_allocgorum2hasmany.php.html | 60,126 | 1/13/2009 |
| fsource_WebIRS_allocgorum2htmllist.php.html | 47,563 | 1/13/2009 |
| fsource_WebIRS_allocgorum2imap.php.html | 10,478 | 1/13/2009 |
| fsource_WebIRS_allocgorum2presentationdeleteformpresentation.php.html | 20,474 | 1/13/2009 |
| fsource_WebIRS_allocgorum2presentationdetailspresentation.php.html | 21,493 | 1/13/2009 |
| fsource_WebIRS_allocgorum2presentationfilter.php.html | 15,733 | 1/13/2009 |
| fsource_WebIRS_allocgorum2presentationformpresentation.php.html | 225,756 | 1/13/2009 |
| fsource_WebIRS_allocgorum2presentationgenerdatewidget.php.html | 119,268 | 1/13/2009 |
| fsource_WebIRS_allocgorum2presentationgenervoicewidget.php.html | 14,981 | 1/13/2009 |
| fsource_WebIRS_allocgorum2presentationgenerwidget.php.html | 107,568 | 1/13/2009 |
| fsource_WebIRS_allocgroup.php.html | 14,362 | 1/13/2009 |
| fsource_WebIRS_allochandlerhandler.php.html | 60,499 | 1/13/2009 |
| fsource_WebIRS_allochandlerhandler_artissue.php.html | 40,176 | 1/13/2009 |
| fsource_WebIRS_allochandlerhandler_expenseitem.php.html | 7,227 | 1/13/2009 |
| fsource_WebIRS_allochandlerhandler_issue.php.html | 59,126 | 1/13/2009 |
| fsource_WebIRS_allochandlerhandler_project.php.html | 6,598 | 1/13/2009 |
| fsource_WebIRS_allochandlerhandler_resaleitem.php.html | 3,019 | 1/13/2009 |
| fsource_WebIRS_allocinclude.php.html | 21,104 | 1/13/2009 |
| fsource_WebIRS_allocindex.php.html | 4,365 | 1/13/2009 |
| fsource_WebIRS_allocinit.php.html | 202,058 | 1/13/2009 |
| fsource_WebIRS_allocraritiesassignments.php.html | 2,010 | 1/13/2009 |
| fsource_WebIRS_allocraritiesbreadcrumb.php.html | 23,335 | 1/13/2009 |
| fsource_WebIRS_allocraritiescache.php.html | 7,322 | 1/13/2009 |
| fsource_WebIRS_allocraritiesclass.phpmailer.php.html | 411,346 | 1/13/2009 |
| fsource_WebIRS_allocraritiesclass.smtp.php.html | 241,273 | 1/13/2009 |
| fsource_WebIRS_allocraritiesclient.php.html | 66,582 | 1/13/2009 |
| fsource_WebIRS_allocraritiescomingsoon.php.html | 18,684 | 1/13/2009 |
| fsource_WebIRS_allocraritiesdisplayerror.php.html | 3,950 | 1/13/2009 |
| fsource_WebIRS_allocrecurringdistributeditemdef.php.html | 23,659 | 1/13/2009 |
| fsource_WebIRS_gorum2adodb-time.php.html | 244,812 | 1/13/2009 |
| fsource_WebIRS_gorum2category.php.html | 95,903 | 1/13/2009 |
| fsource_WebIRS_gorum2changename.php.html | 15,804 | 1/13/2009 |
| fsource_WebIRS_gorum2charconvert.php.html | 6,955 | 1/13/2009 |
| fsource_WebIRS_gorum2constants.php.html | 43,752 | 1/13/2009 |
| fsource_WebIRS_gorum2date.php.html | 230,925 | 1/13/2009 |
| fsource_WebIRS_gorum2dbproperty.php.html | 128,651 | 1/13/2009 |
| fsource_WebIRS_gorum2dbtreeproperty.php.html | 38,278 | 1/13/2009 |
| fsource_WebIRS_gorum2firephpfb.php.html | 12,335 | 1/13/2009 |
| fsource_WebIRS_gorum2firephpFirePHP.class.php.html | 160,425 | 1/13/2009 |
| fsource_WebIRS_gorum2flood.php.html | 8,596 | 1/13/2009 |
| fsource_WebIRS_gorum2form.php.html | 10,597 | 1/13/2009 |
| fsource_WebIRS_gorum2g.php.html | 37,409 | 1/13/2009 |
| fsource_WebIRS_gorum2gorum.php.html | 22,842 | 1/13/2009 |
| fsource_WebIRS_gorum2gorumlib.php.html | 99,456 | 1/13/2009 |
| fsource_WebIRS_gorum2gorum_db.php.html | 16,573 | 1/13/2009 |
| fsource_WebIRS_gorum2hasmany.php.html | 60,118 | 1/13/2009 |
| fsource_WebIRS_gorum2htmllist.php.html | 47,555 | 1/13/2009 |
| fsource_WebIRS_gorum2imap.php.html | 10,470 | 1/13/2009 |
| fsource_WebIRS_gorum2presentationdeleteformpresentation.php.html | 20,466 | 1/13/2009 |
| fsource_WebIRS_gorum2presentationdetailspresentation.php.html | 21,485 | 1/13/2009 |
| fsource_WebIRS_gorum2presentationfilter.php.html | 15,725 | 1/13/2009 |
| fsource_WebIRS_gorum2presentationformpresentation.php.html | 228,368 | 1/13/2009 |
| fsource_WebIRS_gorum2presentationgenerdatewidget.php.html | 119,260 | 1/13/2009 |
| fsource_WebIRS_gorum2presentationgenervoicewidget.php.html | 14,973 | 1/13/2009 |
| fsource_WebIRS_gorum2presentationgenerwidget.php.html | 111,189 | 1/13/2009 |
| D:\webirs\webirs_source\phpdoc\media | | |
| banner.css | 417 | 1/14/2009 |
| stylesheet.css | 6,268 | 1/14/2009 |
| D:\webirs\webirs_source\phpdoc\media\images | | |
| blank.png | 144 | 1/14/2009 |
| empty.png | 90 | 1/14/2009 |
| I.png | 148 | 1/14/2009 |
| L.png | 153 | 1/14/2009 |
| Lminus.png | 219 | 1/14/2009 |
| Lplus.png | 224 | 1/14/2009 |
| minus.gif | 54 | 1/14/2009 |
| plus.gif | 56 | 1/14/2009 |
| T.png | 152 | 1/14/2009 |
| Tminus.png | 207 | 1/14/2009 |
| Tplus.png | 222 | 1/14/2009 |
| D:\webirs\webirs_source\phpdoc\media\lib | | |
| classTree.js | 17,351 | 1/14/2009 |
| D:\webirs\webirs_source\phpdoc\WebIRS | | |
| AppCategory.html | 14,198 | 1/14/2009 |
| AppInit.html | 14,339 | 1/14/2009 |
| AppObject.html | 61,099 | 1/14/2009 |
| AppUser.html | 19,839 | 1/14/2009 |
| Attach.html | 19,206 | 1/14/2009 |
| Client.html | 13,928 | 1/14/2009 |
| ClientGroup.html | 6,649 | 1/14/2009 |
| DisplayError.html | 5,259 | 1/14/2009 |
| Flag.html | 16,729 | 1/14/2009 |
| ItemList.html | 10,354 | 1/14/2009 |
| Note.html | 33,019 | 1/14/2009 |
| NoteList.html | 11,102 | 1/14/2009 |
| ObjectNoteList.html | 12,564 | 1/14/2009 |
| Period.html | 65,273 | 1/14/2009 |
| PeriodList.html | 10,472 | 1/14/2009 |
| Perm.html | 55,638 | 1/14/2009 |
| PermGroup.html | 6,656 | 1/14/2009 |
| Permission.html | 26,628 | 1/14/2009 |
| Portal.html | 13,568 | 1/14/2009 |
| PortalAttr.html | 16,428 | 1/14/2009 |
| ReadState.html | 6,040 | 1/14/2009 |
| Search.html | 9,513 | 1/14/2009 |
| Settings.html | 3,440 | 1/14/2009 |
| Vacation.html | 13,623 | 1/14/2009 |
| VarFields.html | 11,464 | 1/14/2009 |
| Version.html | 11,894 | 1/14/2009 |
| _attach.php.html | 4,223 | 1/14/2009 |
| _category.php.html | 4,223 | 1/14/2009 |
| _clientgroup.php.html | 4,196 | 1/14/2009 |
| _clock.php.html | 4,135 | 1/14/2009 |
| _combine.php.html | 6,791 | 1/14/2009 |
| _config.php.html | 3,395 | 1/14/2009 |
| _constants.php.html | 29,238 | 1/14/2009 |
| _cronjob.php.html | 4,996 | 1/14/2009 |
| _dokuwiki.php.html | 12,667 | 1/14/2009 |
| _flag.php.html | 4,218 | 1/14/2009 |
| _get_css.php.html | 5,989 | 1/14/2009 |
| _get_js.php.html | 4,838 | 1/14/2009 |
| _group.php.html | 4,205 | 1/14/2009 |
| _include.php.html | 36,080 | 1/14/2009 |
| _index.php.html | 5,603 | 1/14/2009 |
| _init.php.html | 8,379 | 1/14/2009 |
| _itemlist.php.html | 4,154 | 1/14/2009 |
| _js_css_map.php.html | 3,403 | 1/14/2009 |
| _note.php.html | 4,207 | 1/14/2009 |
| _notelist.php.html | 4,212 | 1/14/2009 |
| _object.php.html | 4,259 | 1/14/2009 |
| _objectnotelist.php.html | 4,257 | 1/14/2009 |
| _period.php.html | 5,362 | 1/14/2009 |
| _periodlist.php.html | 4,222 | 1/14/2009 |
| _permconfig.js.php.html | 5,525 | 1/14/2009 |
| _permconfig.php.html | 4,259 | 1/14/2009 |
| _permission.php.html | 5,451 | 1/14/2009 |
| _portal.php.html | 4,176 | 1/14/2009 |
| _portalattr.php.html | 5,206 | 1/14/2009 |
| _rarities---assignments.php.html | 3,269 | 1/14/2009 |
| _rarities---breadcrumb.php.html | 3,267 | 1/14/2009 |
| _rarities---cache.php.html | 3,257 | 1/14/2009 |
| _rarities---class.phpmailer.php.html | 3,277 | 1/14/2009 |
| _rarities---class.smtp.php.html | 3,267 | 1/14/2009 |
| _rarities---client.php.html | 4,237 | 1/14/2009 |
| _rarities---comingsoon.php.html | 3,267 | 1/14/2009 |
| _rarities---displayerror.php.html | 4,179 | 1/14/2009 |
| _rarities---proxy.php.html | 3,257 | 1/14/2009 |
| _rarities---readstate.php.html | 5,533 | 1/14/2009 |
| _search.php.html | 4,180 | 1/14/2009 |
| _settings.php.html | 4,154 | 1/14/2009 |
| _smsclock.php.html | 5,214 | 1/14/2009 |
| _user.php.html | 4,238 | 1/14/2009 |
| _vacation.php.html | 4,154 | 1/14/2009 |
| _varfields.php.html | 6,094 | 1/14/2009 |
| _version.php.html | 4,271 | 1/14/2009 |
| _xajax_server.php.html | 34,026 | 1/14/2009 |
| D:\webirs\webirs_source\phpdoc\WebIRS\ArtIssue | | |
| AllocXajaxResponse.html | 10,411 | 1/14/2009 |
| Article.html | 39,321 | 1/14/2009 |
| ArticleSearch.html | 22,077 | 1/14/2009 |
| ArticleSearchQuery.html | 11,137 | 1/14/2009 |
| ArtIssue.html | 39,605 | 1/14/2009 |
| ArtIssueSearch.html | 34,030 | 1/14/2009 |
| ArtPrIssue.html | 73,358 | 1/14/2009 |
| Issue.html | 86,592 | 1/14/2009 |
| IssueListPresentation.html | 7,114 | 1/14/2009 |
| IssueSearch.html | 38,583 | 1/14/2009 |
| IssueSearchQuery.html | 48,621 | 1/14/2009 |
| PriorityIndex.html | 11,344 | 1/14/2009 |
| PrIssueSearch.html | 34,846 | 1/14/2009 |
| Project.html | 48,347 | 1/14/2009 |
| ProjectSearch.html | 24,081 | 1/14/2009 |
| ProjectSearchQuery.html | 27,181 | 1/14/2009 |
| SearchQuery.html | 28,315 | 1/14/2009 |
| _artissue---article.php.html | 5,013 | 1/14/2009 |
| _artissue---articlesearch.php.html | 5,130 | 1/14/2009 |
| _artissue---articlesearchquery.php.html | 4,264 | 1/14/2009 |
| _artissue---articlesearch_typ.php.html | 3,438 | 1/14/2009 |
| _artissue---article_typ.php.html | 3,426 | 1/14/2009 |
| _artissue---artissue.php.html | 4,247 | 1/14/2009 |
| _artissue---artissuesearch.php.html | 4,283 | 1/14/2009 |
| _artissue---artprissue.php.html | 6,225 | 1/14/2009 |
| _artissue---issue.php.html | 7,518 | 1/14/2009 |
| _artissue---issuelistpresentation.php.html | 4,298 | 1/14/2009 |
| _artissue---issuesearch.php.html | 5,112 | 1/14/2009 |
| _artissue---issuesearchquery.php.html | 4,254 | 1/14/2009 |
| _artissue---issuesearch_typ.php.html | 3,434 | 1/14/2009 |
| _artissue---issue_typ.php.html | 3,422 | 1/14/2009 |
| _artissue---priorityindex.php.html | 4,293 | 1/14/2009 |
| _artissue---prissuesearch.php.html | 6,151 | 1/14/2009 |
| _artissue---project.php.html | 5,013 | 1/14/2009 |
| _artissue---projectsearch.php.html | 5,129 | 1/14/2009 |
| _artissue---projectsearchquery.php.html | 4,264 | 1/14/2009 |
| _artissue---projectsearch_typ.php.html | 3,438 | 1/14/2009 |
| _artissue---project_typ.php.html | 3,426 | 1/14/2009 |
| _artissue---searchquery.php.html | 4,287 | 1/14/2009 |
| _xajax.php.html | 4,047 | 1/14/2009 |
| D:\webirs\webirs_source\phpdoc\WebIRS\BillableItem | | |
| ExpenseItem.html | 31,028 | 1/14/2009 |
| Item.html | 47,888 | 1/14/2009 |
| ItemList.html | 10,466 | 1/14/2009 |
| ItemSearch.html | 9,587 | 1/14/2009 |
| Labor.html | 8,149 | 1/14/2009 |
| MilageRate.html | 15,916 | 1/14/2009 |
| MilageReport.html | 31,796 | 1/14/2009 |
| Rate.html | 21,649 | 1/14/2009 |
| ReimbursableItem.html | 26,561 | 1/14/2009 |
| ResaleItem.html | 30,314 | 1/14/2009 |
| WorkReport.html | 37,414 | 1/14/2009 |
| _billableitem---expenseitem.php.html | 4,207 | 1/14/2009 |
| _billableitem---item.php.html | 4,213 | 1/14/2009 |
| _billableitem---itemsearch.php.html | 4,243 | 1/14/2009 |
| _billableitem---labor.php.html | 4,183 | 1/14/2009 |
| _billableitem---milagereport.php.html | 4,211 | 1/14/2009 |
| _billableitem---reimbursableitem.php.html | 4,227 | 1/14/2009 |
| _billableitem---resaleitem.php.html | 4,203 | 1/14/2009 |
| _billableitem---workreport.php.html | 4,203 | 1/14/2009 |
| _itemlist.php.html | 4,248 | 1/14/2009 |
| _rarities---rate.php.html | 4,224 | 1/14/2009 |
| _rarities---rate_milage.php.html | 4,201 | 1/14/2009 |
| D:\webirs\webirs_source\phpdoc\WebIRS\ErrorHandler | | |
| AllocError.html | 6,966 | 1/14/2009 |
| Error.html | 10,728 | 1/14/2009 |
| _error---error.php.html | 6,460 | 1/14/2009 |
| _error---showSource.php.html | 4,991 | 1/14/2009 |
| _error.php.html | 5,411 | 1/14/2009 |
| D:\webirs\webirs_source\phpdoc\WebIRS\EventHandler | | |
| ArtIssueHandler.html | 16,560 | 1/14/2009 |
| ExpenseItemHandler.html | 10,785 | 1/14/2009 |
| Handler.html | 21,928 | 1/14/2009 |
| IssueHandler.html | 21,873 | 1/14/2009 |
| Log.html | 20,059 | 1/14/2009 |
| LogAction.html | 12,531 | 1/14/2009 |
| LogSubscription.html | 22,143 | 1/14/2009 |
| Notif.html | 21,096 | 1/14/2009 |
| NotifSubscription.html | 32,114 | 1/14/2009 |
| ProjectHandler.html | 14,249 | 1/14/2009 |
| ResaleItemHandler.html | 9,556 | 1/14/2009 |
| _handler---handler.php.html | 4,411 | 1/14/2009 |
| _handler---handler_artissue.php.html | 4,289 | 1/14/2009 |
| _handler---handler_expenseitem.php.html | 4,263 | 1/14/2009 |
| _handler---handler_issue.php.html | 4,267 | 1/14/2009 |
| _handler---handler_project.php.html | 4,242 | 1/14/2009 |
| _handler---handler_resaleitem.php.html | 4,258 | 1/14/2009 |
| _handler---log.php.html | 4,241 | 1/14/2009 |
| _handler---logaction.php.html | 4,289 | 1/14/2009 |
| _handler---logsubscription.php.html | 4,331 | 1/14/2009 |
| _handler---notification.php.html | 5,383 | 1/14/2009 |
| _handler---notifsubscription.php.html | 4,342 | 1/14/2009 |
| D:\webirs\webirs_source\phpdoc\WebIRS\Recurring | | |
| DistributedItemDef.html | 12,554 | 1/14/2009 |
| RecurringItemDef.html | 8,867 | 1/14/2009 |
| SpecItem.html | 13,037 | 1/14/2009 |
| SpecItemDef.html | 21,530 | 1/14/2009 |
| _recurring---distributeditemdef.php.html | 5,066 | 1/14/2009 |
| _recurring---recurringitemdef.php.html | 4,221 | 1/14/2009 |
| _recurring---specitem.php.html | 4,189 | 1/14/2009 |
| _recurring---specitemdef.php.html | 4,201 | 1/14/2009 |
| D:\webirs\webirs_source\phpdoc\WebIRS\Report | | |
| CategoryReport.html | 6,720 | 1/14/2009 |
| EmployeeActivityReport.html | 26,030 | 1/14/2009 |
| EmployeeReport.html | 6,721 | 1/14/2009 |
| ItemReport.html | 16,952 | 1/14/2009 |
| PayrollReport.html | 8,409 | 1/14/2009 |
| Report.html | 15,979 | 1/14/2009 |
| VacationReport.html | 6,721 | 1/14/2009 |
| _report---report.php.html | 4,215 | 1/14/2009 |
| _report---report_category.php.html | 4,259 | 1/14/2009 |
| _report---report_employee.php.html | 6,620 | 1/14/2009 |
| _report---report_employeeactivity.php.html | 4,300 | 1/14/2009 |
| _report---report_item.php.html | 5,479 | 1/14/2009 |
| _report---report_payroll.php.html | 4,254 | 1/14/2009 |
| _report---report_vacation.php.html | 4,259 | 1/14/2009 |
| D:\webirs\webirs_source\rarities | | |
| assignments.php | 101 | 4/6/2008 |
| breadcrumb.php | 2,587 | 4/6/2008 |
| cache.php | 516 | 4/6/2008 |
| class.phpmailer.php | 50,231 | 4/6/2008 |
| class.smtp.php | 32,604 | 4/6/2008 |
| client.php | 7,442 | 10/2/2008 |
| comingsoon.php | 3,588 | 4/6/2008 |
| displayerror.php | 291 | 4/6/2008 |
| filechucker_alloc.cgi | 104,158 | 6/20/2008 |
| proxy.php | 395 | 4/6/2008 |
| rate.php | 12,026 | 6/20/2008 |
| rate_milage.php | 6,904 | 10/2/2008 |
| readstate.php | 816 | 4/6/2008 |
| D:\webirs\webirs_source\rarities\language | | |
| phpmailer.lang-en.php | 1,062 | 4/6/2008 |
| D:\webirs\webirs_source\recurring | | |
| distributeditemdef.php | 2,811 | 4/6/2008 |
| recurringitemdef.php | 205 | 4/6/2008 |
| specitem.php | 5,857 | 4/6/2008 |
| specitemdef.php | 10,272 | 5/5/2008 |
| D:\webirs\webirs_source\report | | |
| report.php | 7,864 | 10/2/2008 |
| report_category.php | 12,911 | 4/6/2008 |
| report_employee.php | 8,376 | 6/20/2008 |
| report_employeeactivity.php | 3,732 | 9/10/2008 |
| report_item.php | 28,932 | 10/2/2008 |
| report_payroll.php | 9,144 | 11/4/2008 |
| report_vacation.php | 3,855 | 4/6/2008 |
| D:\webirs\webirs_source\sql | | |
| config.php | 324 | 8/6/2007 |
| install.sh | 736 | 8/4/2007 |
| update13.php | 5,001 | 8/6/2007 |
| update18.php | 1,814 | 11/8/2007 |
| update19.php | 1,488 | 11/8/2007 |
| update_60.php | 1,867 | 11/8/2007 |
| update_60.sql | 10,661 | 4/6/2008 |
| update_70.sql | 16,401 | 6/20/2008 |
| update_71.sql | 3,392 | 9/10/2008 |
| update_73.sql | 1,098 | 10/17/2008 |
| update_items.php | 3,993 | 4/6/2008 |
| update_logs.php | 1,612 | 4/6/2008 |
| update_notes.php | 995 | 4/6/2008 |
| update_outip.php | 1,667 | 1/23/2008 |
| update_outips.php | 1,624 | 4/6/2008 |
| update_searches.php | 4,482 | 9/10/2008 |
| webirs.sql | 34,458 | 4/6/2008 |
| D:\webirs\webirs_source\templates | | |
| activity_report.css | 20,024 | 10/23/2008 |
| activity_report.html | 1,448 | 10/23/2008 |
| AC_RunActiveContent.js | 3,359 | 1/28/2008 |
| alloc.css | 9,716 | 9/10/2008 |
| article_details.tpl.php | 3,652 | 5/8/2008 |
| batch_modify_form.tpl.php | 3,522 | 11/8/2007 |
| category.tpl.php | 2,875 | 11/8/2007 |
| category_list.tpl.php | 786 | 11/8/2007 |
| category_page.tpl.php | 237 | 11/8/2007 |
| clear_flag_notification.html | 223 | 9/28/2007 |
| coloring.css | 617 | 12/13/2007 |
| coloring.html | 1,786 | 12/13/2007 |
| column_organizer.html | 1,960 | 9/28/2007 |
| column_organizer.js | 4,629 | 9/28/2007 |
| create_issue.js | 2,014 | 4/6/2008 |
| default.tpl.php | 192 | 12/19/2007 |
| details_core.tpl.php | 808 | 11/8/2007 |
| dokuwiki.css | 27,860 | 10/2/2008 |
| employee.tpl.php | 3,453 | 11/8/2007 |
| flag_notification.html | 214 | 9/28/2007 |
| issue_details.tpl.php | 5,548 | 9/10/2008 |
| issue_list.tpl.php | 6,994 | 4/6/2008 |
| itemreport_client.tpl.php | 3,508 | 10/2/2008 |
| itemreport_general.tpl.php | 3,623 | 10/2/2008 |
| item_details.tpl.php | 697 | 11/8/2007 |
| item_summary_list.tpl.php | 3,147 | 4/6/2008 |
| jqModal.css | 1,873 | 11/6/2008 |
| mainframe.tpl.php | 4,304 | 10/21/2008 |
| mainframe_empty.tpl.php | 167 | 11/8/2007 |
| mainframe_portalform.tpl.php | 1,389 | 8/18/2008 |
| mainframe_portalform_upload.tpl.php | 3,567 | 8/18/2008 |
| mainframe_print.tpl.php | 657 | 4/18/2008 |
| mainframe_priorize.tpl.php | 4,864 | 4/18/2008 |
| mainframe_punch.tpl.php | 2,166 | 4/18/2008 |
| md5-unpacked.js | 8,572 | 4/18/2008 |
| md5.js | 4,929 | 4/18/2008 |
| note_list.tpl.php | 23,767 | 10/17/2008 |
| note_list_activity.tpl.php | 4,640 | 10/17/2008 |
| one_off_notification.html | 167 | 9/28/2007 |
| payroll.tpl.php | 4,178 | 10/2/2008 |
| period.js | 3,111 | 10/29/2008 |
| period_check.tpl.php | 2,819 | 6/11/2008 |
| perm_modify.tpl.php | 6,510 | 11/6/2008 |
| popup.js | 1,729 | 11/5/2008 |
| popupstyle.js | 1,284 | 9/28/2007 |
| popup_permission.js | 7,948 | 11/6/2008 |
| progressbar-unpacked.js | 21,713 | 4/18/2008 |
| progressbar.css | 2,011 | 9/28/2007 |
| progressbar.js | 11,839 | 4/18/2008 |
| progressbar.tpl.php | 1,230 | 11/8/2007 |
| project_details.tpl.php | 2,871 | 9/10/2008 |
| punchclock.css | 556 | 4/18/2008 |
| related.js | 2,402 | 12/19/2007 |
| reminder_info.tpl.php | 669 | 11/8/2007 |
| reports.tpl.php | 381 | 11/8/2007 |
| set_flag_notification.html | 230 | 9/28/2007 |
| style.css | 4,421 | 4/18/2008 |
| vacation.js | 1,197 | 1/11/2008 |
| vacation.tpl.php | 1,909 | 1/11/2008 |
| valami.js | 30 | 4/18/2008 |
| version.tpl.php | 25 | 4/6/2008 |
| wikipreview.js | 1,259 | 4/6/2008 |
| xajax-unpacked.js | 15,690 | 9/10/2008 |
| xajax.js | 7,407 | 5/27/2008 |
| D:\webirs\webirs_source\xajax | | |
| examples | | 1/23/2009 |
| tests | | 1/23/2009 |
| xajax_js | | 1/23/2009 |
| LICENSE.txt | 26,936 | 7/25/2007 |
| README.txt | 4,490 | 7/25/2007 |
| xajax.inc.php | 36,505 | 4/18/2008 |
| xajaxCompress.php | 4,974 | 7/25/2007 |
| xajaxResponse.inc.php | 19,436 | 7/25/2007 |
| D:\webirs\webirs_source\xajax\examples | | |
| multiply | | 1/23/2009 |
| signup | | 1/23/2009 |
| thewall | | 1/23/2009 |
| xul | | 1/23/2009 |
| helloworld.php | 2,132 | 7/25/2007 |
| D:\webirs\webirs_source\xajax\examples\multiply | | |
| multiply.common.php | 290 | 7/25/2007 |
| multiply.php | 797 | 7/25/2007 |
| multiply.server.php | 366 | 7/25/2007 |
| D:\webirs\webirs_source\xajax\examples\signup | | |
| signup.common.php | 322 | 7/25/2007 |
| signup.php | 1,576 | 7/25/2007 |
| signup.server.php | 3,416 | 7/25/2007 |
| D:\webirs\webirs_source\xajax\examples\thewall | | |
| brick.jpg | 1,119 | 7/25/2007 |
| thewall.common.php | 349 | 7/25/2007 |
| thewall.dta | 201 | 7/25/2007 |
| thewall.php | 1,824 | 7/25/2007 |
| thewall.server.php | 3,353 | 7/25/2007 |
| D:\webirs\webirs_source\xajax\examples\xul | | |
| errors.txt | 134 | 7/25/2007 |
| xulApplication.php | 1,233 | 7/25/2007 |
| xulClient.xul | 655 | 7/25/2007 |
| xulServer.php | 515 | 7/25/2007 |
| D:\webirs\webirs_source\xajax\tests | | |
| catchAllFunctionTest.php | 1,548 | 7/25/2007 |
| changeEventTest.php | 1,213 | 7/25/2007 |
| charEncodingTest.php | 4,249 | 7/25/2007 |
| confirmTest.php | 1,147 | 7/25/2007 |
| createFormInputTest.php | 4,352 | 7/25/2007 |
| customResponseClassTest.php | 2,881 | 7/25/2007 |
| disabledFormElementsTest.php | 1,353 | 7/25/2007 |
| errorHandlingTest.php | 1,057 | 7/25/2007 |
| errors.txt | 2,019 | 7/25/2007 |
| eventHandlerTest.php | 1,820 | 7/25/2007 |
| formSubmissionTest.php | 2,896 | 7/25/2007 |
| HTTPStatusTest.php | 1,121 | 7/25/2007 |
| includeExternalScriptTest.php | 1,196 | 7/25/2007 |
| index.php | 1,682 | 7/25/2007 |
| largeResponseTest.php | 1,026 | 7/25/2007 |
| myExternalFunction.js | 143 | 7/25/2007 |
| myExternalFunction.php | 599 | 7/25/2007 |
| phpWhitespaceTest.php | 1,014 | 7/25/2007 |
| preFunctionTest.php | 2,348 | 7/25/2007 |
| redirectTest.php | 864 | 7/25/2007 |
| registerExternalFunctionTest.php | 1,042 | 7/25/2007 |
| scriptCallTest.php | 1,259 | 7/25/2007 |
| searchReplaceTest.php | 2,052 | 7/25/2007 |
| xajaxResponseTest.php | 1,317 | 7/25/2007 |
| xajax_error_log.log | 287 | 7/25/2007 |
| D:\webirs\webirs_source\xajax\xajax_js | | |
| xajax.js | 15,903 | 7/25/2007 |
| xajax_uncompressed.js | 21,830 | 7/25/2007 |

Total for all folders: Files: 3642; Folders: 130; Total size: 129,340,626

on the compact disc submitted herewith, and the computer program which is represented by their combination. Two identical discs, each containing the files listed above are submitted herewith.

### BACKGROUND

There are a variety of technologies known in the prior art for tracking the completion of tasks. These range from personal information management systems such as Outlook, to project management systems such as MS Project and ERP systems that employ Gantt charts, milestones, and tasks and subtasks with complex dependencies.

One aspect shared by many prior art systems is that they define tasks to be completed by what will be required to complete them in the future. While this may be effective for tasks which are routine and where the future can be forecasted well, in contexts where the future is not known or cannot be accurately forecasted, they often break down. Additionally, prior art systems often lack administrative functions which can be useful in tracking work which is being done (and has been completed) on tasks.

The teachings of this disclosure can be used to implement systems which, among other things, address the weaknesses of the prior art approaches set forth above.

### SUMMARY

Disclosed herein are various tools and techniques which can be used in task tracking and allocation. For example, based on the disclosure set forth herein, one of ordinary skill in the art could create a computer readable medium having stored thereon a set of instructions operable to configure a computer such that the computer is operable to perform a set of tasks. That set of tasks might comprise maintaining a database, generating a first interface displaying subjects specifically associated with individual issues, generating a second interface displaying notes uniquely related to an issue selected by a user, sending notifications to users when a new note is created, begin incrementing a time record based on a signal generated by a user, and generating and outputting a report based on a set of report information specified through a report specification interface. The set of tasks might also include generating a search interface operable to allow a user to specify a set of search criteria, and the subjects displayed to the user in the first interface might be the subjects associated with the issues that match the search criteria.

The set of tasks might also comprise presenting a priority modification interface. In some implementations, there might be a list of subjects presented to a user in a manner that indicates the relative priorities of the issues associated with those subjects. A priority modification interface could allow a user to modify the priorities associated with specific issues, and the modified priority information could be stored in a database comprising the issues so that the change in priority would be reflected in future interfaces. Another task which instructions on a computer readable medium could configure a computer to perform is, in response to receiving a message comprising a text string, identifying the sender of the message by searching a plurality of stored user records to identify the user who sent the message, then starting to increment a time record for the user indicating work done by the user.

Also, in some instances, instructions stored on a computer readable medium and implemented according to this disclosure could configure a computer to maintain a database comprising a plurality of folders organized into a hierarchy. The database might also comprise a plurality of relationship records containing data indicating relationships which might stretch across folders. In such an implementation, the instructions might also be operable to configure the computer such that it was operable to present a relationship record interface which the user could use to examine a relationship record in one folder. Such interface might also, in response to a user indicating a cross-folder relationship with a second relationship record, display information related to that second relationship record.

Of course, the above description should be understood as being illustrative only. The disclosure herein could be used to create computer readable media having instructions stored thereon which could configured a computer to perform additional or different tasks than identified above. Additionally, the disclosure set forth herein is not limited to implementation in the form of computer readable media, and could similarly be used in implementing servers or performing various methods. Accordingly, neither the claims set forth herein or on any document claiming the benefit of this disclosure should be limited by the examples of computer readable media provided above.

### BRIEF DESCRIPTION OF THE DRAWINGS

The drawings and detailed description which follow are intended to be merely illustrative and are not intended to limit the scope of the invention as set forth in the appended claims.

FIG. 1 depicts possible uses of a system for task tracking and allocation.

FIGS. 2a-2k depict interfaces which could be presented to a user by a system for task tracking and allocation.

FIGS. 3a-3b depicts relationships between various conceptual entities which could be maintained in a system for task tracking and allocation.

### DETAILED DESCRIPTION

The inventors have conceived of novel technology for task tracking and allocation. For the purpose of illustration, this disclosure is organized around certain exemplary embodiments and uses of task tracking and allocation technology. However, it should be understood that those of ordinary skill in the art will be able to implement technology for task tracking and allocation which diverges from the explicit disclosure in this application without undue experimentation in light of the teachings set forth herein. Therefore, the discussion herein should be understood as being illustrative only, and not limiting on the scope of claims which are set forth in this application, or which are included in future applications which claim the benefit of this application.

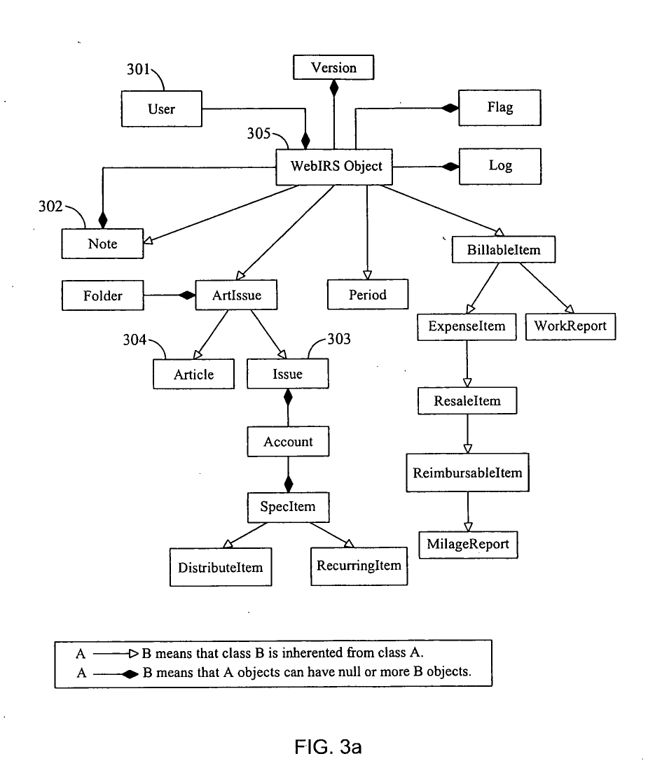

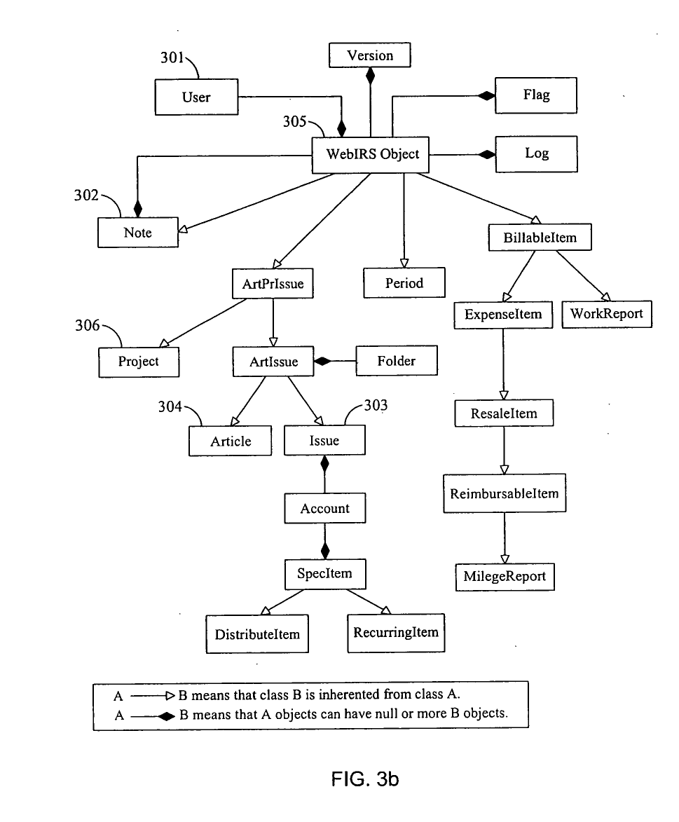

Turning now to the drawings, FIG. 3a depicts potential relationships between different types of entities which could be used in implementing certain aspects of this disclosure. While FIG. 3a is set forth in the form of a UML (Unified Modeling Language) class diagram, it should be understood that the teachings of this disclosure could be implemented without reliance on classes. For example, entities having relationships such as depicted in FIG. 3a could be represented by data in a relational database, and accessed using front end software which may or may not be implemented using classes. Similarly, it should be understood that the labels given for the entities shown in FIG. 3a are provided for ease of reference only, and should not be understood as implying that certain types of entities or relationships are required to be included in all implementations of this disclosure. Accordingly, FIG. 3a, and the accompanying discussion should be understood as being exemplary of how relationships between certain types of entities can be maintained in some implementations, and should not be treated as implying limits on the scope of claims in this or any related application.

As shown in FIG. 3a, one type of information which can be maintained and used in task tracking and allocation is information regarding users (user records) [301]. Those user records [301] could be implemented to contain information related to specific individuals who might use, modify or review information stored for task tracking and allocation. For example, a user record [301] could include a contact identification (e.g., an email address) which could be used to send notifications to the user corresponding to the user record. The user record [301] might also include other information, such as passwords, access control information, hourly rate, user skills, or availability, could also be included. Of course, the information disclosed is intended to be illustrative only, and should not be treated as implying information which is required to be in a user record [301], or as implying that other information could not be included in a user record [301]. It should be understood that the particular information stored in user records [301] may vary from implementation to implementation, depending on the specifics of particular situations.

Also, as shown in FIG. 3a, in some implementations there might be maintained information regarding notes [302]. Notes [302] could be units of information created by users describing actions, requirements or suggestions for tasks. In some implementations, when a note [302] is created, the program creating the note [302] would store information such as the user who created the note, the time the note was created, and what permissions a user would require in order to view the note. Also, in some implementations, individual notes [302] might be associated with other entities, such as issues. In such a case, when a note [302] is created, the program which creates the note could create an indication of the association with the other entity, such as by adding a pointer to a note in the associated entity, by storing a pointer to the associated entity in the note, or some other manner. Of course, it should be understood that other information regarding notes (e.g., category for information stored in the note, users who should be notified when the note is created, etc) could also be stored when a note is created, and that the information described is intended to be illustrative only.

As referred to in the discussion of notes [302], some implementations of task tracking and allocation technology based on this disclosure might also maintain information about issues [303] (that is, a unit of work product which needs to be created, or a defined unit of work which needs to be performed). In some implementations, the information maintained about an issue might include information such as: a client on whose behalf work on the issue is performed; notes relevant to the issue; and a subject (i.e., descriptive text reflective of the general nature of an issue). Also, as depicted in FIG. 3a, in some implementations, issues [303] may not be unique in some of the information which they are related to. For example, in implementations following FIG. 3a, articles [304] would also have some information (e.g., association with one or more notes) stored for them in common with issues [302] based on their descending from the same ultimate base class [305]. Of course, it should be understood that, as mentioned previously, while FIG. 3a and the associated disclosure used terminology related to classes, not all implementations of task tracking and allocation based on this disclosure will utilize classes (or, necessarily, any form of object oriented technology). The inventors contemplate that the teachings set forth herein can be implemented using non-object oriented technology (e.g., the Ruby on Rails web application framework).

Additionally, it should be understood that the relationships shown in FIG. 3a are intended to be illustrative only, and that other types of data or relationships could be maintained in some implementations. For example, as shown in FIG. 3b, some implementations might include information about projects [306], a type of entity not explicitly depicted in FIG. 3a. Such projects [306] could be used as a mechanism to help organize information such as articles [304] and issues [303], by grouping related information by subject matter into a specific container (i.e., the project [306]). Of course, as the inclusion of projects [306] in FIG. 3b is also intended to be illustrative only, and information on entities other than those shown in FIGS. 3a and 3b could be included as well. An example of such an entity, referred to as a record, is discussed below.

In some implementations, in addition to (or as an alternative to) the entities depicted in FIGS. 3a and 3b, there might be records (which might have some of the same features as issues and articles, such as relationships with other objects, associations with notes, etc) stored containing attributes represented as key value pairs (e.g., “User ID” might be defined in a record as a small text field). These key value pairs might be predefined (i.e., a user creating a new record would only be able to decide on specific types of key value pairs to include in it). In an implementation with predefined key value pairs, the advance of knowledge of what key value pairs exist could be used to optimize the system (e.g., a database storing the records could include a separate RecordID:Key:Value table for each type of attribute data, which could be used for fast searching of the database). Alternatively, it is possible in some implementations that records might include custom key/value pairs, where the user creating the record would specify information such as the key name, and the type of data. These custom key/value pairs could allow users to specify particular information which might be relevant to a particular record, but which might not be applicable generally. Of course, combinations of the described approaches are also possible (i.e., a user could choose between predefined key/value pairs and customized key/value pairs when creating a record). Accordingly, the discussion of records, like the discussion of FIGS. 3a and 3b above, should be understood as being illustrative only, and not limiting.

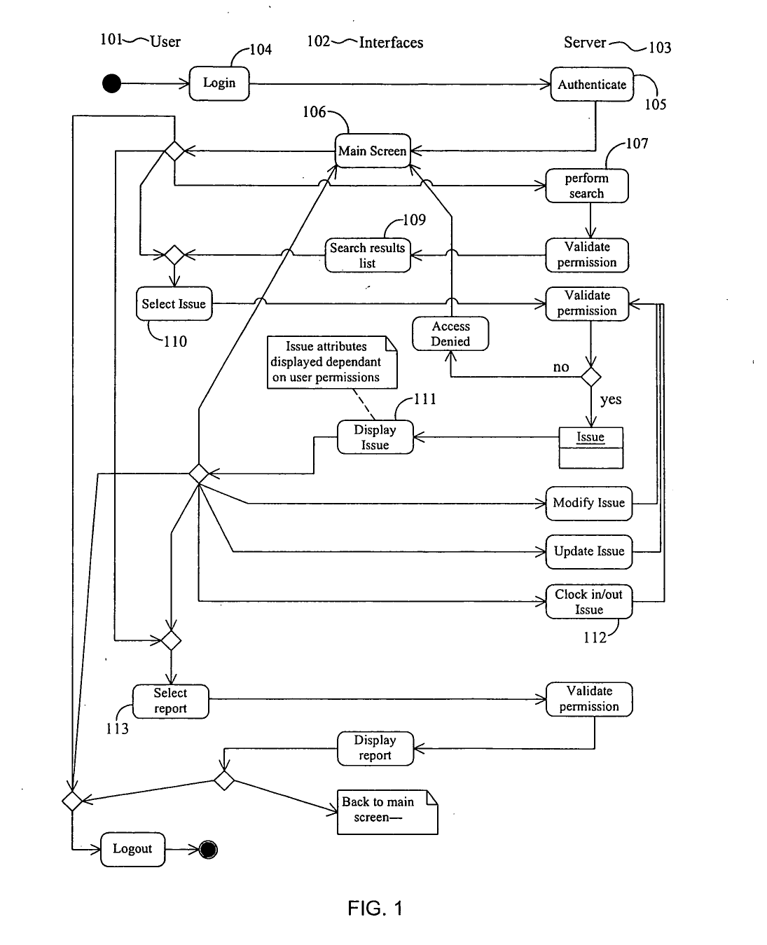

In practice, it is possible to implement the teachings of this document to create a system which can be used to perform tasks such as shown in FIG. 1. As shown in FIG. 1, a user [101] could use various interfaces [102] to interact with a server [103]. This could result in the server [103] updating information it maintains for task tracking and allocation, as well as performing tasks which do not directly affect the maintained data, such as validating that the user's permissions are compatible with the performance of specific acts. In some implementations, the server [103] could be implemented so that the interfaces [102] would be internet interfaces, accessible through any device capable of hosting a standard web browser. Alternatively, there might be interfaces [102] which would require special purpose software to be accessed by the user [101], or interfaces [102] which would allow the user to interact with the server [103] through standard software other than a web browser (e.g., SMS interfaces). Similarly, the server itself could be implemented using a variety of physical architectures, such as an individual computer, multiple devices linked together for redundancy (e.g., a RAID), or multiple devices which interact for performance (e.g., a Beowulf cluster). Accordingly, FIG. 1 should be understood as depicting possible uses for the technology disclosed herein, but should not be treated as implying any type of limitation on what types of tools or devices could potentially be used to implement that technology.

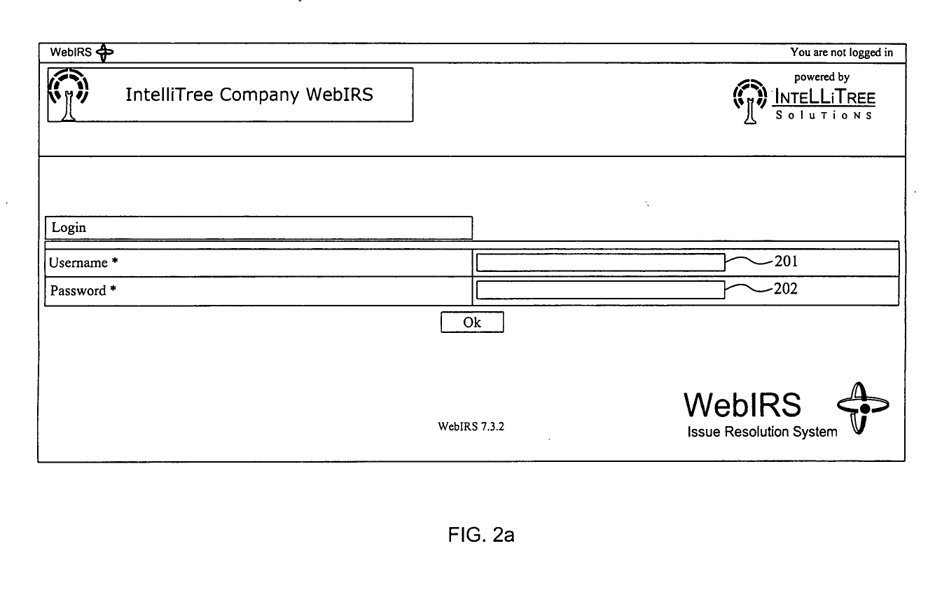

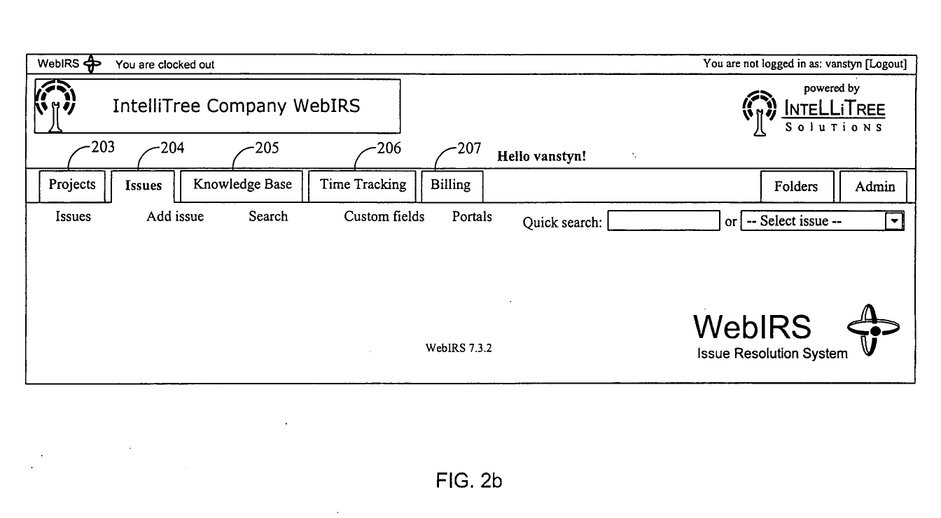

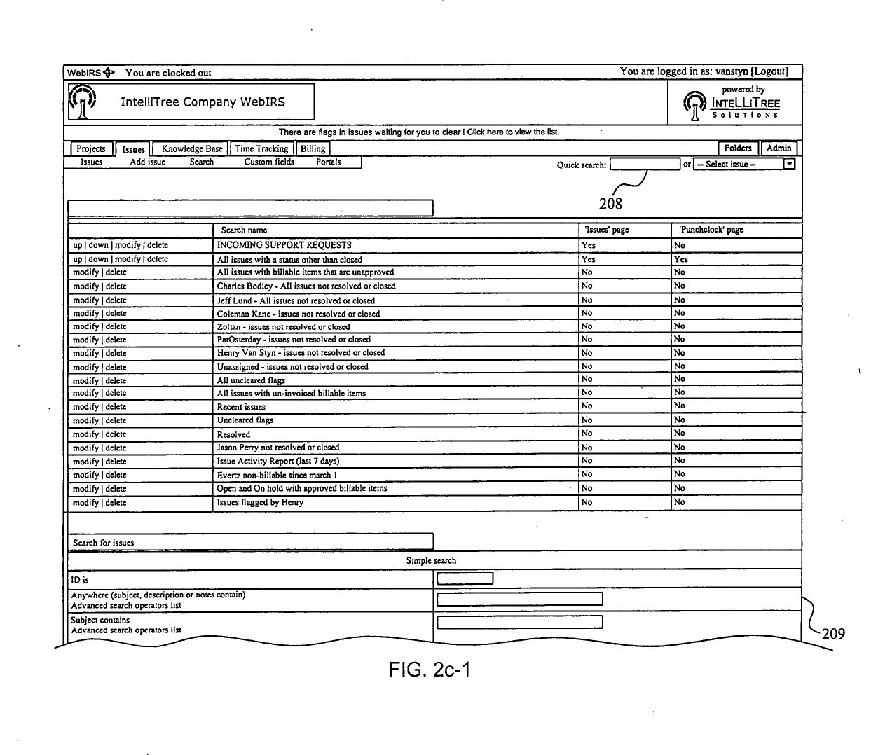

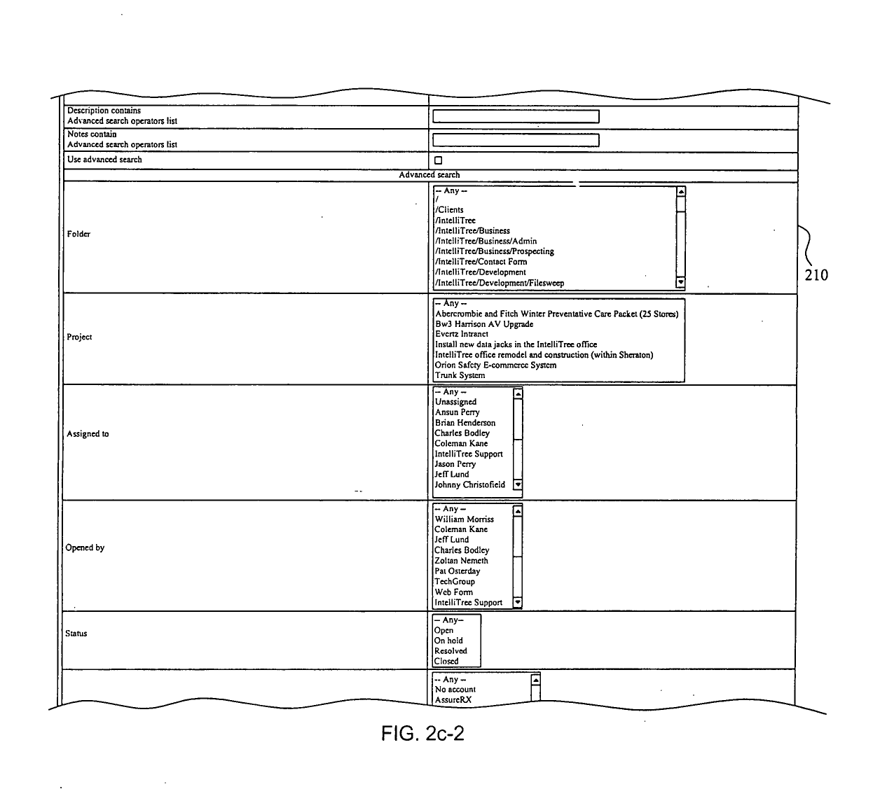

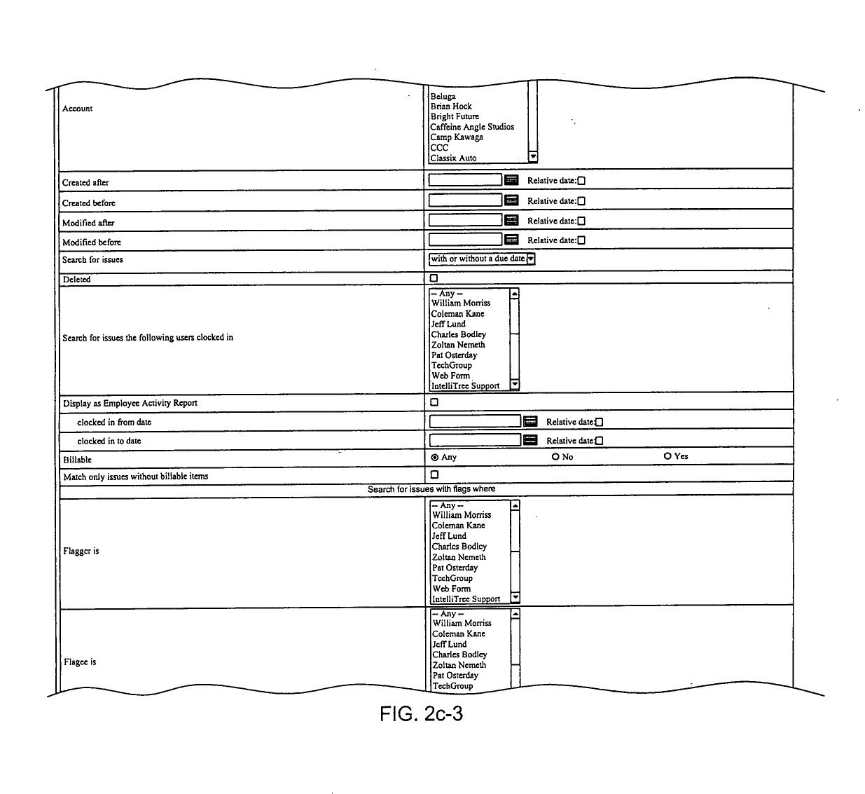

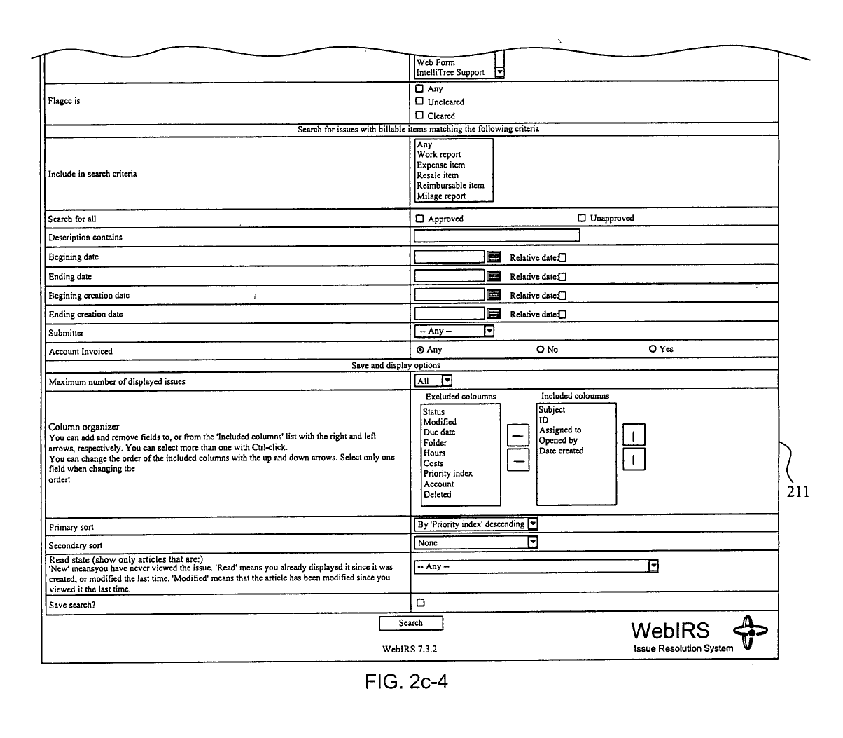

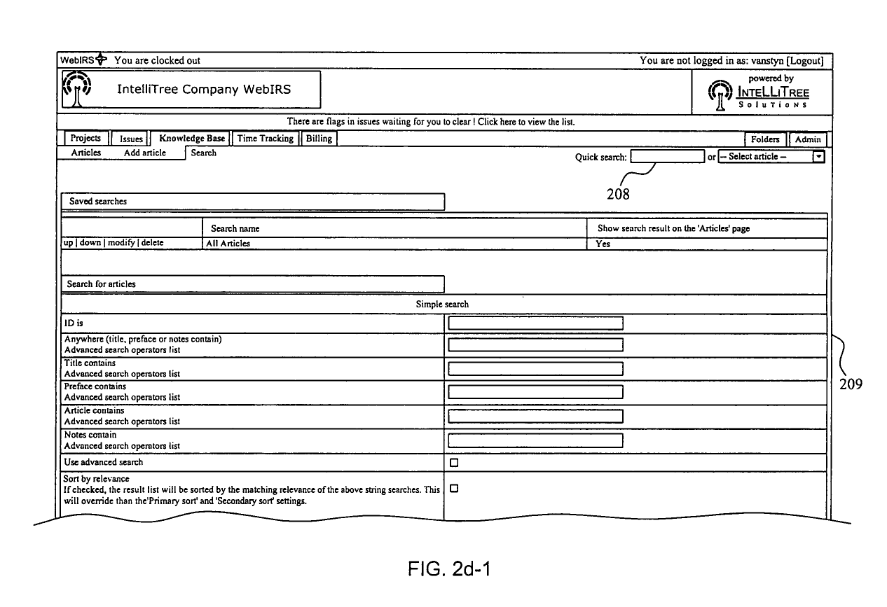

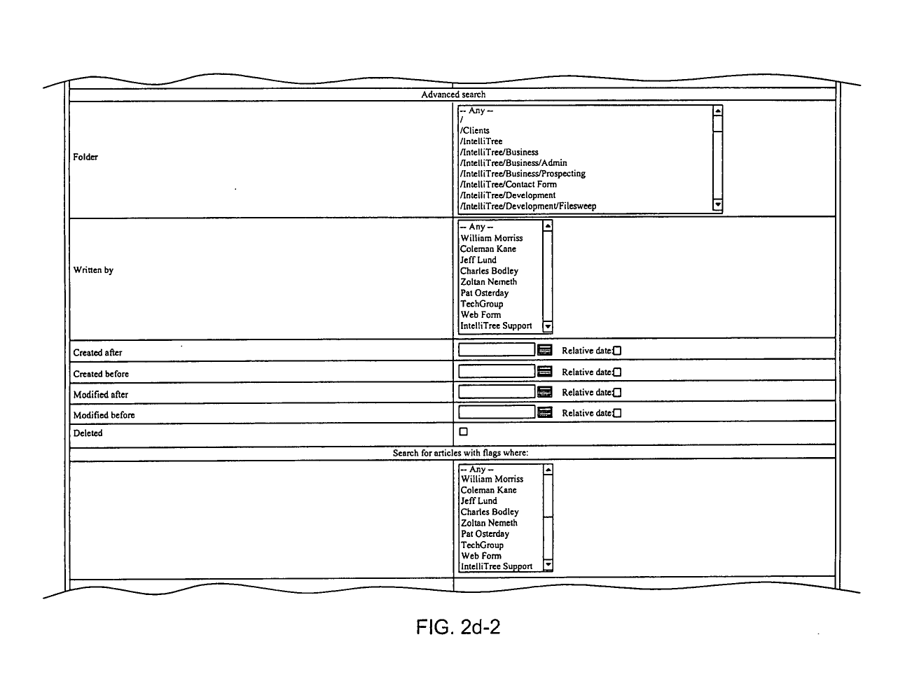

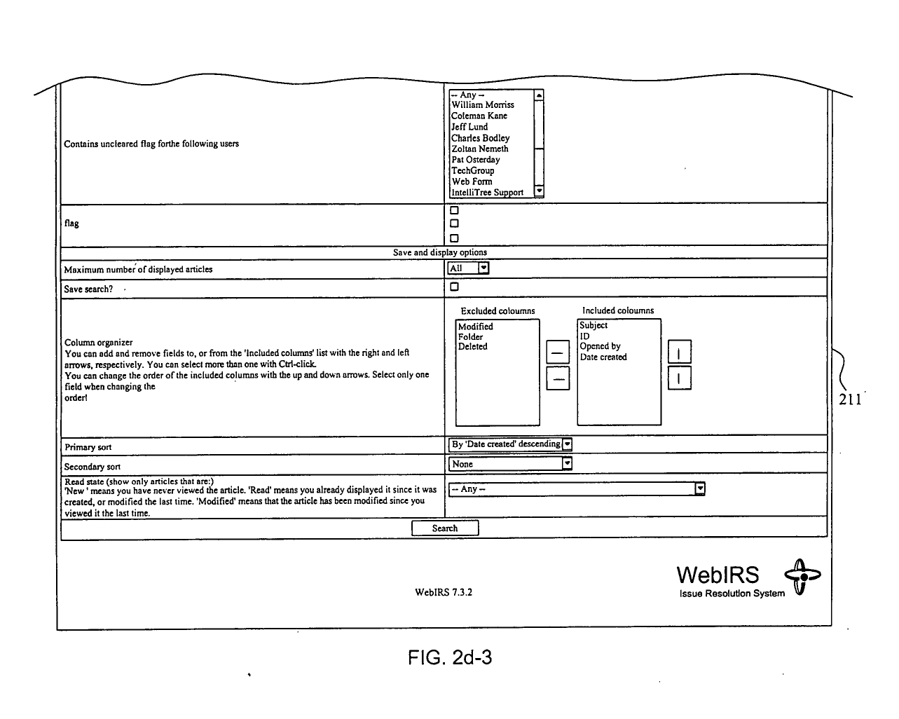

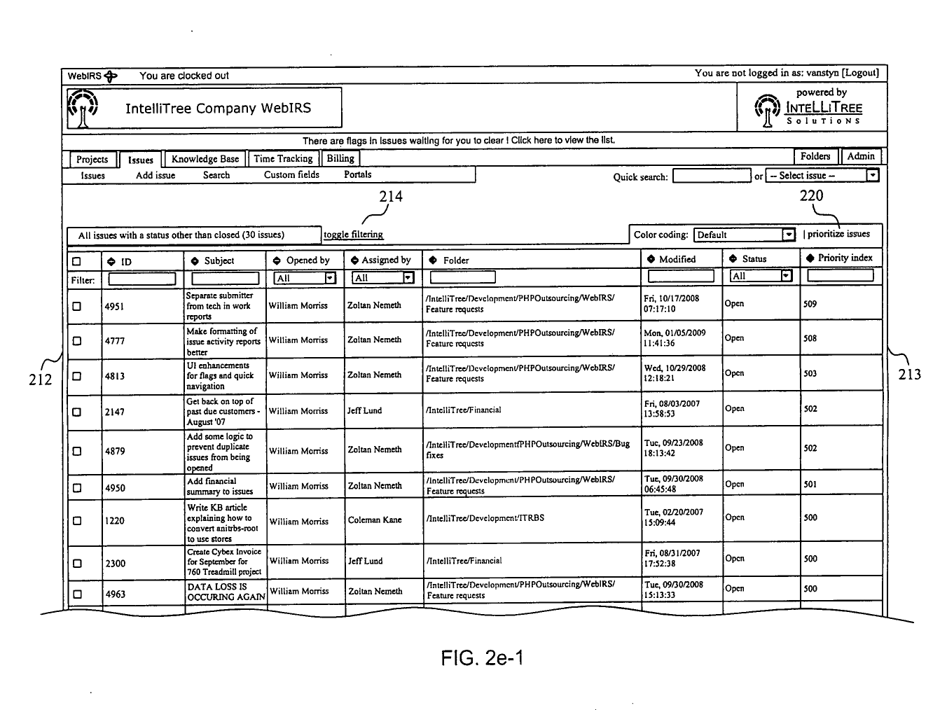

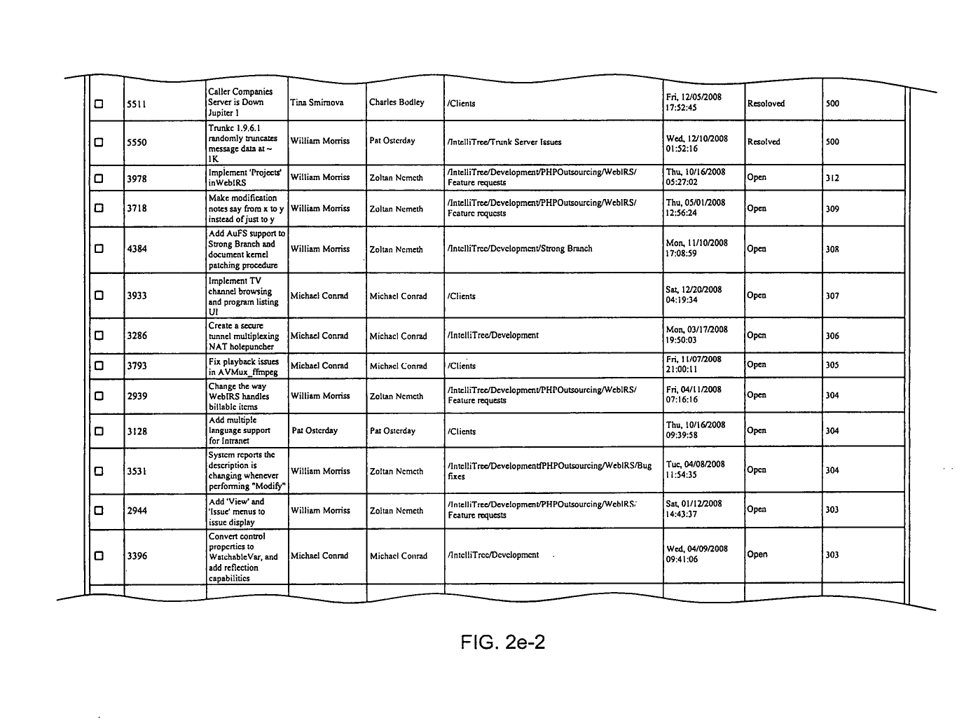

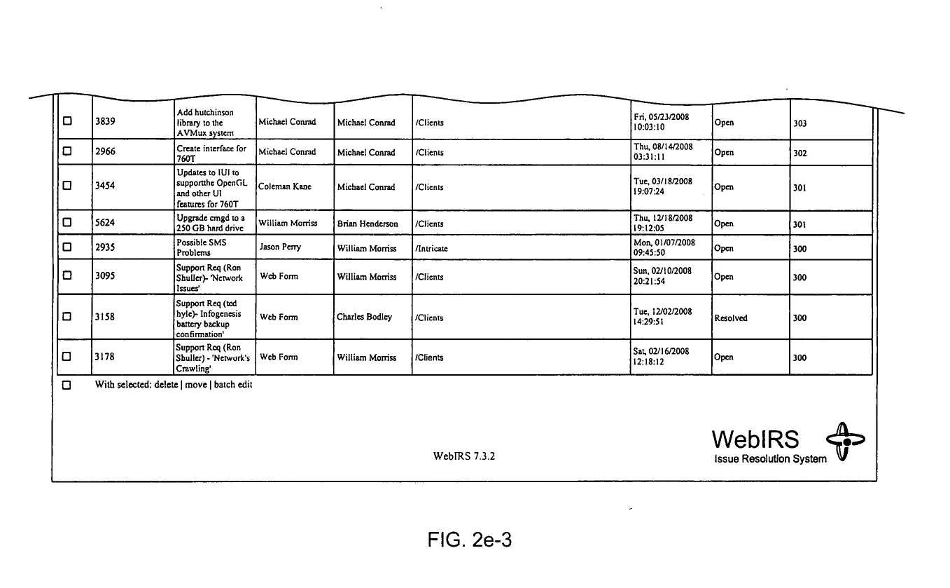

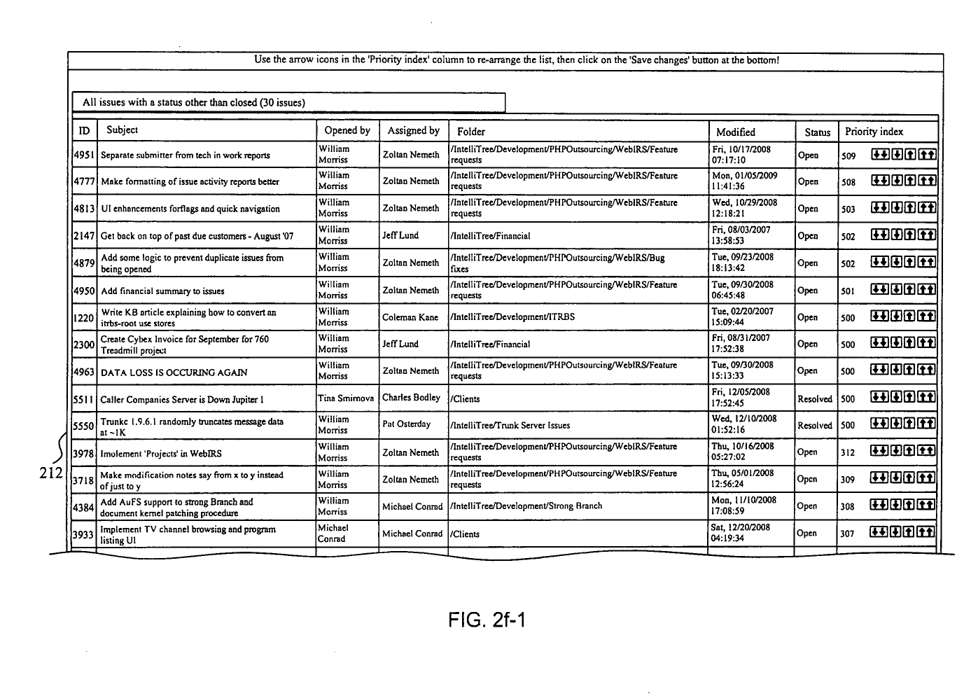

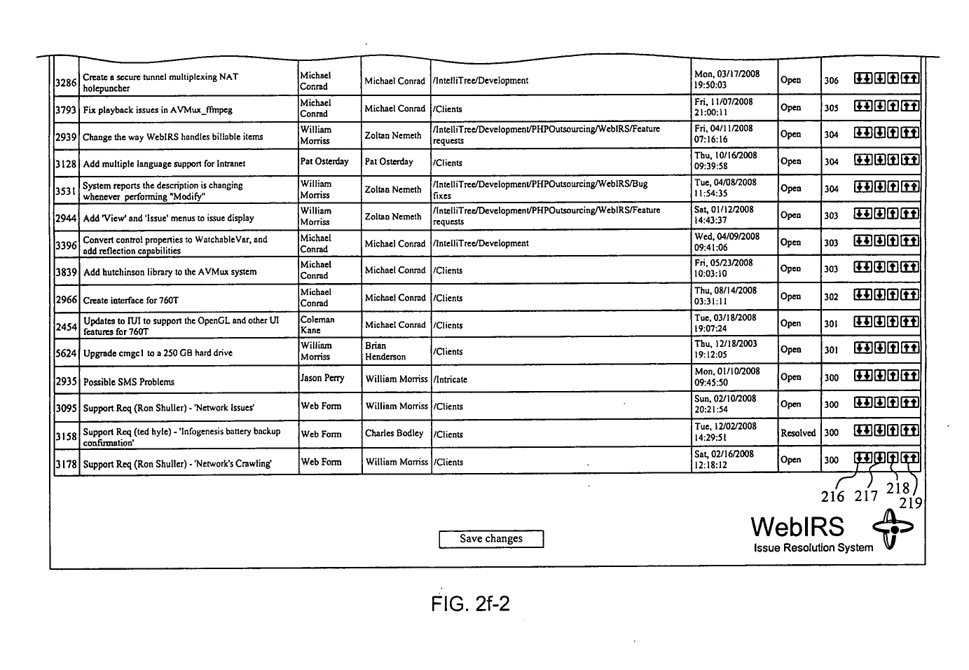

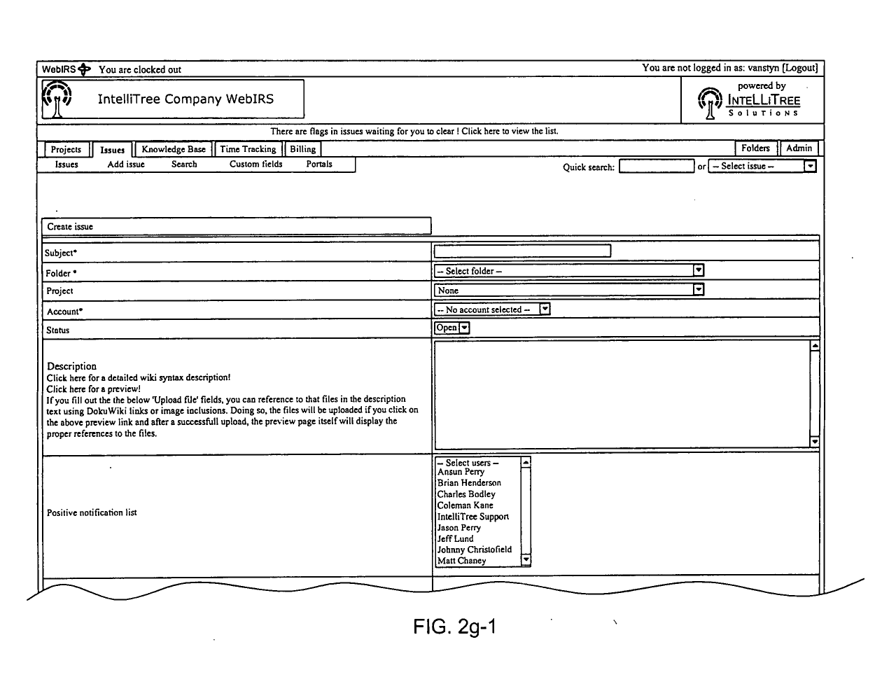

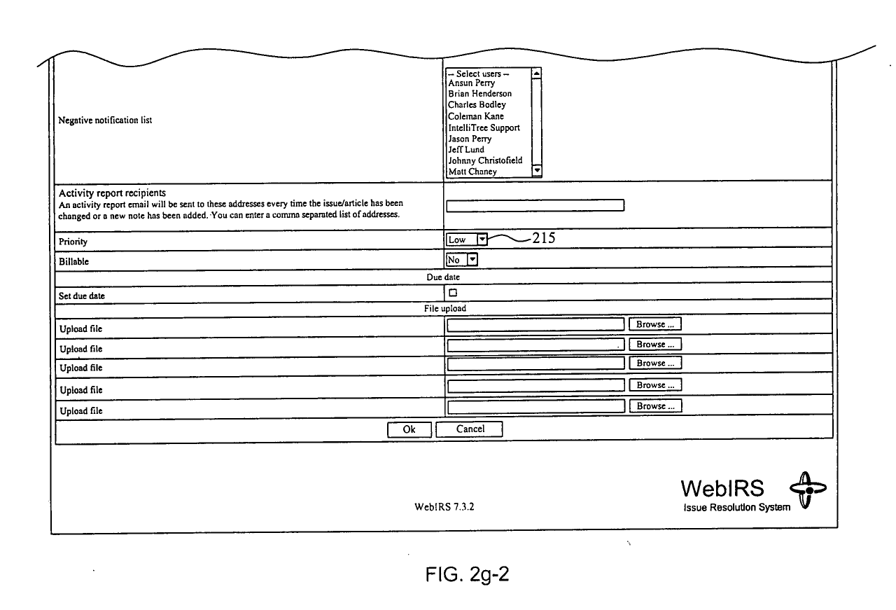

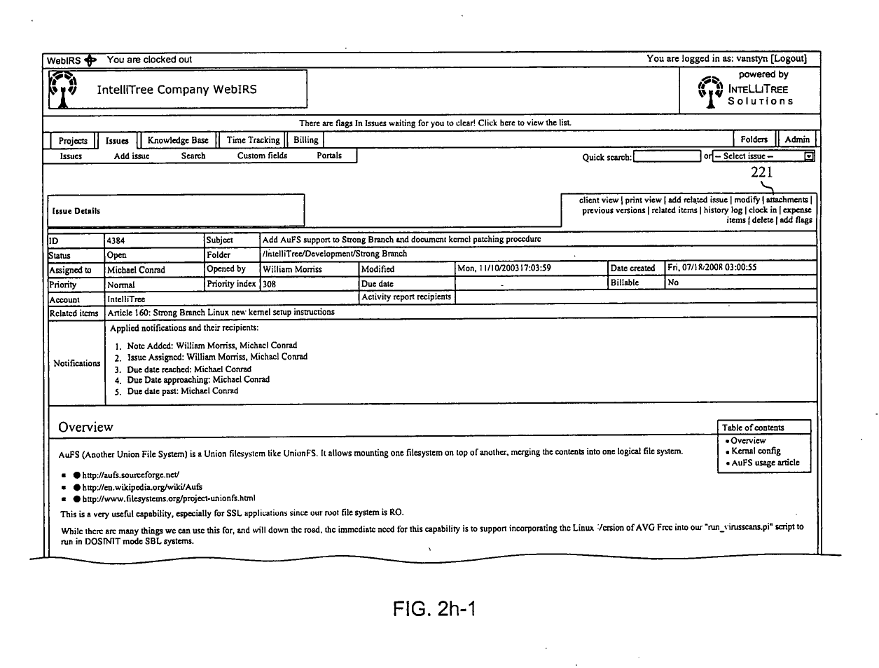

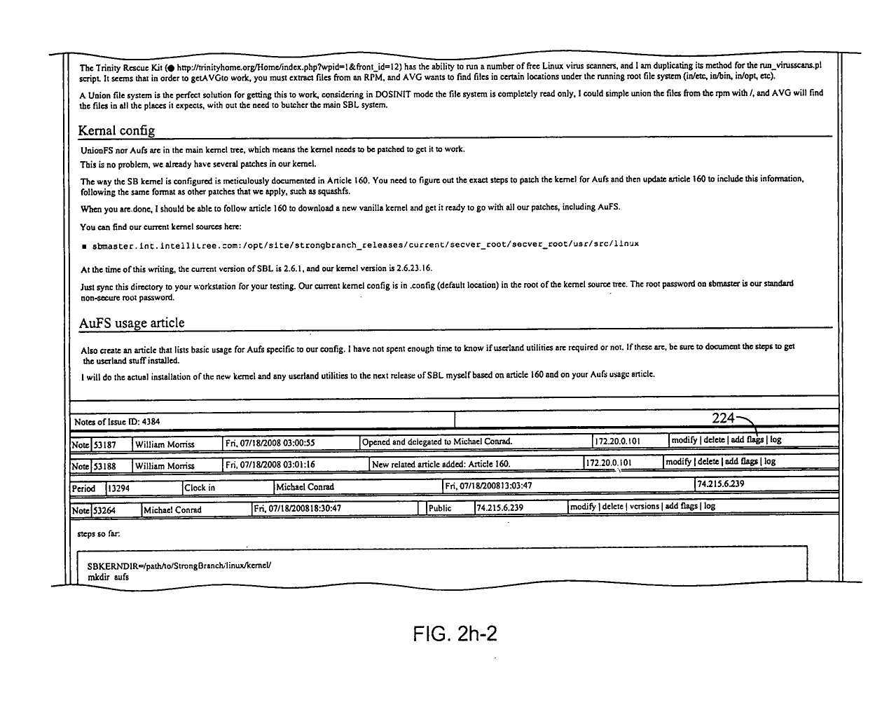

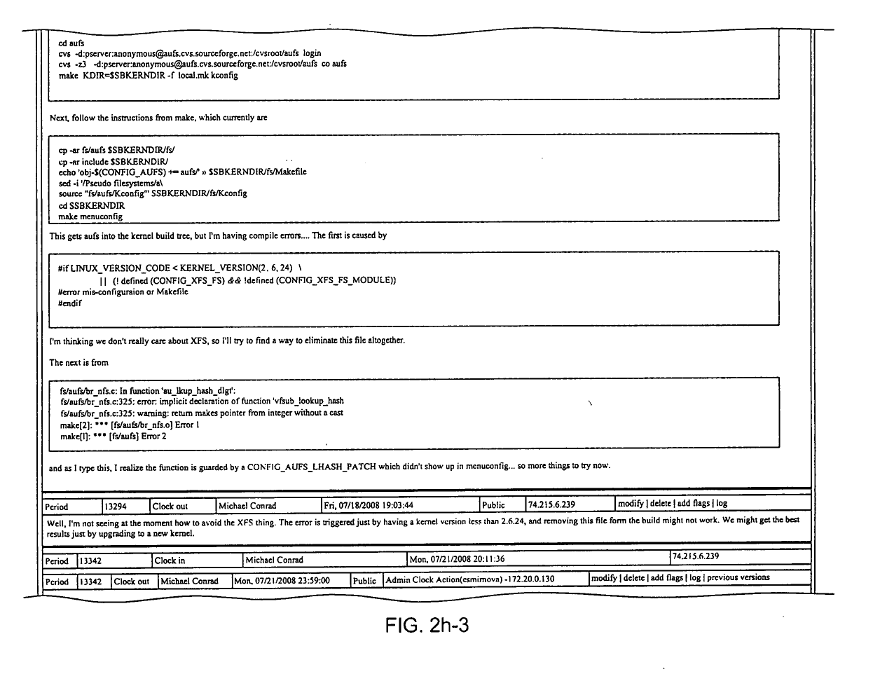

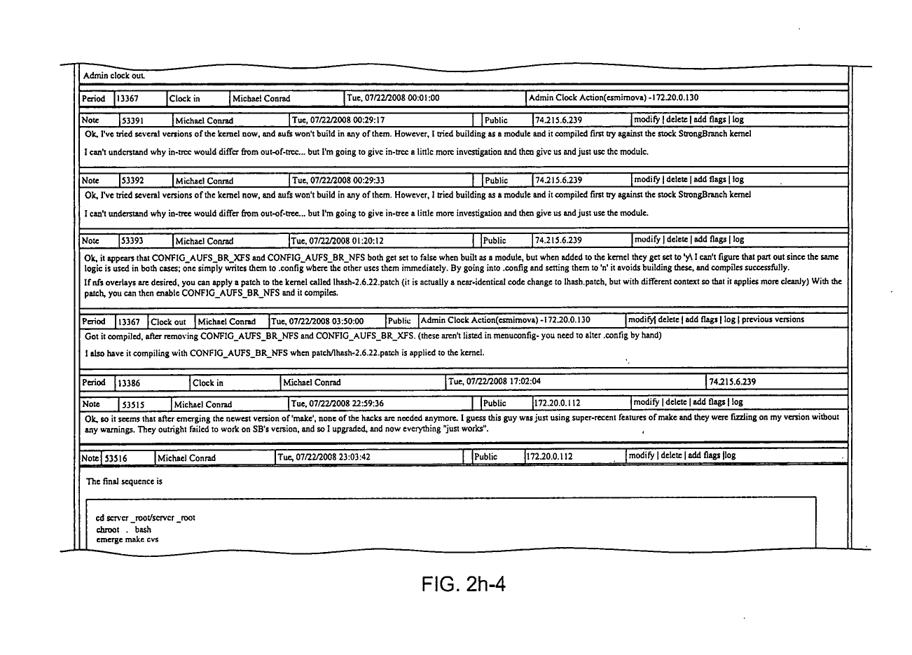

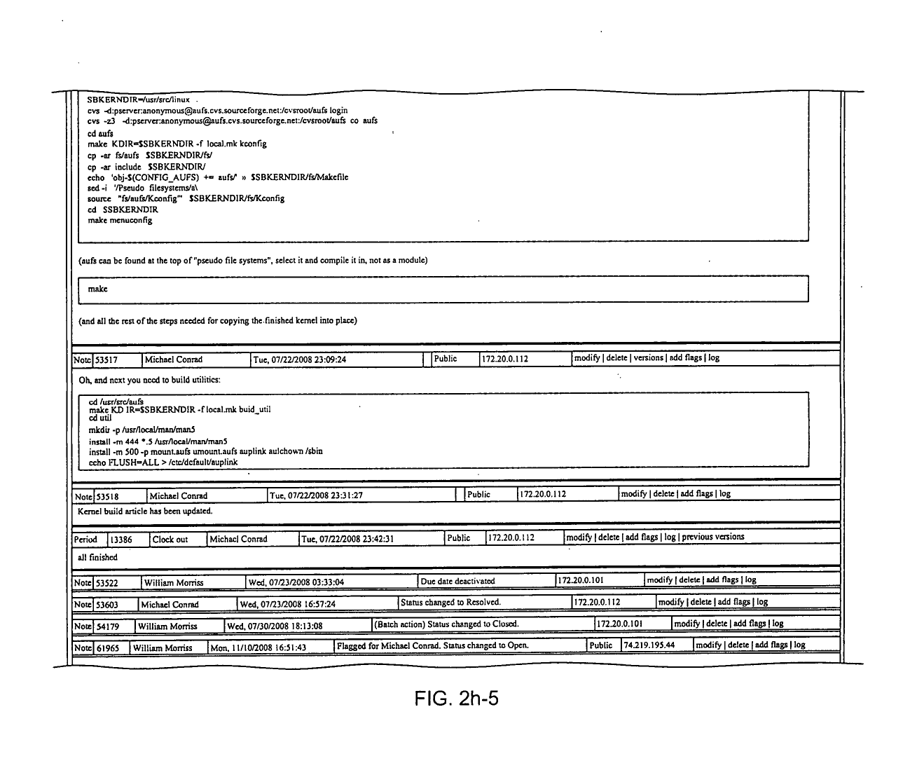

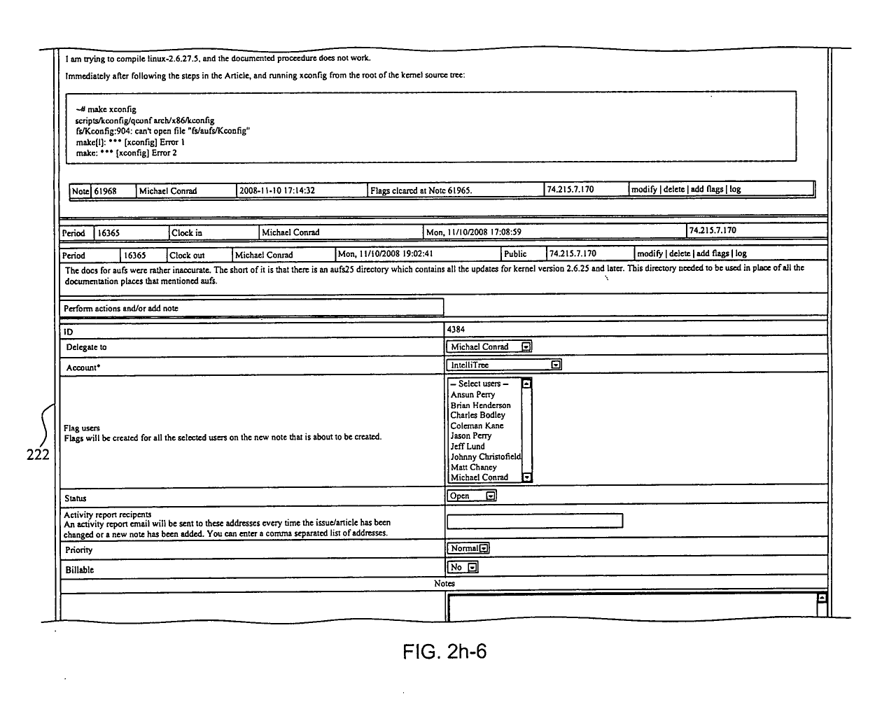

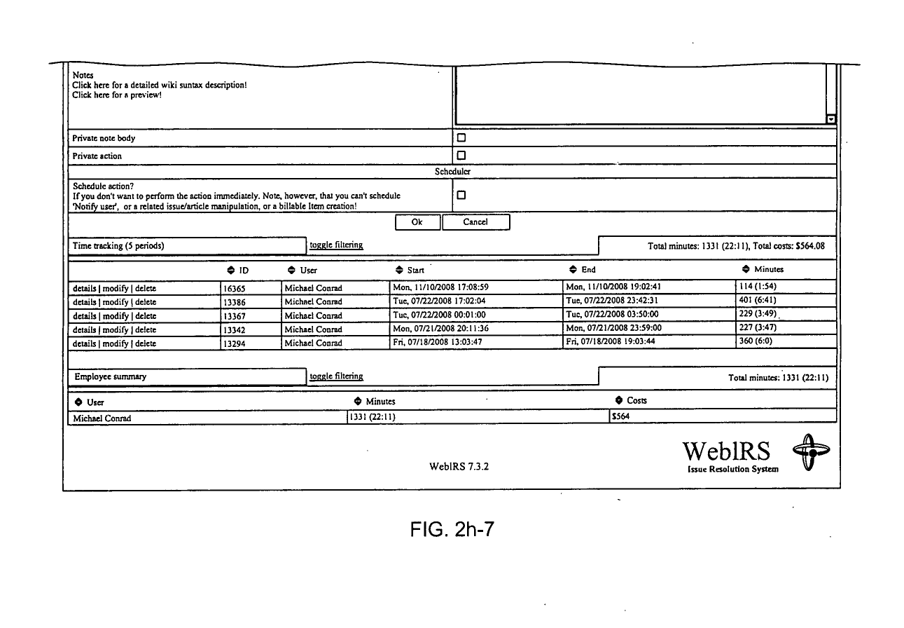

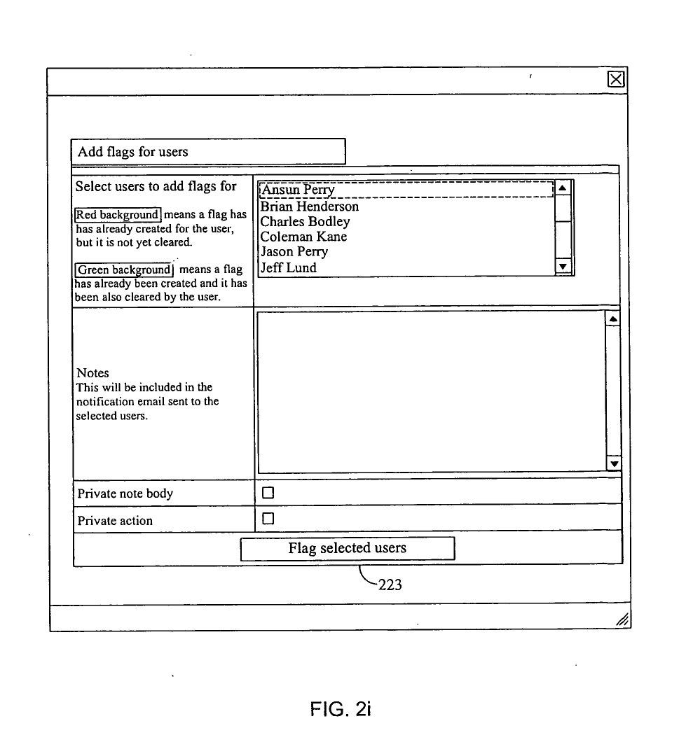

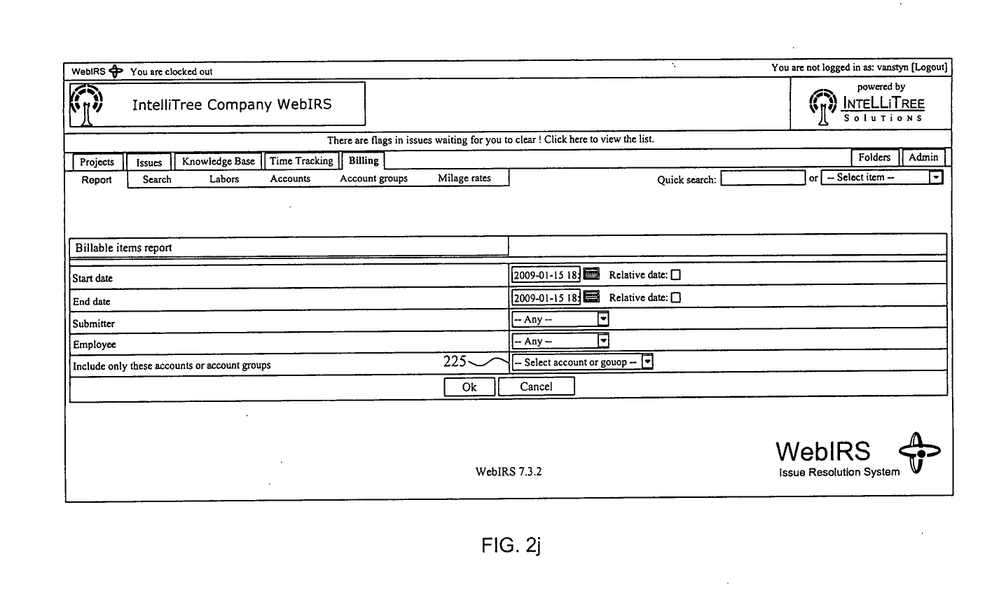

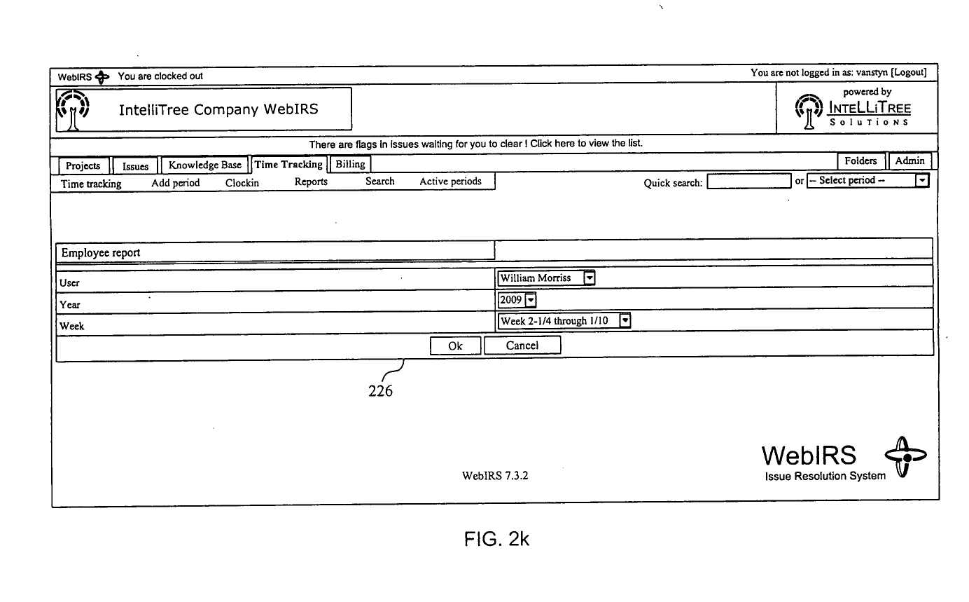

Initially, in the activities set forth in FIG. 1, a user [101] could login to the server [103], such as by using a login interface of the type depicted in FIG. 2a. In FIG. 2a, a user [101] is prompted to enter a username and password into (respectively) a username field [201] and password field [202]. In the sequence of events shown in FIG. 1, the information entered into the login interface would then be authenticated [105] by the server [103]. Once the user [101] had been authenticated (e.g., by finding a screen name and password combination in user records maintained by the system which matches the entered username and password), in the sequence of FIG. 1, a main screen [106] would be presented to the user [101]. Such a main screen [106] is an interface which could be used to navigate through the functionalities of the system. For the purpose of illustration, and exemplary main screen [106] which could be used in some implementations is presented in FIG. 2b. From a main screen [106] such as shown in FIG. 2b, the user [101] could use the project tab [203], issues tab [204], knowledge base tab [205], time tracking tab [206], and billing tab [207] to access various aspects of the system.

One of the functionalities the user [101] could access from the main screen [106] is to search [107] for issues having certain characteristics. As discussed previously, the teachings of this disclosure could be implemented in a system which would maintain certain information regarding issues, such as a client on whose behalf work on an issue is performed, and notes created for the issue. The disclosure herein could allow a user [101] to search through the information related to issues, for example, using a dedicated search interface such as shown in FIG. 2c (separated into views on FIGS. 2c-1 through 2c-4). As shown in FIG. 2c, a variety of tools could be provided for a user [101] to specify what he or she was searching for, such as a quick search tool [208] (such a tool could be designed to let the user [101] enter text then automatically perform a common search, such as a full text search of all notes), a simple search tool [209] (e.g., a searching tool which allows the user [101] to search for the ID of an issue, or to search if text is located in various fields related to an issue), and an advanced search tool [210] (e.g., a tool which allows the user [101] to consider metadata related to an issue, such as who an issue is assigned to, the status of the issue, etc). Additionally, as shown in FIG. 2c, a system could be implemented so that the user [101] could save the search performed, for example by defining the information requested in the saving tool [211].

Of course, it should be understood that searching [107] is not limited to searching for issues as depicted in the exemplary interface of FIG. 2c. Depending on the implementation, other types of information (e.g., articles containing useful knowledge which could be applied in completing tasks) could also be searched. An exemplary interface for searching articles is depicted in FIG. 2d (split into views 2d-1 through 2d-3), though it should be understood that the interfaces of FIGS. 2c and 2d are intended to be illustrative only, and are not intended to indicate that searching interfaces would include all, or only, elements shown in those interfaces. Similarly, it should be understood that the inventors contemplate that searches could be implemented for other types of information beyond issues and articles, and that the interfaces shown for issues and articles are intended to be illustrative only of types of searches which could be created. Accordingly, the discussion of searching above, as well as of FIGS. 2c and 2d should not be treated as implying limitations on the scope of claims included in this document or any document claiming the benefit of this document.

After the search has been performed [107] the user [101] could be presented with the results of the search, for example, in the form of a list. The user [101] could then search the result list [109] to determine which issue is the most pressing, and then select [110] and begin work on that issue. Additionally, in some implementations, it is possible that the interface presented to the user [101] for the search of the results list [109] could include tools which could be used to facilitate or guide the search. To illustrate this, an example search result interface is shown in FIG. 2e (split into views 2e-1 through 2e-3). In the interface of FIG. 2e, a user is presented with a list [212] of issues which meet the search criteria, along with a filtering tool [213], and a toggle [214] which could hide or make the filtering tool [213] available as needed. The filtering tool [213] in turn could be used to specify attributes of the search results in the list [212] which could be used to hide some portion of the search results so as to facilitate the user [101] selecting an issue [110] to work on (e.g., limit displayed issues to only those having a certain status).

Also, as shown in FIG. 2e, the search results in the list [212] could be ordered based on an assigned priority for each issue. This could allow the user [101] to more easily identify what issue to work on. Such a priority could be implemented in a variety of ways, such as a numeric value or a priority category (e.g., high, low, medium). The specific priority for an issue could be determined using a variety of techniques. For example, when an issue is created (e.g., using an interface such as shown in FIG. 2g), the entity creating the issue could affirmatively assign a priority. This priority value might be assigned in a final form (e.g., where the priority is represented by the system in terms of a numeric value, the priority could be assigned by entering that numeric value) or could be assigned using some other method then transformed into a final form by a program on the server [103]. As an example of this latter approach, a priority selector [215] could allow a user to assign a priority of “Low”, “Normal”, “High” or “Urgent”, and that assignment could then be translated into a final value, such as 100 for low, 200 for normal, 300 for high, and 500 for urgent.

As another approach to assigning a priority for an issue, a priority could be automatically determined by a program as opposed to being assigned by the entity creating the issue. For example, the server [103] could be configured to consider data related to the issue such as its due date, the client (if any) the issue is associated with, whether the issue is billable, and other information in order to determine a priority. As an example of this approach, some systems could be implemented such with certain attributes having specific positive or negative effects on the priority (e.g., issues with closer due dates would be given higher priority; issues associated with high value/volume clients would be given higher priority; etc. . . . ) Other variations are also possible. For example, the teachings of this disclosure could be implemented in a system where a priority would be assigned based on a combination of software calculation and user selection. For instance, a user selection of a priority category could result in the issue being assigned an initial value (e.g., 200 for normal) and that initial value could then be automatically modified based on other information about the issue (e.g., +50 for a deadline within less than five business days, −50 for nonbillable internal projects, etc. . . . ) Accordingly, it should be understood that the explicitly disclosed techniques for assigning a priority are intended to be illustrative only, and should not be treated as limiting on claims included in this document or any related document.

In some implementations it might also be possible to modify the priority of an issue after it has initially been assigned. As with the initial definition of priorities, such modification could be programmatic, user driven, or both. As an example of programmatic modification of priorities, in some implementations, there could be software which would cause issues to increase in priority as their deadline approached. As another example, in some implementations, there could be information stored regarding the clients associated with issues, and the issue priorities could be updated as the client information is updated (e.g., if a client upgrades a service level agreement, then the priority for all issues associated with that client could be increased). As an example of human modification, in some implementations, this might take place simply by using an interface such as discussed above with respect to FIG. 2g (split into views 2g-1 through 2g-2) when the priority of the issue was first defined. Alternatively, a different interface could also be used. An example of an interface which a human could use to modify the priority of issues is depicted in FIG. 2f (split into views 2f-1 through 2f-2), discussed below.

FIG. 2f depicts an interface which could be used to modify the relative priorities of issues from a list [212] of results returned by a search. In some implementations, the reprioritization interface of FIG. 2f could be accessed directly from a search interface such as shown in FIG. 2e by activation of a prioritize issues selector [220]. Once the interface of FIG. 2f is presented, the user [101] can utilize the minimize priority tool [216], the decrease priority tool [217], the increase priority tool [218] and the maximize priority tool [219] to change the relative priorities of issues from the list [212] of FIG. 2e. For example, the minimize priority tool [216] could be used to change the priority of an issue so that that issue would move to the bottom of the list [212]. Of course, other types of priority changes, such as priority changes which are made relative to all issues, rather than the issues represented in the list [212] returned by a search are also possible. Additionally, it should be understood that the prioritization of issues is not necessarily tied to any particular search, and that some implementations might allow users to modify a priority value for individual issues, or for all issues, and that such a prioritization might be either relative (e.g., modify the priority of an issue so that it is higher than the ten issues currently ahead of it) or absolute (e.g., add one to a′numeric value representing the priority of an issue). Accordingly, the specific list, as well as the discussion of relative modification of priorities set forth with respect to FIG. 2f should be understood as illustrative only, and not limiting.

Continuing with the discussion of the activities shown in FIG. 1, once a user [101] has selected an issue [110], the software stored on the server [103] could display [111] that issue to the user [101]. In different implementations, the interface presented to the user [101] to display [111] the issue might vary based on the information stored by the system. To illustrate on such interface, FIG. 2h (split into views 2h-1 through 2h-7) depicts an interface which includes, among other things, notes and priority information about the issue displayed. Additionally, the interface of FIG. 2h also includes tools that the user [101] can use to facilitate the tracking of work done on the issue. For example, FIG. 2h includes a clock in tool [221] which could be used by the user [101] to indicate starting work on the issue. In some implementations, activation of the clock in tool [221] could result in a signal being sent to the server [103] which would cause the server record when the user [101] begins work, and the issue the user [101] was viewing when the clock in tool [221] was selected. As a complement to the clock in tool [221], some implementations might also include a clock out tool (not shown). The clock out tool could be used to generate a signal which would cause the server [103] to modify the data stored in its memory to indicate that the work period initiated by selection of the clock in tool [221] was complete.

In addition to (or as an alternative to, depending on the implementation) tools used to facilitate tracking of work done on an issue such as described, an interface such as shown in FIG. 2h could include tools which could be used to facilitate communication among different users. As an example of such tools, consider the flag tool [222] depicted in FIG. 2h. The flag tool [222] can be used to identify specific users of the system who should be informed (“flagged”) about an action or change made to an issue (e.g., the addition of a note). In an implementation in which the server [103] maintains contact identifications for individual users, those contact identifications can be used to send notifications to each of the users who had been identified using the flag tool [222]. The notifications can also include certain information about the action taken when the flag tool [222] was used. For example, if the flag tool [222] was used in conjunction with the creation of a note having a textual body, then the notification sent to the identified users could comprise the textual body of the note.

Additionally, in some implementations, using a flag tool [222] might also result in the storage of data by the server [103] indicating that a “flag” had been created. This type of information could be used to create, for each user who had been indicated to receive a notification by a flag tool [222], a list of issues which had been “flagged” to that user. Such a list could be used as an alternative to the searching tools described previously when determining what issues should be worked on. Of course, it should be understood that the discussion of flagging in the context of FIG. 2h and the flag tool [222] is illustrative only, and that variations could be implemented in light of this disclosure. For example, in some implementations there might be an entity level flag tool [224] which would allow a user to specify that a note (or other appropriate entity) should be flagged to one or more other users. In some implementations, this would proceed by the user selecting the entity level flag tool [224], and then being presented with a dedicated flagging interface such as shown in FIG. 2i. The user could use the flagging interface to identify who should receive notifications, then activate the send flag tool [223] to have the identified users notified. Of course, other variations are also possible, and could be implemented by one of ordinary skill in the art in light of this disclosure. Accordingly, the discussion of flagging set forth above should be understood to be illustrative only, and not limiting.

As shown in FIG. 1, in addition to the issue search, selection and modification functionalities described, a user [101] could also use the disclosed task tracking and allocation technology to select a report [113] which should be displayed. As an example of how this report selection might be performed, consider the interface of FIG. 2j. In the interface of FIG. 2j, a user [101] could use the client selector [225] to identify a specific client account which the user [101] would like to see all billable items for. In addition, using an interface such as shown in FIG. 2j, the user [101] could specify start and end dates for the billable items which should be displayed, as well as specify one or more users who should be associated with the information displayed. The resulting report shown could then be used for purposes such as accounting, generating invoices, auditing, or evaluating client profitability. Additionally, in implementations in which users would clock into and out of issues as they were working on them, the report displayed to the user [101] might include real time information about work being done as the report was being generated. Of course, it should be understood that the interface depicted in FIG. 2j, as well as the functionality associated therewith are only indicative of types of reports which might be created using technology implemented according to this disclosure. The creation of other types of reports is also possible. For example, as shown in the interface of FIG. 2k, there could be interface which would present the user with a more specialized employee level report tool [226] which could allow the user [101] to quickly examine work done by a particular individual in a specified time period. Accordingly, discussion of creation of reports, as well as the interfaces connected therewith, should be understood as being illustrative only, and not limiting on the claims included in this application or any other application claiming the benefit of this application.

While the discussion of FIG. 1, and the interfaces of FIGS. 2a-2k focused largely on functions related to issues and reporting, the technology disclosed herein is not limited to those aspects of the system. As an example of an additional use of technology set forth herein, consider the use of records for tracking physical equipment in an information technology setting. Such use could be facilitated by the creation of records having key/value pairs indicating the physical attributes of specific pieces of equipment (e.g., a MAC address for an Ethernet card), the relationship to other pieces of equipment (e.g., a part of/contains relationship for peripherals and base systems, what the equipment is connected to), and the location of the equipment (e.g., office of client X, cubicle Y). With such records, an interface could be created which would allow a user to call up information for a particular piece of equipment, and then trace the relationships for that piece of equipment (e.g., what network jack is an Ethernet card plugged in to, what router manages signals from this device) to accomplish tasks such as verifying that the equipment is properly deployed, or identifying the source of a problem reported for the equipment. Additionally, in implementations in which records can be related to other entities (e.g., articles, issues, etc. . . . ) a user might examine the relationship of the record for a piece of equipment to past issues to determine if the piece of equipment itself might be faulty and require replacement.

It should be understood that the example of using records to track physical equipment set forth above is intended to be illustrative only, and not limiting. Records, as well as the other types of information which could be maintained in a system implemented according to this disclosure could be used in a variety of settings. For example, in the sales context, the technology disclosed herein could be used to track and ensure follow up on sales leads (e.g., an issue might be to research and contact a particular prospect, a record might store social relationships of specific individuals, etc). Indeed, while special purpose implementations of the technology set forth herein could be created, the disclosure of this application is broadly applicable, and should not be limited to any particular subject matter or field of use.

Further, even in the context of issues and reporting, it should be understood that FIG. 1, the interfaces of FIGS. 2a-k, and the related text are intended to be illustrative only, and that certain implementations might support other workflows and/or methods of operation. As an example of such an alternative, consider the case where a server [103] is implemented so that users can contact it through non-browser tools, such as SMS messages. In such an implementation, a user could call the server [103], and then send an SMS message with a command to be executed, along with zero or more arguments to go with the command. For example, a system could be implemented so that a user could send a message “clock in issue 1234” where 1234 is a number uniquely identifying a particular issue in the system, and the server could then match the number the message was sent from against a recorded number for a particular user stored in a user record, and record the time the message was sent as the time the user associated with the number begins work on the issue. Clock out (and other commands) could be implemented in a similar manner.

Variations other than allowing non-browser interactions are supported as well. For instance, some individuals (e.g., contract employees who are hired for a specific project or task only) may not need to search for issues and decide what to work on. In such a case, software on a server [103] could be set up so that, if a user has permission to work on a single issue only, as soon as that user logged into the system, that user would automatically be clocked into that issue, and would be automatically clocked out again upon logging out. Alternatively, the user could be presented with a simplified interface which would allow the user to clock into/out of the particular assigned issue without having to log in/out of the system to do so. As another example of additional functionality which could be included, in some cases there could be interfaces for users who would only create issues (e.g., a tech support interface where users could submit requests for assistance) and would not need/want to search for other information in the system.

Another additional feature which could be used in a system for task tracking and allocation, consider the feature of permissions and access restrictions, which could be used to limit information which could be viewed, and acts which could be taken, by users. Such permissions and access restrictions could be specified in an implementation by organizing information stored for task tracking and allocation into folders, and giving users permissions relative to the specific folders. Such permissions might include permissions such as depicted in Table 1.

TABLE 1
Exemplary Permissions

| | |
|---|---|
| Read Issues | Access to read issues, except parts marked private |
| Read Issues Private | Access to read parts of issues marked as private |
| Read Articles | Access to read issues, except parts marked private |
| Read Articles Private | Access to read parts of articles marked as private |
| Post Notes Issues | Access to post notes in issues, can post private |
| | notes if has Read Issues Private |
| Post Notes Articles | Access to post notes in articles, can post private |
| | notes if has Read Articles Private |
| Create Issues | Create new issues. Can create issues with private |
| | custom fields is has Read Issues Private |
| Create Articles | Create new articles. |
| Modify Issues | Modify issues and notes. Can modify private parts |
| | if has Read Issues Private |
| Modify Articles | Modify articles and notes. Can modify private parts |
| | if has Read Articles Private |
| Create Sub-Folders | Can create sub folders. Sub folders are created with |
| | the permissions of their parent |
| Self Delegate | Can Delegate Unassigned issues to self |
| Delegate | Can Delegate issues to anyone |
| Clock In | Access to clock into issues |
| View time periods | Access to view time clocked in issues, except |
| | employee rate information |
| View time period rates | Access to view employee rates in time clocked in |
| | issues |
| Add work reports | Access to add work reports. Access to view work |
| | reports with time, excluding rate information (tech |
| | and account). |
| Add expense items | Access to add expense items. Access to view |
| | expense items, except rate information (cost and |
| | resell). |
| View billable items | Access to view cost components of billable items: |
| costs | tech rate/total in work reports, item cost in expense |
| | items. |
| View billable items | Access to view resell rate components of billable |
| resell rates | items: account rate/total in work reports, resell rate |
| | in expense items. |
| Approve Billable Items | Access to Approve Billable Items |
| Mark Billable Items | Access to Mark Billable Items Invoiced |
| Invoiced | |
| Modify Billable Items | Access to Modify Billable Items |
| Set issues On Hold | Access to set the status of issues to On Hold. |
| Set issues Closed | Access to set the status of issues to Closed. |
| Schedule Actions | Access to create scheduled actions on issues. |
| | (Everyone can now see scheduled actions) |
| View previous | Access to view previous versions of objects. |
| versions | |
| Administrator | Can Set Permissions |
| Delete | Can delete the folder if there are no objects inside it |
| Read Records | Access to view Records, excluding attributes |
| | marked as private |
| Read Records Private | Access to read attributes in Records marked as |
| | private |
| Post Notes Records | Access to post notes in Records, can post private |
| | notes if has Read Records Private |
| Create Records | Access to create Records. Can create Records with |
| | private attributes if has Read Records Private |
| Modify Records | Modify Records and notes. Can modify private |
| | parts if has Read Records Private |
| Delete Records | Access to mark Records as deleted |
| Lock/Unlock Locks | Access to lock or unlock existing locks (they would |
| | obviously need to also know the passphrase) |
| Modify Locks | Access to Create, Remove, and change the |
| | passphrase of locks |

Following that structure, in some implementations there might also be groups of permissions implemented and given descriptive names so that a user could have their permissions defined by simply assigning a predefined group of permissions, rather than requiring individual permissions to be set separately. A set of exemplary permission groups is set forth below in Table 2.

TABLE 2
Exemplary Permission Groups

| | |
|---|---|
| Outside Observer | Read Issues |
| | Read Articles |
| | Read Records |
| Client/Account Observer | Read Issues |
| | Read Articles |
| | View billable items resell rates |
| | Read Records |
| Basic Observer | Read Issues |
| | Read Issues Private |
| | Read Articles |
| | Read Articles Private |
| | Post Notes Issues |
| | Post Notes Articles |
| | View Time Periods |
| | Read Records |
| | Read Records Private |
| | Post Notes Records |
| Advanced/Financial | Read Issues |
| Observer | Read Issues Private |
| | Read Articles |
| | Read Articles Private |
| | Post Notes Issues |
| | Post Notes Articles |
| | View Time Periods |
| | View Time Period Rates |
| | View billable items costs |
| | View billable items resell rates |
| | View Previous Versions |
| | Read Records |
| | Read Records Private |
| | Post Notes Records |
| Basic Performer | Read Issues |
| | Read Issues Private |
| | Read Articles |
| | Read Articles Private |
| | Post Notes Issues |
| | Post Notes Articles |
| | Create Issues |
| | Create Articles |
| | Self Delegate |
| | Clock In |
| | View Time Periods |
| | Add Work Reports |
| | Add Expense Items |
| | Set Issues On Hold |
| | Schedule Actions |
| | Read Records |
| | Read Records Private |
| | Post Notes Records |
| | Create Records |
| Advanced Performer | Read Issues |
| | Read Issues Private |
| | Read Articles |
| | Read Articles Private |
| | Post Notes Issues |
| | Post Notes Articles |
| | Create Issues |
| | Create Articles |
| | Modify Issues |
| | Modify Articles |
| | Self Delegate |
| | Delegate |
| | Clock In |
| | View time periods |
| | Add work reports |
| | Add expense items |
| | View billable items costs |
| | Set issues On Hold |
| | Schedule Actions |
| | View previous versions |
| | Read Records |
| | Read Records Private |
| | Post Notes Records |
| | Create Records |
| | Modify Records |
| Bookkeeper | Read Issues |
| | Read Issues Private |
| | Read Articles |
| | Read Articles Private |
| | Post Notes Issues |
| | Post Notes Articles |
| | View time periods |
| | View time period rates |
| | View billable items costs |
| | View billable items resell rates |
| | Mark Billable Items Invoiced |
| | Modify Billable Items |
| | View previous versions |
| | Read Records |
| | Read Records Private |
| | Post Notes Records |
| Full Access | All permissions |

Alternatively, or in addition to the folder based permissions described above, certain implementations could also include access controls and security measures which would be applied to individual entities (e.g., notes, issues, articles) or even data maintained for those entities (e.g., there might be different levels of permissions necessary to view text stored in a note than would be necessary to view the note itself). Additionally, in some implementations, different entities might have relationships which reach across folders and types of permissions. For example, in a case where records are used to allow users to track connections between physical pieces of networking equipment, it is possible that the physical connections between pieces of equipment might extent across folders. In such a case, it is possible that an exception could be written so that a user could follow the relationships of pieces of physical equipment even into folders which the user would not normally be able to access. Alternatively, the system might be configured such that the relationships with pieces of equipment located in folders the user could not access would be hidden from the user. Additional alternatives are also possible and could be implemented by those of ordinary skill in the art without undue experimentation in light of this disclosure.

Additionally, in some implementations, information stored for task tracking and allocation might be encrypted (or otherwise protected) so that it could not be accessed even if the database it was stored in was breached. As an example of an approach to this type of protection, in an implementation where information is organized into folders, if an individual folder is set as encrypted, then a passphrase could be used to encrypt (e.g., a hash on the passphrase as an encryption key, where the hash could be created using a one way hash algorithm such as MD5 or salted SHA256) the data for that folder before it is stored. Such a system might also include data which could be used to validate the passphrase (e.g., a version of the passphrase encrypted using salted SHA256 with a different salt than the encryption hash for the folder) before it was used to access the folder data. In operation, a two way encryption/decryption algorithm, such as AES or 3DES or Blowfish could be used to actually encrypt and decrypt the data.

Also, in some implementations there might be multiple levels of encryption necessary to unlock to reach a certain item of information. For example, in a case where there might be folders within folders, a user might be required to first unlock the parent folder, then unlock any subfolders before being able to access the information he or she was seeking. This could be achieved by repeatedly encrypting data, starting with encryption based on the passphrase for the highest level folder, then re-encrypting it with the passphrases applicable at each sub-folder level. Alternatively, it is also possible that data in a subfolder could be encrypted only a single time with a single passphrase formed by concatenating the passphrases for each folder level. Of course, the discussion above of multi-level encryption could easily be applied to forms of organization other than folders, such as projects, records, fields within issues or notes, etc. Accordingly, the discussion of encryption set forth above should be understood as being illustrative only, and not limiting.

Part of the disclosure, incorporated herein by reference in its entirety, is a computer program listing appendix containing code which can be used to implement certain features of the technology described herein. In particular, when used to configure a server, the code contained in the computer program listing appendix will allow users to (among other things) log in, search issues and create reports as described with reference to FIG. 1.

As mentioned, the disclosure herein is intended only to illustrate the inventors' technology, and is not intended to disclose every possible implementation of that technology contemplated by the inventors. Numerous variations on, and departures from, the explicit disclosure of this application are contemplated by the inventors, and will be apparent to one of ordinary skill in the art in light of this application. Accordingly, the protection provided to the inventors by this document should not be limited to the material explicitly disclosed. Instead, such protection should be understood to be defined by the following claims, which are drafted to reflect the scope of protection sought by the inventors in this document when the terms in those claims which are listed below under the label “Explicit Definitions” are given the explicit definitions set forth therein, and the remaining terms are given their broadest reasonable interpretation, which should encompass the usage of terms presented herein, and be at least as broad as the broadest definitions given in a general purpose dictionary.

### EXPLICIT DEFINITIONS

When used in the claims, “account” should be understood to refer to an entity on behalf of which actions can be taken and to which any costs associated with those actions can be attributed for purposes such as recordkeeping and billing. Examples of accounts include specific clients for a business, as well as internal cost centers a business might desire to define for cost tracking purposes.

When used in the claims, “based on” should be understood to mean that something is determined at least in part by the thing that it is indicated as being “based on.” When something is completely determined by a thing, it will be described as being “based EXCLUSIVELY on” the thing.

When used in the claims, “computer” should be understood to mean a device or group of devices which is capable of performing one or more logical and/or physical operations on data to produce a result.

When used in the claims, “computer executable instructions” should be understood to mean data which can be used to specify physical or logical operations which can be performed by a computer.

When used in the claims, a statement that a first thing “corresponds to” a second thing should be understood to mean that there is a one to one relationship between the first and second things. That is, only the first thing satisfies the relationship for the second thing, and only the second thing satisfies the relationship for the first thing.

When used in the claims, “data” means information which is represented in a form which is capable of being processed, stored and/or transmitted.

When used in the claims, “database” should be understood to refer to a discrete and identifiable set of information organized to facilitate the information's use and/or retrieval. For the purpose of clarity, it should be understood that a “database” can be a dedicated system (e.g., a server which serves purely as a repository of information), or could be integrated with other systems (e.g., a “database” could be stored on a server which is used for other tasks, potentially including the storage of other “databases”).

When used in the claims, “due date” should be understood to refer to a particular date on or before which a task should be completed. It should be understood that “due date” is not limited to calendar dates (e.g., Apr. 1, 2012), and also includes other types of dates, such as relative dates (e.g., in two weeks), or null dates (e.g., no due date).

When used in the claims, “indicate” (and various forms thereof) should be understood to refer to the act of showing the thing “indicated.”

When used in the claims, an “issue” should be understood to refer to data representing a unit of work product which needs to be created, or a defined unit of work which needs to be performed.

When used in the claims, “plurality” should be understood to refer to two or more. Accordingly, a statement that each X in a plurality of X's has some characteristic should be understood to mean that there are at least two X's having the characteristics listed, and should not be understood to mean that there are no X's which do not have characteristics listed.

When used in the claims, “priority” should be understood to refer to the precedence or importance of a thing.

When used in the claims, the verb “select” should be understood to refer to the act of picking out or otherwise specifically identifying the thing selected.

When used in the claims, a “set” should be understood to refer to a number, group, or combination of zero or more things of similar nature, design, or function.

When used in the claims, a statement that X is “specifically associated” with Y should be understood mean that either X is uniquely related to Y, Y is uniquely related to X, or both.

When used in the claims, “subject” should be understood to refer to a brief textual identification reflecting the general nature or a particular feature of an associated data entity.

When used in the claims, a statement that X is “uniquely related” to Y should be understood to mean that there is a particular set of operations which directly maps Y (and only Y) onto X. As an example of this relationship, a data object is uniquely related to its member variables, because there is a set of operations (e.g., a request for the member variable) which maps the member variables onto the data object.

Accordingly, we claim:

1. A non-transitory computer readable medium having stored thereon a set of computer executable instructions operable to configure a computer such that said computer is operable to perform a set of tasks comprising:
a) maintain a database comprising:
i) a plurality of issues associated with:
a plurality of accounts;
a plurality of notes;
a plurality of priority values; and
a plurality of subjects;
a plurality of due dates;
wherein:
each issue from said plurality of issues is uniquely related to a single account from said plurality of accounts;
each note from said plurality of notes is uniquely related to a single issue from said plurality of issues;
each issue from said plurality of issues is uniquely related to a single subject from said plurality of subjects;
each issue from said plurality of issues is uniquely related to a single priority value;
each issue from said plurality of issues is uniquely related to a single due date;
ii) a plurality of user records, each user record comprising a contact identification and corresponding to a single user from a plurality of users; and
iii) the plurality of notes, each note from said plurality of notes having been created by a creating user from said plurality of users, each note from said plurality of notes comprising an indication of the creating user from the plurality of users who created the note;
b) generate a first interface displaying one or more subjects from said plurality of subjects, and indicating the relative priorities of the one or more issues uniquely related to the one or more subjects, said first interface operable to allow a user from said plurality of users to select a subject from said one or more subjects;
c) generate a second interface displaying two or more notes from said plurality of notes, wherein each note from said two or more notes is specifically associated with the issue uniquely related to the selected subject, and wherein said two or more notes comprises:
i) a first note created by a first user; and
ii) a second note created by a second user;
and wherein said second interface is operable to allow said user to:
i) generate a first signal indicating starting work on the issue uniquely related to the selected subject;
ii) enter text for a new note;
iii) indicate one or more users from said plurality of users for notification of said new note; and
iv) generate a second signal indicating starting work on the issue uniquely related to the selected subject;
d) in response to receiving a set of data indicating that the user entered text for the new note and indicated one or more users for notification of the new note:
i) send a notification to each of the one or more users indicated for notification, wherein the notification comprises the text entered for the new note, and wherein, for each user from said one or more users, the notification is sent via the contact identification in the user record from the plurality of user records corresponding to the user from the one or more users; and
ii) update the database to include the new note, wherein the issue uniquely related to the selected subject is uniquely related to the new note;
e) begin incrementing a time record for said user indicating time worked on said issue uniquely related to said selected subject upon receiving said first signal;
f) cease incrementing the time record for the user indicating time worked on said issue uniquely related to said selected subject upon receiving the second signal;
g) receive a set of report information specified through use of a report specification interface, wherein said set of report information comprises indications of
i) an account from said plurality of accounts;
ii) a first time occurring before generation of the second signal; and
iii) a second time occurring after the first time and after generation of the first signal; and
h) in response to receiving said set of report information, generate and output a report, said report indicating a set of cost information comprising all time worked by said user on said account between said first time and said second time.

2. The non-transitory computer readable medium of claim 1, wherein said set of tasks further comprises:
a) generate a search interface, said search interface operable to allow the user to specify a set of issue criteria; and
b) generate a result set comprising one or more issues by performing a set of acts comprising searching said database for issues matching said set of issue criteria;
wherein each subject from the one or more subjects displayed by the first interface is specifically associated with a single issue from the result set.

3. The non-transitory computer readable medium of claim 1 wherein said set of tasks further comprises:
a) present a priority modification interface, said priority modification displaying said one or more subjects from said plurality of subjects and operable to allow generation of a signal indicating:
i) a first issue uniquely related to a first subject from said one or more subjects; and
ii) a modification for a first priority value, wherein the first issue is uniquely related to the first priority value; and
b) update the database by modifying the first priority value according to said modification.

4. The non-transitory computer readable medium of claim 1 wherein said set of tasks further comprises, in response to receiving message comprising a text string and a device identification from a mobile device:
a) identifying a sending user by searching said plurality of user records for a user device identification matching said device identification; and
b) begin incrementing a second time record for said user indicating time worked on an issue uniquely related to an issue identifier comprised within said text string.

5. The non-transitory computer readable medium of claim 1 wherein:
a) the database comprises a plurality of folders, wherein:
i) each folder from said plurality of folders has zero or more child folders and at most one parent folder;
ii) each folder from said plurality of folders is specifically associated with a set of permission information indicating one or more users having one or more authorizations relative to the folder;
b) the database comprises a plurality of relationship records, wherein each relationship record from said plurality of relationship records:
i) corresponds to a physical entity;
ii) comprises a key-value pair indicating a specific association between the physical entity corresponding to the relationship record and a different physical entity corresponding to a different relationship record; and
iii) is uniquely related to a folder from said plurality of folders;
wherein said plurality of relationship records comprises a first relationship record comprising a first key-value pair indicating a specific association between a first physical entity corresponding to the first relationship record and a second physical entity corresponding to a second relationship record;
wherein the first relationship record is uniquely related to a first folder from said plurality of folders, said first folder being specifically associated with a first set of permission information; and
wherein the second relationship record is uniquely related to a second folder from said plurality of folders, said second folder being specifically associated with a second set of permission information;
c) the set of tasks comprises:
i) allow said user to indicate the first relationship record for display;
ii) generate a relationship record interface, said relationship record interface displaying a first set of information specifically associated with the first relationship record; and
iii) in response to receiving a signal indicating selection of the first key-value pair by the user using the relationship record interface, modifying the relationship record interface to display a second set of information, said second set of information comprising information specifically associated with the second relationship record.

6. A method comprising:
a) maintaining a database comprising:
i) a plurality of issues associated with:
a plurality of accounts;
a plurality of notes;
a plurality of priority values; and
a plurality of subjects;
a plurality of due dates;
wherein:
each issue from said plurality of issues is uniquely related to a single account from said plurality of accounts;
each note from said plurality of notes is uniquely related to a single issue from said plurality of issues;
each issue from said plurality of issues is uniquely related to a single subject from said plurality of subjects;
each issue from said plurality of issues is uniquely related to a single priority value;
each issue from said plurality of issues is uniquely related to a single due date;
ii) a plurality of user records, each user record comprising a contact identification and corresponding to a single user from a plurality of users; and
iii) the plurality of notes, each note from said plurality of notes having been created by a creating user from said plurality of users, each note from said plurality of notes comprising an indication of the creating user from the plurality of users who created the note;
b) generating a first interface displaying one or more subjects from said plurality of subjects, and indicating the relative priorities of the one or more issues uniquely related to the one or more subjects, said first interface operable to allow a user from said plurality of users to select a subject from said one or more subjects;
c) generating a second interface displaying two or more notes from said plurality of notes, wherein each note from said two or more notes is specifically associated with the issue uniquely related to the selected subject, and wherein said two or more notes comprises:
i) a first note created by a first user; and
ii) a second note created by a second user;
and wherein said second interface is operable to allow said user to:
i) generate a first signal indicating starting work on the issue uniquely related to the selected subject;
ii) enter text for a new note;
iii) indicate one or more users from said plurality of users for notification of said new note; and
iv) generate a second signal indicating starting work on the issue uniquely related to the selected subject;
d) in response to receiving a set of data indicating that the user entered text for the new note and indicated one or more users for notification of the new note:
i) send a notification to each of the one or more users indicated for notification, wherein the notification comprises the text entered for the new note, and wherein, for each user from said one or more users, the notification is sent via the contact identification in the user record from the plurality of user records corresponding to the user from the one or more users; and
ii) update the database to include the new note, wherein the issue uniquely related to the selected subject is uniquely related to the new note;
e) beginning incrementing a time record for said user indicating time worked on said issue uniquely related to said selected subject upon receiving said first signal;
f) ceasing incrementing the time record for the user indicating time worked on said issue uniquely related to said selected subject upon receiving the second signal;
g) receiving a set of report information specified through use of a report specification interface, wherein said set of report information comprises indications of:
i) an account from said plurality of accounts;
ii) a first time occurring before generation of the second signal; and
iii) a second time occurring after the first time and after generation of the first signal; and
h) in response to receiving said set of report information, generate and output a report, said report indicating a set of cost information comprising all time worked by said user on said account between said first time and said second time.

7. The method of claim 6, further comprising:
a) generating a search interface, said search interface operable to allow the user to specify a set of issue criteria; and
b) generating a result set comprising one or more issues by performing a set of acts comprising searching said database for issues matching said set of issue criteria;
wherein each subject from the one or more subjects displayed by the first interface is specifically associated with a single issue from the result set.

8. The method of claim further comprising:
a) presenting a priority modification interface, said priority modification displaying said one or more subjects from said plurality of subjects and operable to allow generation of a signal indicating:
i) a first issue uniquely related to a first subject from said one or more subjects; and
ii) a modification for a first priority value, wherein the first issue is uniquely related to the first priority value; and
b) updating the database by modifying the first priority value according to said modification.

9. The method of claim 6 further comprising, in response to receiving message comprising a text string and a device identification from a mobile device:
a) identifying a sending user by searching said plurality of user records for a user device identification matching said device identification; and
b) beginning incrementing a second time record for said user indicating time worked on an issue uniquely related to an issue identifier comprised within said text string.

10. The method of claim 6 wherein:
a) the database comprises a plurality of folders, wherein:
i) each folder from said plurality of folders has zero or more child folders and at most one parent folder;
ii) each folder from said plurality of folders is specifically associated with a set of permission information indicating one or more users having one or more authorizations relative to the folder;
b) the database comprises a plurality of relationship records, wherein each relationship record from said plurality of relationship records:
i) corresponds to a physical entity;
ii) comprises a key-value pair indicating a specific association between the physical entity corresponding to the relationship record and a different physical entity corresponding to a different relationship record; and
iii) is uniquely related to a folder from said plurality of folders;
wherein said plurality of relationship records comprises a first relationship record comprising a first key-value pair indicating a specific association between a first physical entity corresponding to the first relationship record and a second physical entity corresponding to a second relationship record;
wherein the first relationship record is uniquely related to a first folder from said plurality of folders, said first folder being specifically associated with a first set of permission information; and
wherein the second relationship record is uniquely related to a second folder from said plurality of folders, said second folder being specifically associated with a second set of permission information;
c) the method comprises:
i) allowing said user to indicate the first relationship record for display;
ii) generating a relationship record interface, said relationship record interface displaying a first set of information specifically associated with the first relationship record; and
iii) in response to receiving a signal indicating selection of the first key-value pair by the user using the relationship record interface, modifying the relationship record interface to display a second set of information, said second set of information comprising information specifically associated with the second relationship record.
